(19) United States
(12) Patent Application Publication
(10) Pub. No.: US 2002/0107591 A1
(43) Pub. Date: Aug. 8, 2002

(54) "CONTROLLABLE TOY SYSTEM OPERATIVE IN CONJUNCTION WITH A HOUSEHOLD AUDIO ENTERTAINMENT PLAYER"

(76) Inventors: OZ GABAI, TEL AVIV (IL); JACOB GABAI, TEL AVIV (IL); NIMROD SANDLERMAN, RAMAT GAN (IL)

Correspondence Address: ABELMAN FRAYNE & SCHWAB, 26TH FLOOR, 150 EAST 42ND STREET, NEWYORK, NY, 100175612

(21) Appl. No.: 09/062,547

(22) Filed: Apr. 17, 1998

(30) Foreign Application Priority Data
May 19, 1997 (IL) 120856

(51) Int. Cl. G06F 17/00; A63H 3/00

(52) U.S. Cl. 700/94; 446/268; 379/88.03; 446/141; 446/142

(57) ABSTRACT

A controllable toy system operative in conjunction with a household audio entertainment player, the system including a controllable toy, and an audio entertainment signal analyzer operative to analyze an audio entertainment signal so as to recognize therewithin predetermined audio entertainment elements and to command the controllable toy to perform at least one action according to the predetermined audio entertainment elements at a time corresponding to a time at which the audio entertainment elements are played by the household audio entertainment player.

### FIELD OF THE INVENTION

The present invention relates to apparatus and methods for toy control.

### BACKGROUND OF THE INVENTION

Computer-controlled toys are known.

U.S. Pat. No. 5,191,615 to Aldava describes movable and audible toys spaced apart from a television screen with program synchronized audio and control data to interact with the program viewer in relationship to the television program. A sampling keyboard-based encoder for kinetic device actuating signals is coupled via an audio mixer to an audiovisual programming source and television transmitter carrying an audio based kinetic and audio signal complex. At a remote location, coded audio and kinetic device signals along with audiovisual programming is received and the audiovisual programming content is displayed for viewing and listening. Stereo soundband based program audio signals are decoded and separated from the stereo sound band based device audio and kinetic signals. The device audio and kinetic signals are retransmitted to a spaced apart toy causing the device to be audible and move in synchronization with the spaced apart audiovisual programming. A single band low powered FM transmitter carries the audio kinetic signal complex in proximity yet spaced apart from a receiver coupled to an audio cassette configured magnetic head transducer disposed in the kinetic device to communicate audio and kinetic information to a device speaker and motors to cause the device to move and be audible.

Also well known in the art are toys which are remotely controlled by wireless communication and which are not used in conjunction with a computer system. Typically, such toys include vehicles whose motion is controlled by a human user via a remote control device.

U.S. Pat. No. 4,712,184 to Haugerud describes a computer controlled educational toy, the construction of which teaches the user computer terminology and programming and robotic technology. Haugerud describes computer control of a toy via a wired connection, wherein the user of the computer typically writes a simple program to control movement of a robot.

U.S. Pat. No. 4,840,602 to Rose describes a talking doll responsive to an external signal, in which the doll has a vocabulary stored in digital data in a memory which may be accessed to cause a speech synthesizer in the doll to simulate speech.

U.S. Pat. No. 5,021,878 to Lang describes an animated character system with real-time control.

U.S. Pat. No. 5,142,803 to Lang describes an animated character system with real-time control.

U.S. Pat. No. 5,195,920 to Collier describes a radio controlled toy vehicle which generates realistic sound effects on board the vehicle. Communications with a remote computer allows an operator to modify and add new sound effects.

U.S. Pat. No. 5,270,480 to Hikawa describes a toy acting in response to a MDI signal, wherein an instrument-playing toy performs simulated instrument playing movements.

U.S. Pat. No. 5,289,273 to Lang describes a system for remotely controlling an animated character. The system uses radio signals to transfer audio, video and other control signals to the animated character to provide speech, hearing vision and movement in real-time.

U.S. Pat. No. 5,388,493 describes a system for a housing for a vertical dual keyboard MDI wireless controller for accordionists. The system may be used with either a conventional MIDI cable connection or by a wireless MIDI transmission system.

German Patent DE 3009-040 to Neuhierl describes a device for adding the capability to transmit sound from a remote control to a controlled model vehicle. The sound is generated by means of a microphone or a tape recorder and transmitted to the controlled model vehicle by means of radio communications. The model vehicle is equipped with a speaker that emits the received sounds.

The disclosures of all publications mentioned in the specification and of the publications cited therein are hereby incorporated by reference.

### SUMMARY OF THE INVENTION

The present invention seeks to provide improved apparatus and methods for controlling toys by means of a television or radio.

There is thus provided in accordance with a preferred embodiment of the present invention a controllable toy system operative in conjunction with a household audio entertainment player, the system including a controllable toy, and an audio entertainment signal analyzer operative to analyze an audio entertainment signal so as to recognize therewithin predetermined audio entertainment elements and to command the controllable toy to perform at least one action according to the predetermined audio entertainment elements at a time corresponding to a time at which the audio entertainment elements are played by the household audio entertainment player.

Further in accordance with a preferred embodiment of the present invention the toy system includes a household audio entertainment player such as an audio cassette player or a VCR and/or a household entertainment broadcast receiver such as a television set or a radio set.

Further in accordance with a preferred embodiment of the present invention the audio entertainment signal analyzer is operative to receive an acoustical representation of the audio entertainment signal from the audio entertainment player.

Still further in accordance with a preferred embodiment of the present invention the audio entertainment player and the audio entertainment signal analyzer each receive an electronic representation of the audio entertainment signal from an electronic audio entertainment source.

Further in accordance with a preferred embodiment of the present invention the audio entertainment signal analyzer is integrally formed with the controllable toy.

Still further in accordance with a preferred embodiment of the present invention the audio entertainment signal analyzer includes a computer, such as a personal computer, in electronic communication with the controllable toy.

Further in accordance with a preferred embodiment of the present invention the electronic communication includes wired electronic communication or wireless electronic communication.

Also provided in accordance with another preferred embodiment of the present invention is a computerized toy system including a toy, a computer having a sound card, a computer-radio interface associated with the sound card of the computer via at least one audio channels, and a toy control device associated with the toy and providing radio communication with the computer-radio interface, wherein at least one of the computer-radio interface and the computer are operative to transmit audio signals and digital commands through the sound card, via the at least one audio channels to the other one of the computer-radio interface and the computer and wherein the other one of the computer-radio interface and the computer is operative to receive the audio signals and the digital commands from the at least one audio channels.

Additionally provided in accordance with another preferred embodiment of the present invention is a controllable toy system operative in conjunction with a household audio entertainment player receiving an audio entertainment signal from a remote radio transmitter, the system including a controllable toy, and a radio signal receiver operative to receive a toy control signal from a remote radio transmitter which transmits the toy control signal and a corresponding audio entertainment signal, and to command the controllable toy to perform at least one action according to the toy control signal.

Further in accordance with a preferred embodiment of the present invention the radio signal receiver is integrally formed with the controllable toy.

Additionally in accordance with a preferred embodiment of the present invention the radio signal receiver is integrally formed with a computer which is in electronic communication with the controllable toy.

Further in accordance with a preferred embodiment of the present invention the electronic communication includes wired electronic communication.

Still further in accordance with a preferred embodiment of the present invention the electronic communication includes wireless electronic communication.

Also provided in accordance with another preferred embodiment of the present invention is a telephone communication toy including a toy including a microphone and a loudspeaker, a computer in electronic communication with the toy and including a speech recognizer, a telephone number database accessible by the speech recognizer and including at least one destination paired with at least one telephone number, and an automatic dialing device operative to generate a telephone connection with the destination, using a corresponding telephone number accessed from the telephone number database by the speech recognizer.

Further in accordance with a preferred embodiment of the present invention the controllable toy is integrally formed with the household audio entertainment player.

Also provided in accordance with another preferred embodiment of the present invention is a toy control method operative in conjunction with a household audio entertainment player, the method including providing a controllable toy, and analyzing an audio entertainment signal so as to recognize therewithin predetermined audio entertainment elements and commanding the controllable toy to perform at least one action according to the predetermined audio entertainment elements at a time corresponding to a time at which the audio entertainment elements are played by the household audio entertainment player.

Further in accordance with a preferred embodiment of the present invention the system also includes a remote radio transmitter broadcasting an audio entertainment signal and a corresponding toy control signal.

Still further in accordance with a preferred embodiment of the present invention the household audio entertainment player is integrally formed with the controllable toy.

Also provided in accordance with another preferred embodiment of the present invention is a computerized toy control method including providing a toy, a computer having a sound card, a computer-radio interface associated with the sound card of the computer via at least one audio channels and a toy control device associated with the toy and providing radio communication with the computer-radio interface, and transmitting audio signals and digital commands through the sound card, from one of the computer-radio interface and the computer via the at least one audio channels to the other one of the computer-radio interface and the computer.

Additionally provided in accordance with another preferred embodiment of the present invention is a toy control method operative to control a controllable toy in conjunction with a household audio entertainment player receiving an audio entertainment signal from a remote radio transmitter, the method including broadcasting a toy control signal and a corresponding audio entertainment signal, playing the audio entertainment signal at a location remote from the radio transmitter, and commanding the controllable toy to perform at least one action according to the toy control signal, at a location remote from the radio transmitter.

Further provided in accordance with yet another preferred embodiment of the present invention is a telephone communication method including providing a toy including a microphone and a loudspeaker, a computer in electronic communication with the toy and including a speech recognizer and a telephone number database accessible by the speech recognizer, and generating a telephone connection with a destination, using a telephone number accessed from the telephone number database by the speech recognizer.

There is additionally provided in accordance with a preferred embodiment of the present invention a wireless computer controlled toy system including a computer system operative to transmit a first transmission via a first wireless transmitter and at least one toy including a first wireless receiver, the toy receiving the first transmission via the first wireless receiver and operative to carry out at least one action based on the first transmission.

The computer system may include a computer game. The toy may include a plurality of toys, and the at least one action may include a plurality of actions.

The first transmission may include a digital signal. The first transmission includes an analog signal and the analog signal may include sound.

Additionally in accordance with a preferred embodiment of the present invention the computer system includes a computer having a MIDI port and wherein the computer may be operative to transmit the digital signal by way of the MIDI port.

Additionally in accordance with a preferred embodiment of the present invention the sound includes music, a pre-recorded sound and/or speech. The speech may include recorded speech and synthesized speech.

Further in accordance with a preferred embodiment of the present invention the at least one toy has a plurality of states including at least a sleep state and an awake state, and the first transmission includes a state transition command, and the at least one action includes transitioning between the sleep state and the awake state.

A sleep state may typically include a state in which the toy consumes a reduced amount of energy and/or in which the toy is largely inactive, while an awake state is typically a state of normal operation.

Still further in accordance with a preferred embodiment of the present invention the first transmission includes a control command chosen from a plurality of available control commands based, at least in part, on a result of operation of the computer game.

Additionally in accordance with a preferred embodiment of the present invention the computer system includes a plurality of computers.

Additionally in accordance with a preferred embodiment of the present invention the first transmission includes computer identification data and the second transmission includes computer identification data.

Additionally in accordance with a preferred embodiment of the present invention the at least one toy is operative to transmit a second transmission via a second wireless transmitter and the computer system is operative to receive the second transmission via a second wireless receiver.

Moreover in accordance with a preferred embodiment of the present invention the system includes at least one input device and the second transmission includes a status of the at least one input device.

Additionally in accordance with a preferred embodiment of the invention the at least one toy includes at least a first toy and a second toy, and wherein the first toy is operative to transmit a toy-to-toy transmission to the second toy via the second wireless transmitter, and wherein the second toy is operative to carry out at least one action based on the toy-to-toy transmission.

Further in accordance with a preferred embodiment of the present invention operation of the computer system is controlled, at least in part, by the second transmission.

Moreover in accordance with a preferred embodiment of the present invention the computer system includes a computer game, and wherein operation of the game is controlled, at least in part, by the second transmission.

The second transmission may include a digital signal and/or an analog signal.

Still further in accordance with a preferred embodiment of the present invention the computer system has a plurality of states including at least a sleep state and an awake state, and the second transmission include a state transition command, and the computer is operative, upon receiving the second transmission, to transition between the sleep state and the awake state.

Still further in accordance with a preferred embodiment of the present invention at least one toy includes sound input apparatus, and the second transmission includes a sound signal which represents a sound input via the sound input apparatus.

Additionally in accordance with a preferred embodiment of the present invention the computer system is also operative to perform at least one of the following actions: manipulate the sound signal; and play the sound signal.

Additionally in accordance with a preferred embodiment of the present invention the sound includes speech, and the computer system is operative to perform a speech recognition operation on the speech.

Further in accordance with a preferred embodiment of the present invention the second transmission includes toy identification data, and the computer system is operative to identify the at least one toy based, at least in part, on the toy identification data.

Still further in accordance with a preferred embodiment of the present invention the first transmission includes toy identification data. The computer system may adapt a mode of operation thereof based, at least in part, on the toy identification data.

Still further in accordance with a preferred embodiment of the present invention the at least one action may include movement of the toy, movement of a part of the toy and/or an output of a sound. The sound may be transmitted using a MIDI protocol.

There is also provided in accordance with another preferred embodiment of the present invention a game system including a computer system operative to control a computer game and having a display operative to display at least one display object, and at least one toy in wireless communication with the computer system, the computer game including a plurality of game objects, and the plurality of game objects includes the at least one display object and the at least one toy.

Further in accordance with a preferred embodiment of the present invention the at least one toy is operative to transmit toy identification data to the computer system, and the computer system is operative to adapt a mode of operation of the computer game based, at least in part, on the toy identification data.

The computer system may include a plurality of computers.

Additionally in accordance with a preferred embodiment of the present invention the first transmission includes computer identification data and the second transmission includes computer identification data.

There is also provided in accordance with a preferred embodiment of the present invention a data transmission apparatus including first wireless apparatus including musical instrument data interface (MIDI) apparatus operative to receive and transmit MIDI data between a first wireless and a first MIDI device and second wireless apparatus including MIDI apparatus operative to receive and transmit MIDI data between a second wireless and a second MIDI device, the first wireless apparatus is operative to transmit MIDI data including data received from the first MIDI device to the second wireless apparatus, and to transmit MIDI data including data received from the second wireless apparatus to the first MIDI device, and the second wireless apparatus is operative to transmit MIDI data including data received from the second MIDI device to the first wireless apparatus, and to transmit MIDI data including data received from the first wireless apparatus to the second MIDI device.

Further in accordance with a preferred embodiment of the present invention the second wireless apparatus includes a plurality of wirelesses each respectively associated with one of the plurality of MIDI devices, and each of the second plurality of wirelesses is operative to transmit MIDI data including data received from the associated MIDI device to the first wireless apparatus, and to transmit MIDI data including data received from the first wireless apparatus to the associated MIDI device.

The first MIDI device may include a computer, while the second MIDI device may include a toy.

Additionally in accordance with a preferred embodiment of the present invention the first wireless apparatus also includes analog interface apparatus operative to receive and transmit analog signals between the first wireless and a first analog device, and the second wireless apparatus also includes analog interface apparatus operative to receive and transmit analog signals between the second wireless and a second analog device, and the first wireless apparatus is also operative to transmit analog signals including signals received from the first analog device to the second wireless apparatus, and to transmit analog signal including signals received from the second wireless apparatus to the first analog device, and the second wireless apparatus is also operative to transmit analog signals including signals received from the second analog device to the first wireless apparatus, and to transmit analog signals including data received from the first wireless apparatus to the second analog device.

There is also provided in accordance with another preferred embodiment of the present invention a method for generating control instructions for a computer controlled toy system, the method includes selecting a toy, selecting at least one command from among a plurality of commands associated with the toy, and generating control instructions for the toy including the at least one command.

Further in accordance with a preferred embodiment of the present invention the step of selecting at least one command includes choosing a command, and specifying at least one control parameter associated with the chosen command.

Still further in accordance with a preferred embodiment of the present invention the at least one control parameter includes at least one condition depending on a result of a previous command.

Additionally in accordance with a preferred embodiment of the present invention at least one of the steps of selecting a toy and the step of selecting at least one command includes utilizing a graphical user interface.

Still further in accordance with a preferred embodiment of the present invention the previous command includes a previous command associated with a second toy.

Additionally in accordance with a preferred embodiment of the present invention the at least one control parameter includes an execution condition controlling execution of the command.

The execution condition may include a time at which to perform the command and/or a time at which to cease performing the command. The execution condition may also include a status of the toy.

Additionally in accordance with a preferred embodiment of the present invention the at least one control parameter includes a command modifier modifying execution of the command.

Still further in accordance with a preferred embodiment of the present invention the at least one control parameter includes a condition dependent on a future event.

Additionally in accordance with a preferred embodiment of the present invention the at least one command includes a command to cancel a previous command.

There is also provided for in accordance with a preferred embodiment of the present invention a signal transmission apparatus for use in conjunction with a computer, the apparatus including wireless transmission apparatus; and signal processing apparatus including at least one of the following analog/digital sound conversion apparatus operative to convert analog sound signals to digital sound signals, to convert digital sound signals to analog sound signals, and to transmit the signals between the computer and a sound device using the wireless transmission apparatus; a peripheral control interface operative to transmit control signals between the computer and a peripheral device using the wireless transmission apparatus; and a MIDI interface operative to transmit MIDI signals between the computer and a MIDI device using the wireless transmission apparatus.

There is also provided in accordance with another preferred embodiment of the present invention a computer system including a computer, and a sound card operatively attached to the computer and having a MIDI connector and at least one analog connector, wherein the computer is operative to transmit digital signals by means of the MIDI connector and to transmit analog signals by means of the at least one analog connector.

Further in accordance with a preferred embodiment of the present invention the computer is also operative to receive digital signals by means of the MIDI connector and to receive analog signals by means of the at least one analog connector.

It is also noted that throughout the specification and claims the term “radio” includes all forms of “wireless” communication.

### BRIEF DESCRIPTION OF THE DRAWINGS

The present invention will be understood and appreciated from the following detailed description, taken in conjunction with the drawings in which:

FIGS. 1-32C illustrate a toy system for use in conjunction with a computer system wherein:

FIG. 1A is a partly pictorial, partly block diagram illustration of a computer control system including a toy, constructed and operative in accordance with a preferred embodiment of the present invention;

FIG. 1B is a partly pictorial, partly block diagram illustration a preferred implementation of the toy 122 of FIG. 1A;

FIG. 1C is a partly pictorial, partly block diagram illustration of a computer control system including a toy, constructed and operative in accordance with an alternative preferred embodiment of the present invention;

FIGS. 2A-2C are simplified pictorial illustrations of a portion of the system of FIG. 1A in use;

FIG. 3 is a simplified block diagram of a preferred implementation of the computer radio interface 110 of FIG. 1A;

FIG. 4 is a more detailed block diagram of the computer radio interface 110 of FIG. 3;

FIGS. 5A-5D taken together comprise a schematic diagram of the apparatus of FIG. 4;

FIG. 5E is an schematic diagram of an alternative implementation of the apparatus of FIG. 5D;

FIG. 6 is a simplified block diagram of a preferred implementation of the toy control device 130 of FIG. 1A;

FIGS. 7A-7F, taken together with either FIG. 5D or FIG. 5E, comprise a schematic diagram of the apparatus of FIG. 6;

FIG. 8A is a simplified flowchart illustration of a preferred method for receiving radio signals, executing commands comprised therein, and sending radio signals, within the toy control device 130 of FIG. 1A;

FIGS. 8B-8T, taken together, comprise a simplified flowchart illustration of a preferred implementation of the method of FIG. 8A;

FIG. 9A is a simplified flowchart illustration of a preferred method for receiving MIDI signals, receiving radio signals, executing commands comprised therein, sending radio signals, and sending MIDI signals, within the computer radio interface 110 of FIG. 1A;

FIGS. 9B-9N, taken together with FIGS. 8D-8M, comprise a simplified flowchart illustration of a preferred implementation of the method of FIG. 9A;

FIGS. 10A-10C are simplified pictorial illustrations of a signal transmitted between the computer radio interface 110 and the toy control device 130 of FIG. 1A;

FIG. 11 is a simplified flowchart illustration of a preferred method for generating control instructions for the apparatus of FIG. 1A;

FIGS. 12A-12C are pictorial illustrations of a preferred implementation of a graphical user interface implementation of the method of FIG. 11;

FIG. 13 is a block diagram of a first sub-unit of a multi-port multi-channel implementation of the computer radio interface 110 of FIG. 1A, which sub-unit resides within computer 100 of FIG. 1A;

FIG. 14 is a block diagram of a second sub-unit of a multi-port multi-channel implementation of the computer radio interface 110 of FIG. 1A, which sub-unit complements the apparatus of FIG. 13 and resides exteriorly to computer 100 of FIG. 1A;

FIGS. 15A-15E, taken together, form a detailed electronic schematic diagram of the toy control device of FIG. 6, suitable for the multi-channel implementation of FIGS. 13 and 14;

FIG. 16 is a simplified flowchart illustration of a preferred method by which a computer selects a control channel pair in anticipation of a toy becoming available and starts a game-defining communication over the control channel each time both a toy and a transceiver of the computer radio interface are available;

FIG. 17 is a simplified flowchart illustration of a preferred method for implementing the “select control channel pair” step of FIG. 16;

FIG. 18A is a simplified flowchart illustration of a preferred method for implementing the “select information communication channel pair” step of FIG. 16;

FIG. 18B is a simplified flowchart illustration of a preferred method for performing the “locate computer” step of FIG. 18A;

FIG. 19 is a simplified flowchart illustration of a preferred method of operation of the toy control device 130;

FIG. 20 is a simplified illustration of a remote game server in association with a wireless computer controlled toy system which may include a network computer;

FIG. 21 is a simplified flowchart illustration of the operation of the computer or of the network computer of FIG. 20, when operating in conjunction with the remote server;

FIG. 22 is a simplified flowchart illustration of the operation of the remote game server of FIG. 20;

FIG. 23 is a semi-pictorial semi-block diagram illustration of a wireless computer controlled toy system including a proximity detection subsystem operative to detect proximity between the toy and the computer;

FIGS. 24A-24E, taken together, form a detailed electronic schematic diagram of a multi-channel implementation of the computer radio interface 110 of FIG. 3 which is similar to the detailed electronic schematic diagrams of FIGS. 5A-5D except for being multi-channel, therefore capable of supporting full duplex applications, rather than single-channel;

FIGS. 25A-25F, taken together, form a detailed schematic illustration of a computer radio interface which connects to a serial port of a computer rather than to the sound board of the computer;

FIGS. 26A-26D, taken together, form a detailed schematic illustration of a computer radio interface which connects to a parallel port of a computer rather than to the sound board of the computer.;

FIGS. 27A-27J are preferred flowchart illustrations of a preferred radio coding technique which is an alternative to the radio coding technique described above with reference to FIGS. 8E, 8G-8M and 10A-C;

FIGS. 28A-28K, taken together, form a detailed electronic schematic diagram of the multi-port multi-channel computer radio interface sub-unit of FIG. 13;

FIGS. 29A-29I, taken together, form a detailed electronic schematic diagram of the multi-port multi-channel computer radio interface sub-unit of FIG. 14;

FIG. 30 is a partly pictorial, partly block diagram illustration of a computer control system including a toy, constructed and operative in accordance with a further preferred embodiment of the present invention;

FIG. 31 is a block diagram is a simplified block diagram illustrating the combination of the computer radio interface and the toy control device as used in the embodiment of FIG. 30; and

FIGS. 32A, 32B and 32C taken together form a simplified block diagram of the EPLD chip of FIG. 28H; and

FIGS. 33-54 illustrates embodiments of the toy system of FIGS. 1-32C, in which a computer-controlled toy system controls toys by means of a television or radio, wherein:

FIG. 33 is a semi-pictorial semi-block diagram illustration of a toy sensing audio information from a television set viewed by a user, wherein the toy transmits this information wirelessly to a computer and receiving from the computer commands responsive to the audio information, and wherein the source of the audio-visual information provided by the television set is a conventional television broadcast;

FIG. 34 is a semi-pictorial semi-block diagram illustration of a toy sensing audio information from a radio, transmitting this information wirelessly to a computer and receiving from the computer commands responsive to the audio information.

FIG. 35 is a semi-pictorial semi-block diagram illustration of a toy including a radio receiver receiving radio entertainment broadcast information, transmitting this information wirelessly to a computer and receiving from the computer commands responsive to the radio entertainment broadcast information;

FIG. 36 is a semi-pictorial semi-block diagram illustration of a toy and a computer including a radio receiver operative to receive radio entertainment broadcast information and to simultaneously transmit to the toy the radio entertainment broadcast information and computer commands responsive to the radio entertainment broadcast information.

FIG. 37 is a semi-pictorial semi-block diagram illustration of a toy, a television monitor and a computer including a TV receiver operative to receive television entertainment broadcast information and to transmit to the toy computer commands responsive to the television entertainment broadcast information;

FIG. 38 is a semi-pictorial semi-block diagram illustration of toy apparatus functioning as a PDA (personal digital assistant);

FIG. 39A is a simplified flowchart illustration of a preferred mode of operation for the apparatus of FIG. 38 allowing a call to be placed;

FIG. 39B is a simplified flowchart illustration of a preferred mode of operation for the apparatus of FIG. 38 for handling an entering call;

FIG. 40 is a simplified diagram of the interface between the computer radio interface of FIG. 33 and a soundboard of the computer of FIG. 1;

FIG. 41 is a simplified block diagram of a preferred implementation of the computer radio interface of FIG. 1;

FIG. 42 is a simplified flowchart illustration of a preferred method allowing one of the computer radio interface and the computer to receive commands over the audio channel, rather than over the MIDI channel, from the other one of the computer radio interface and the computer;

FIG. 43 is a diagram of analog and digital representations and respectively of the following signals: SYNC, SQ, zero-valued bit and one-valued bit;

FIG. 44 is a semi-pictorial semi-block diagram illustration of a toy sensing audio information from a television viewed by a user, wherein the toy transmits this information wirelessly to a computer and receiving from the computer commands responsive to the audio information, and wherein the source of the audio-visual information provided by the television is a VCR rather than a conventional television broadcast as in FIG. 1;

FIG. 45 is a semi-pictorial semi-block diagram illustration of a toy, a television monitor and a computer including a TV receiver operative to receive audio-visual entertainment information from a VCR and to transmit to the toy computer commands responsive to the audio visual entertainment broadcast information;

FIG. 46 is a semi-pictorial semi-block diagram illustration of a toy connected by wire to a computer, and a conventional audio entertainment provision system providing audio entertainment information which is presented to the user and which is used by the computer to operate the toy in coordination with the presentation of the audio entertainment information;

FIGS. 47A-47E, taken together, form a detailed electronic schematic diagram of a preferred implementation of the apparatus of FIG. 41;

FIG. 48 is a semi-pictorial semi-block diagram illustration of a controllable toy system comprising a controllable toy and a radio signal receiver operative to receive an audio entertainment signal and a corresponding toy control signal from a remote radio transmitter;

FIG. 49 is a semi-pictorial semi-block diagram illustration of a modification of FIG. 48 in which the radio signal receiver is integrally formed with the controllable toy;

FIG. 50 is a simplified flowchart illustration of a preferred method by which the computer analyzes an audio entertainment signal so as to recognize therewithin predetermined audio entertainment elements and to command the toy to perform at least one action having a predetermined association with the recognized predetermined audio entertainment elements;

FIG. 51 is a simplified flowchart illustration of a preferred method for performing the TV/radio program coordination step of the method of FIG. 50;

FIG. 52 is a simplified flowchart illustration of a preferred method for performing the conformance checking step of the method of FIG. 50 in order to synchronize the toy's activities with a broadcast program;

FIG. 53 is a simplified flowchart illustration of a preferred method for performing the “command toy . . . ” step of the method of FIG. 50 in which the toy is activated in synchronization with the broadcast program; and

FIG. 54 is a semi-pictorial semi-block diagram of a controllable toy system operative in conjunction with a household audio entertainment player receiving an audio entertainment signal from a remote radio transmitter, the system comprising a controllable toy and a radio signal receiver, integrally formed with the computer and communicating with the toy by means of a wire.

Attached herewith is a microfiche appendix labeled “1 of 2,” “2 of 2,” “1 of 4,” “2 of 4,” “3 of 4, ” and “4 of 4” and comprising appendices A-W wherein:

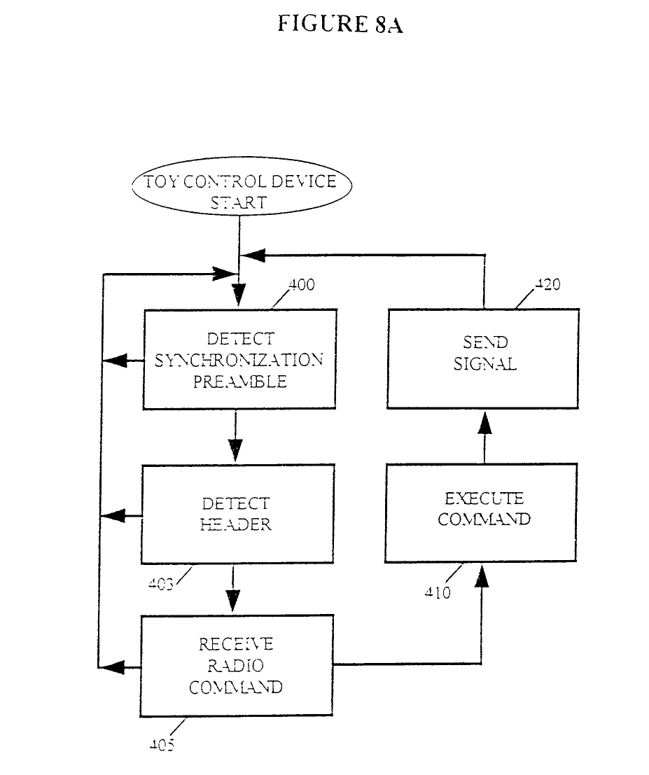

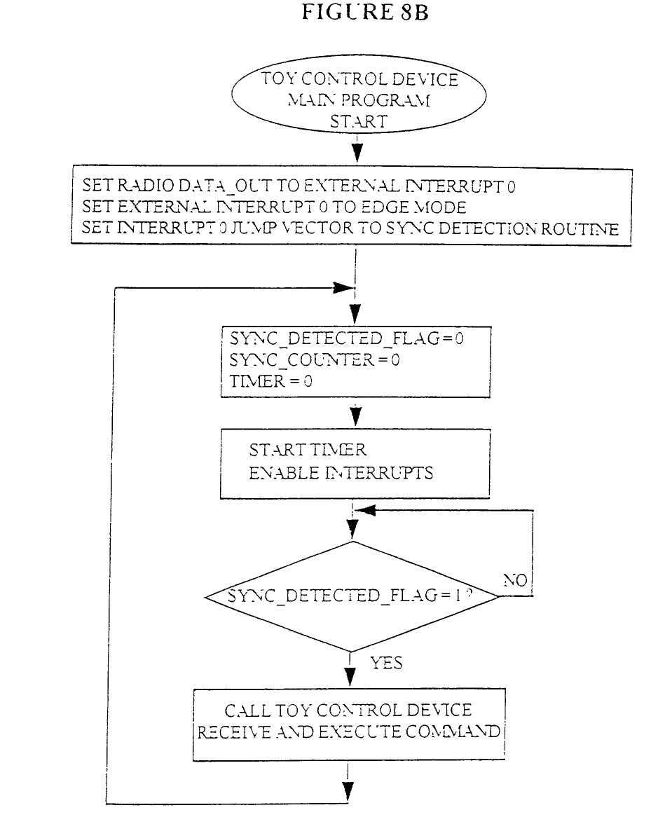

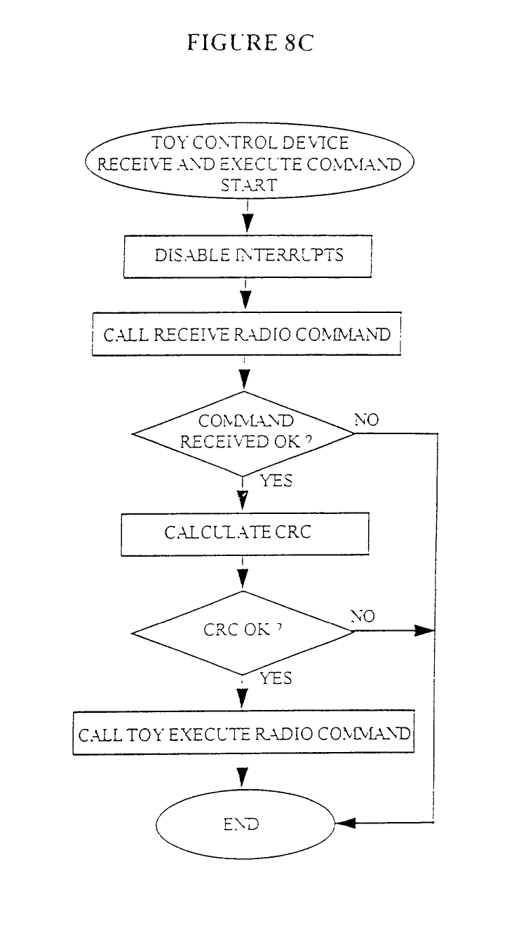

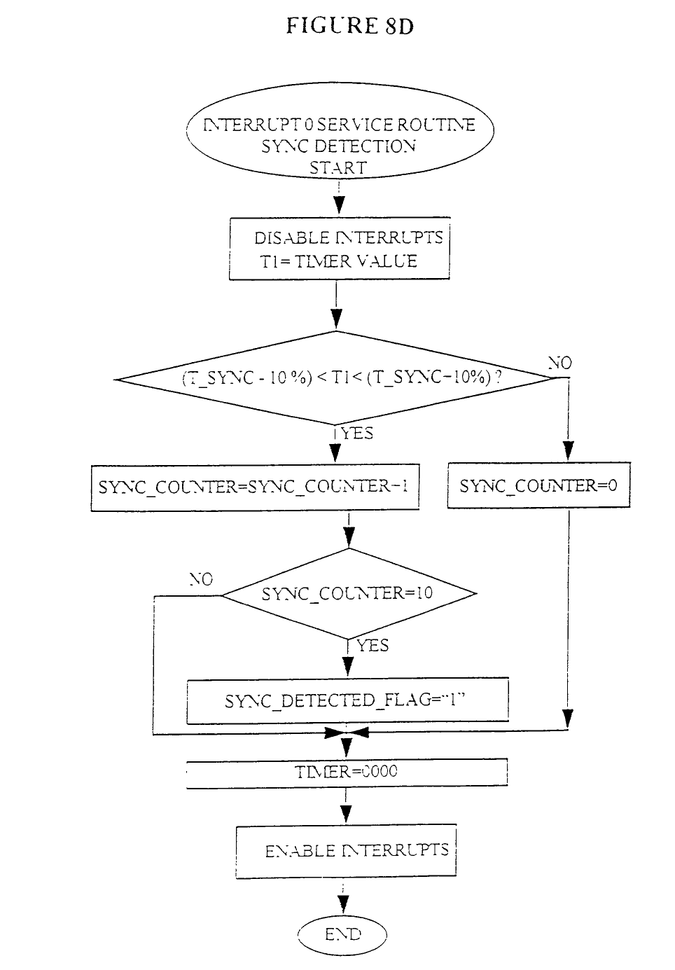

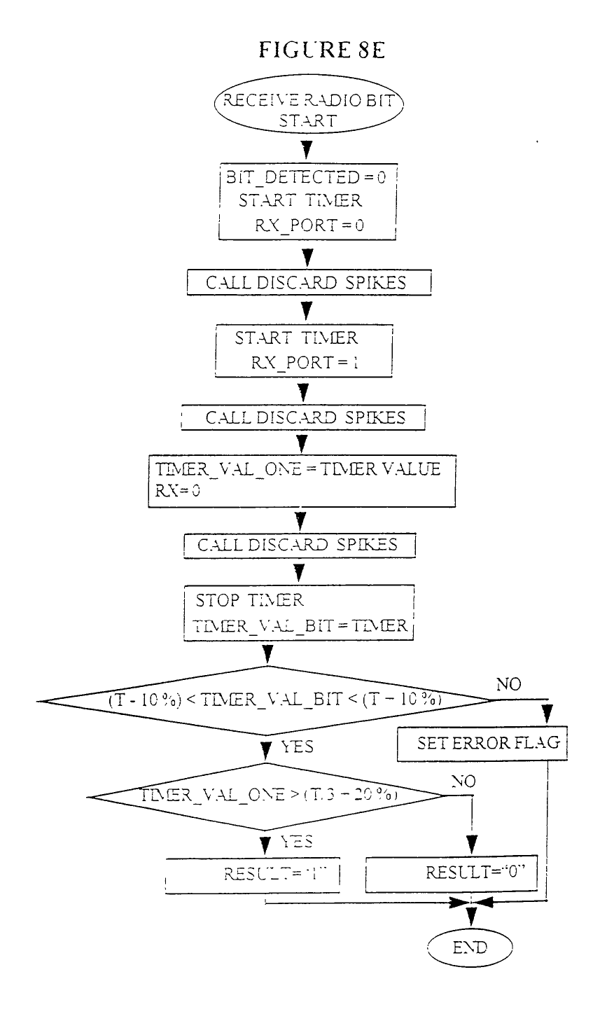

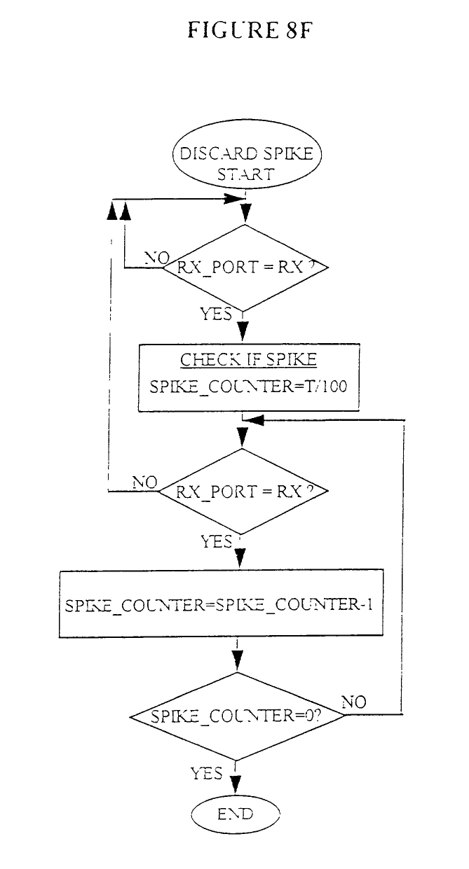

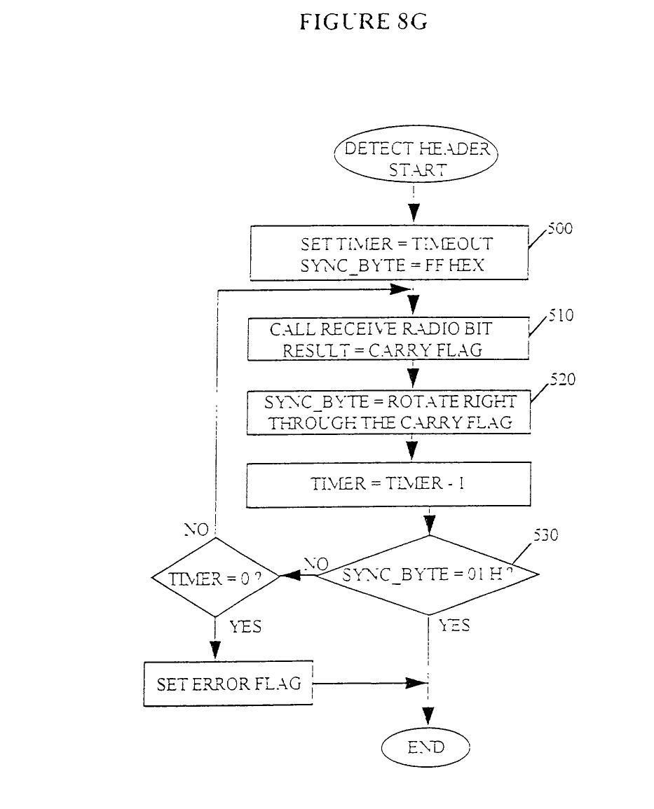

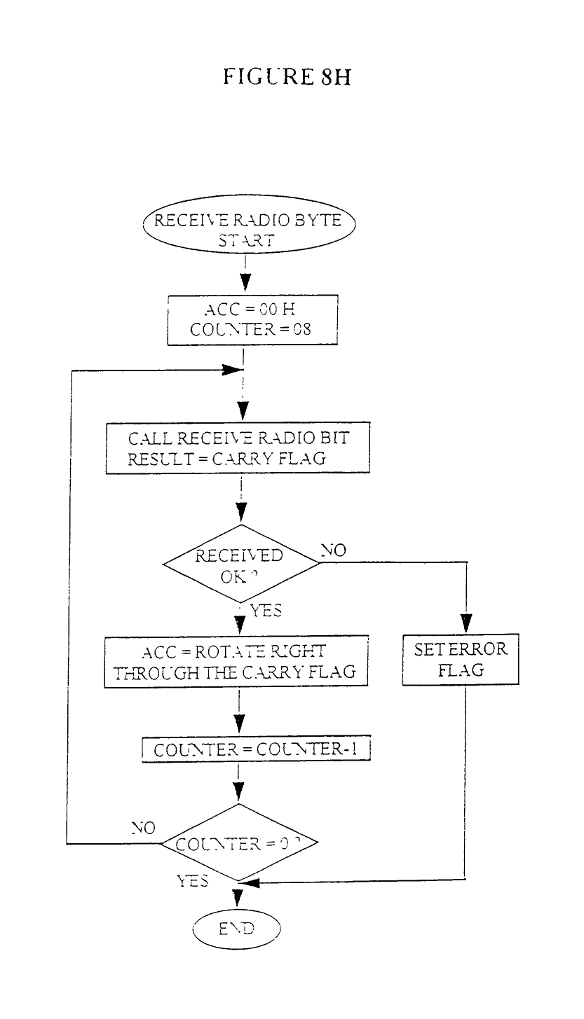

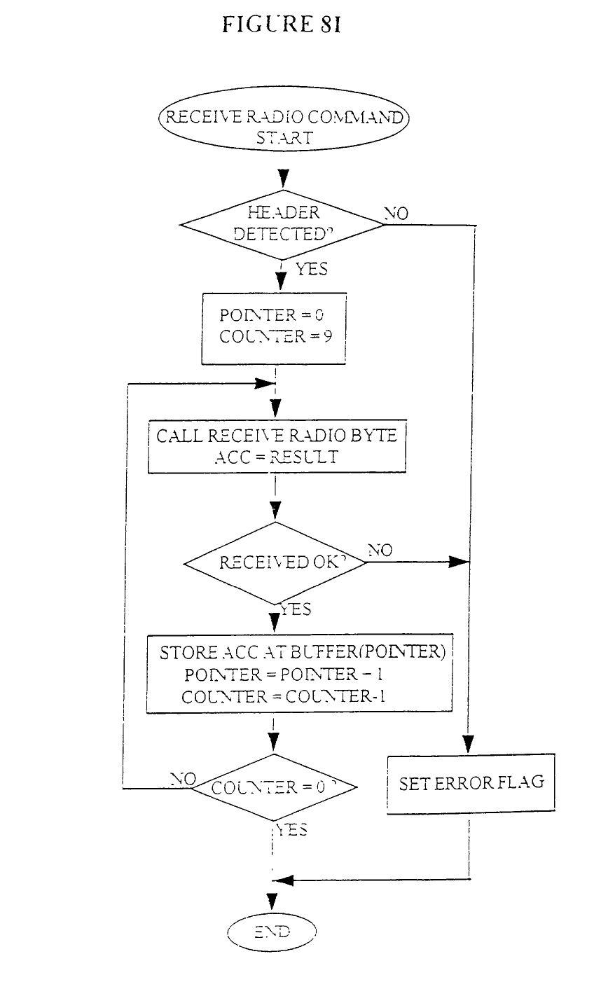

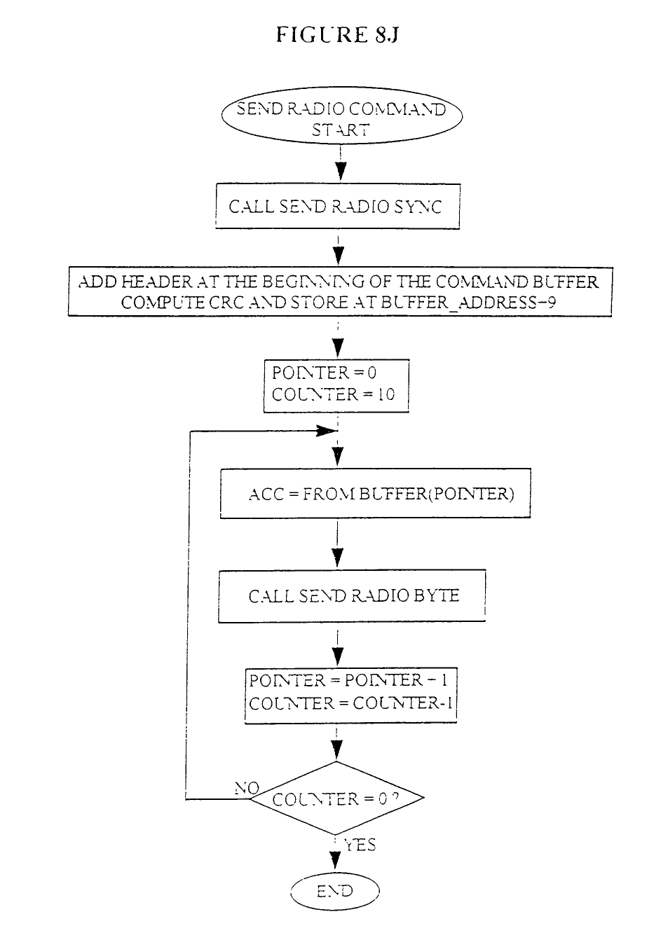

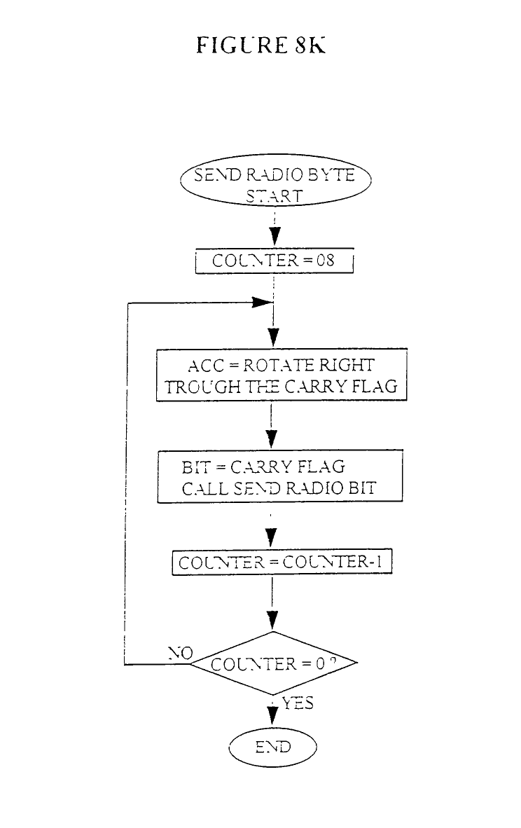

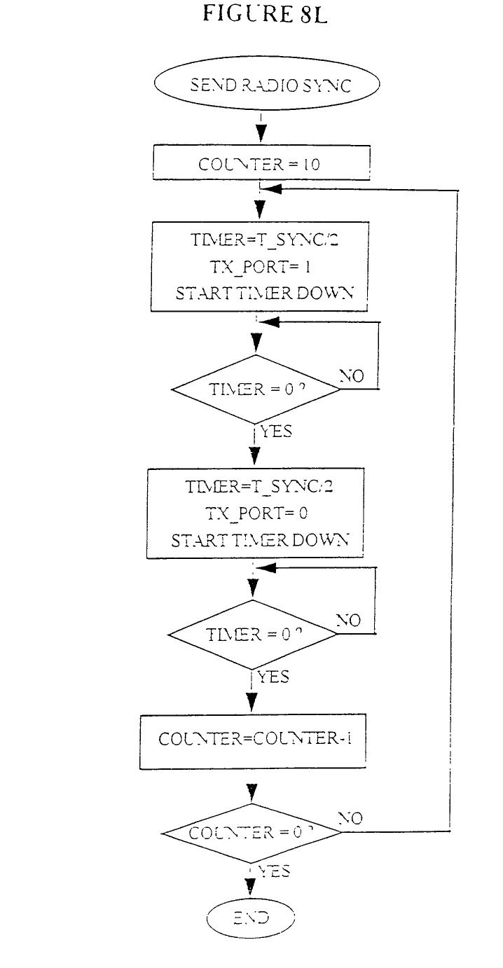

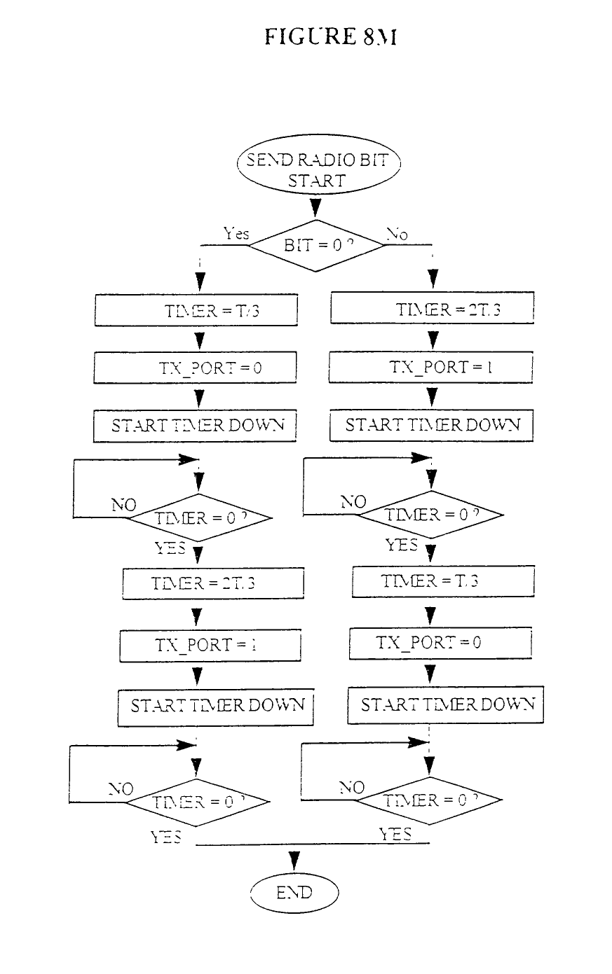

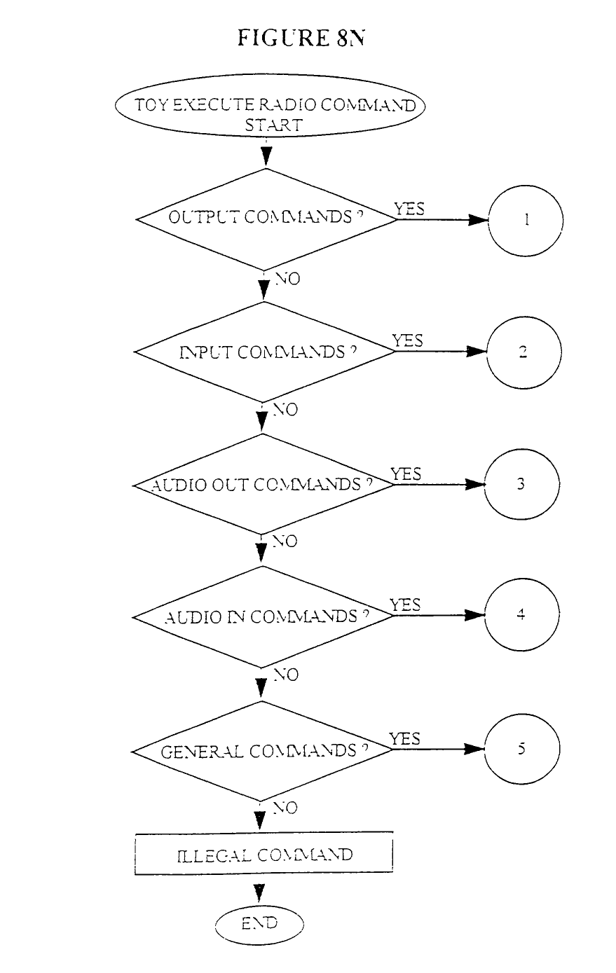

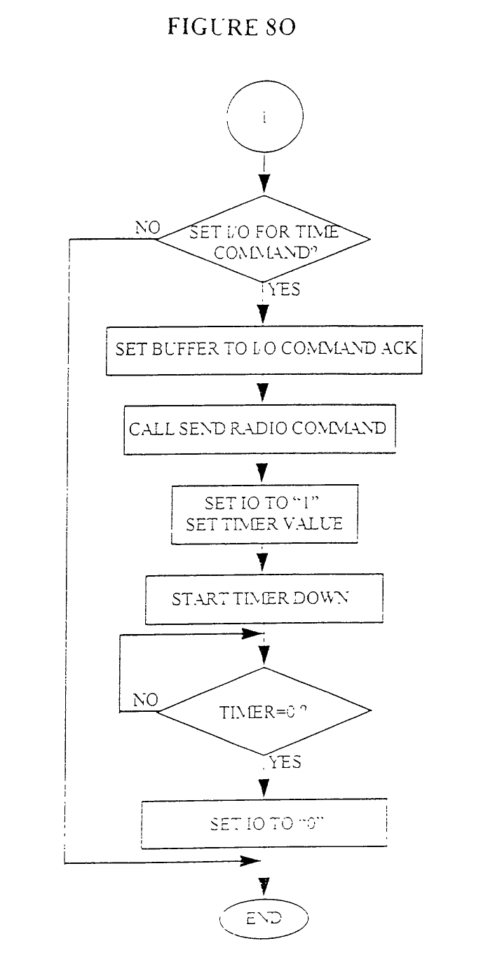

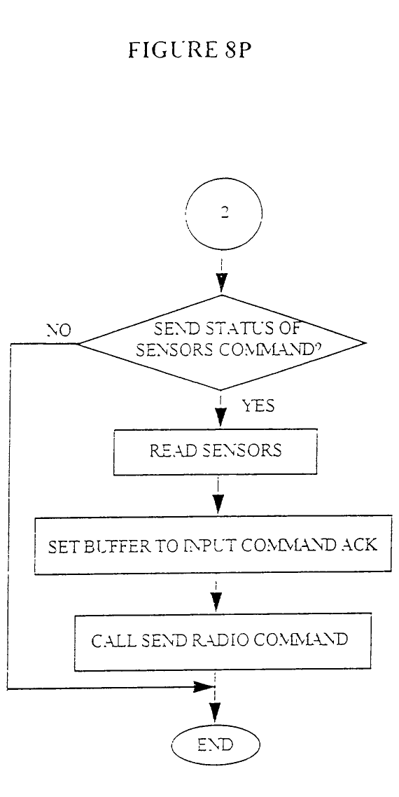

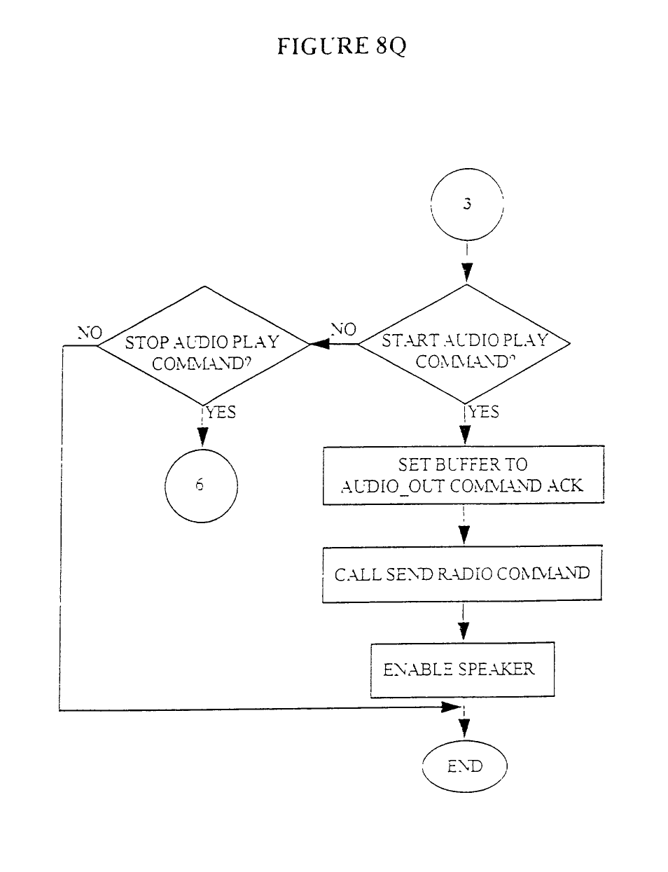

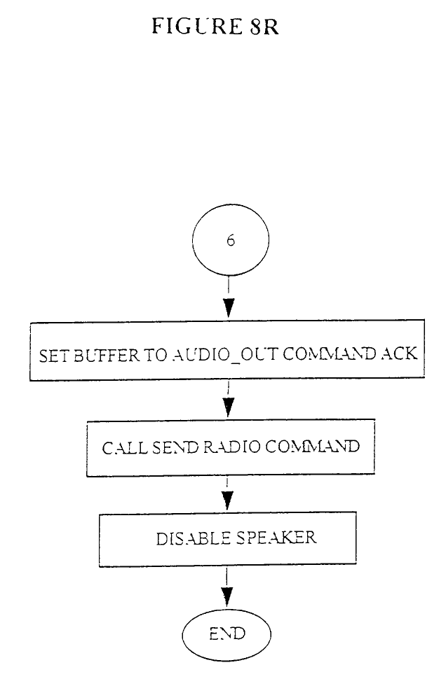

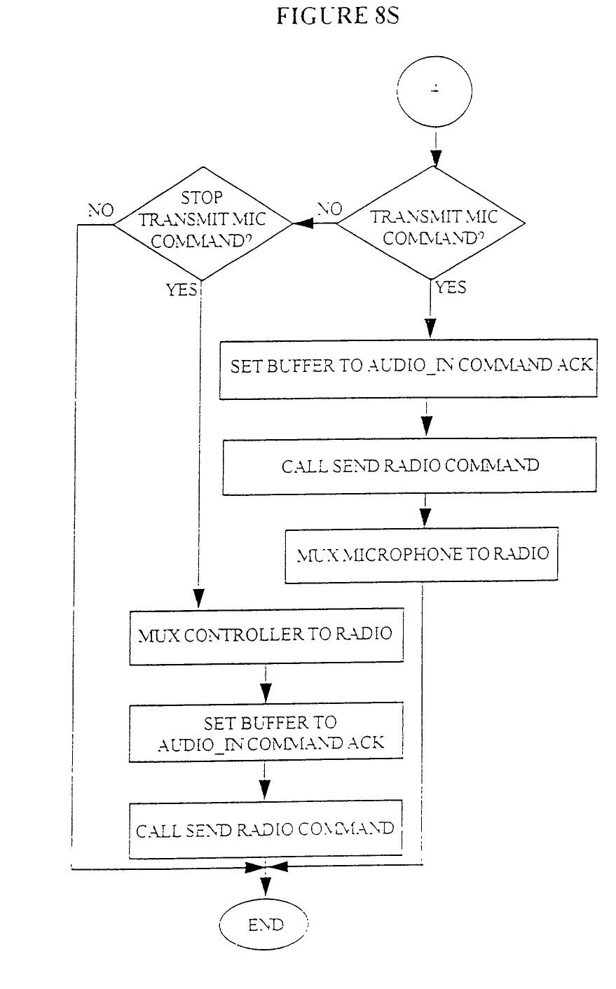

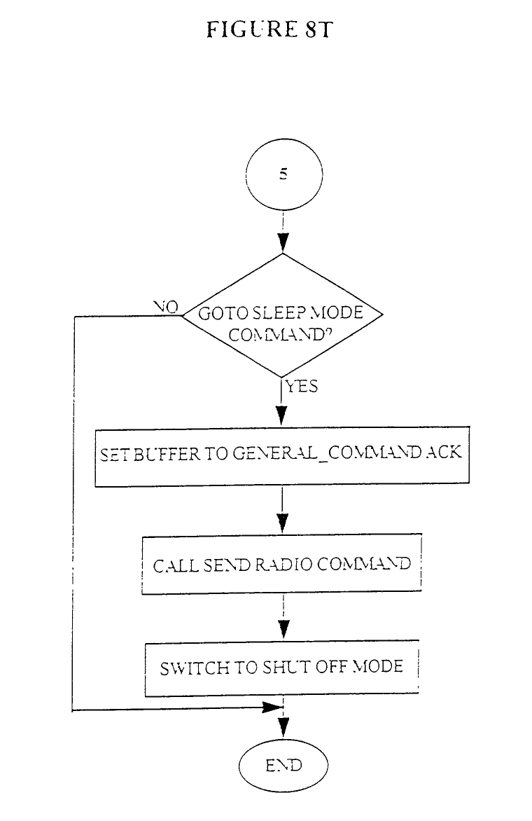

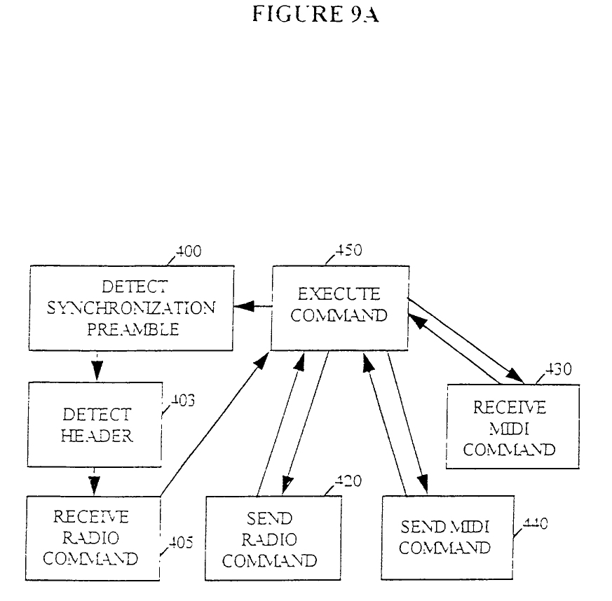

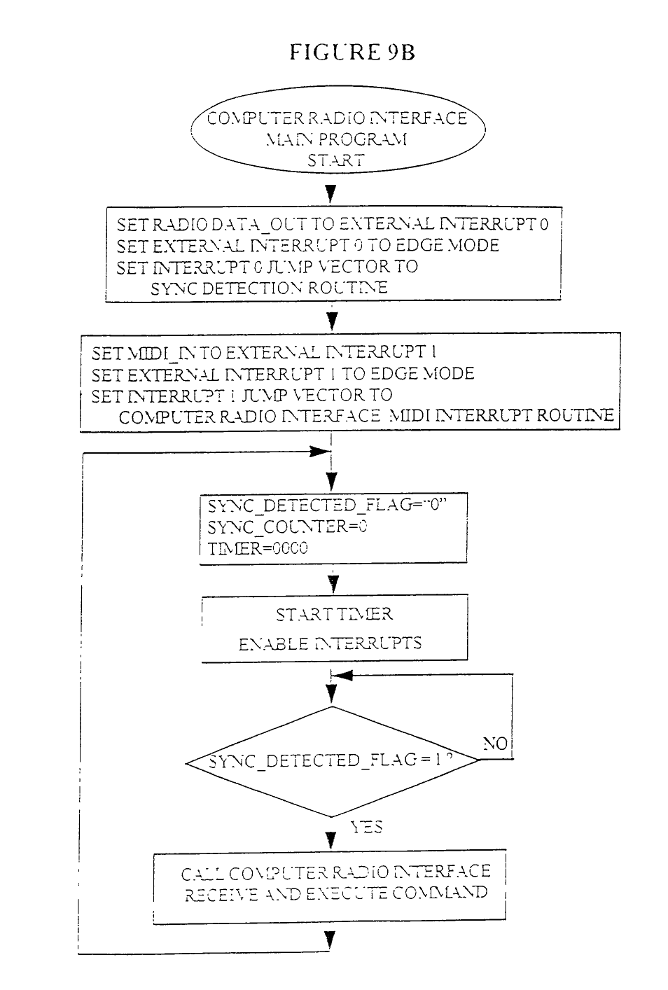

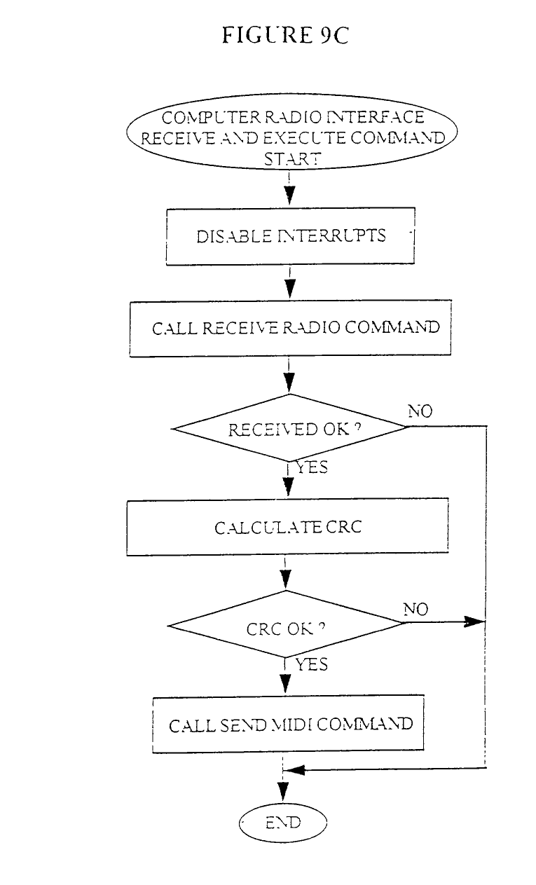

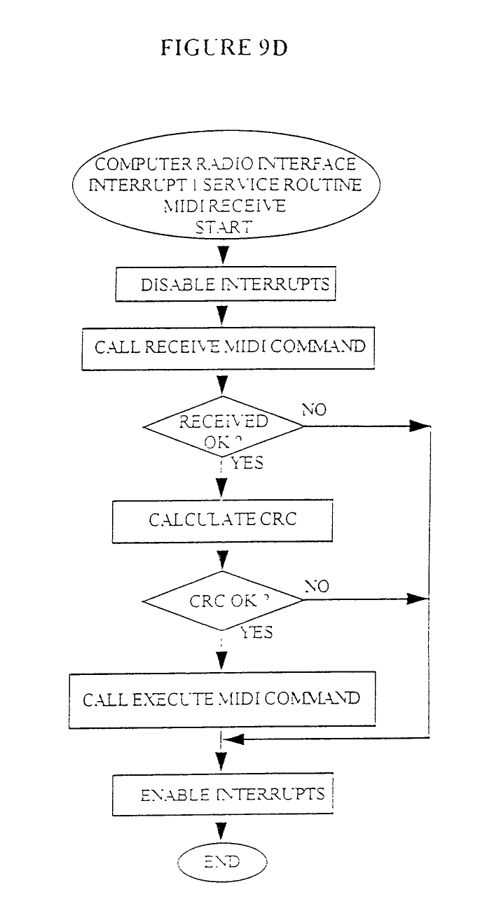

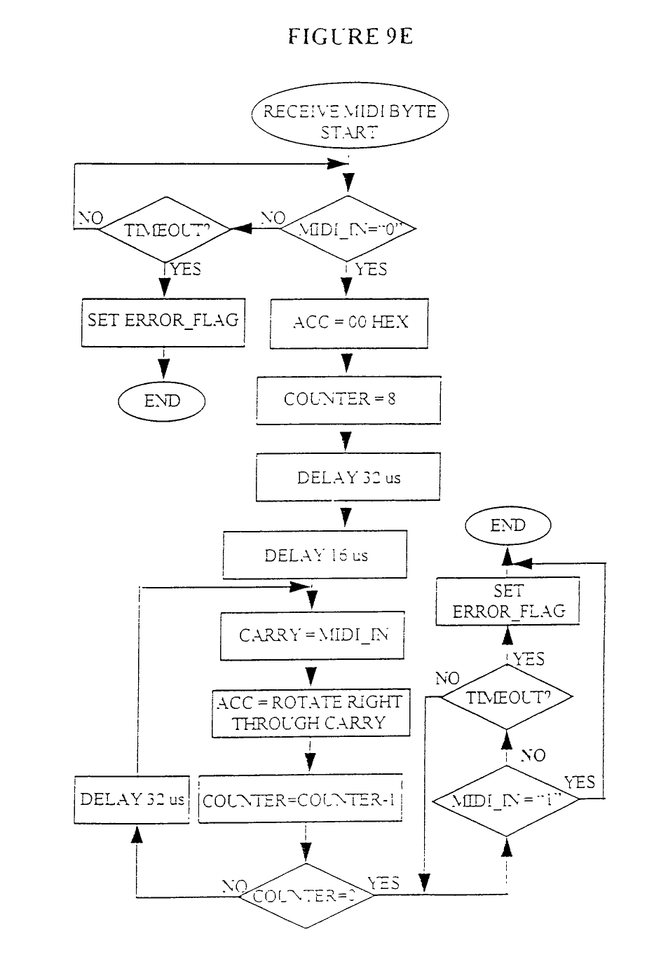

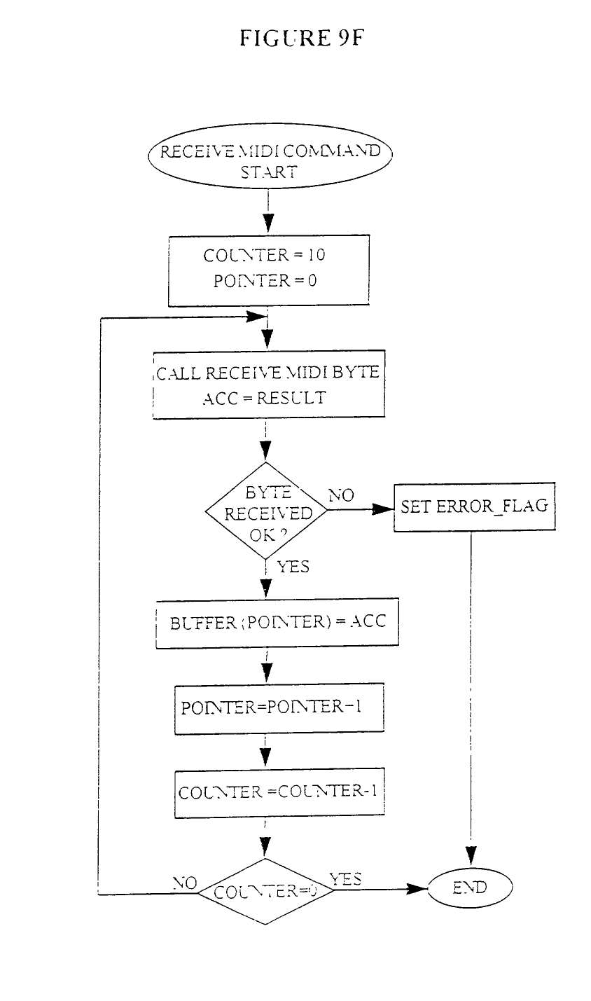

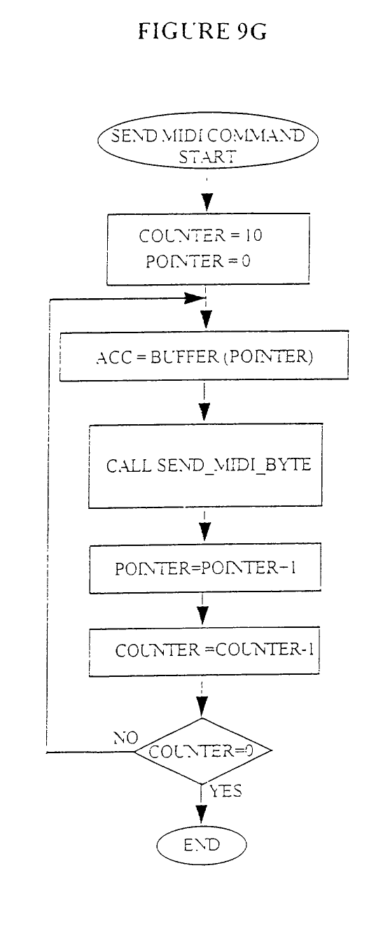

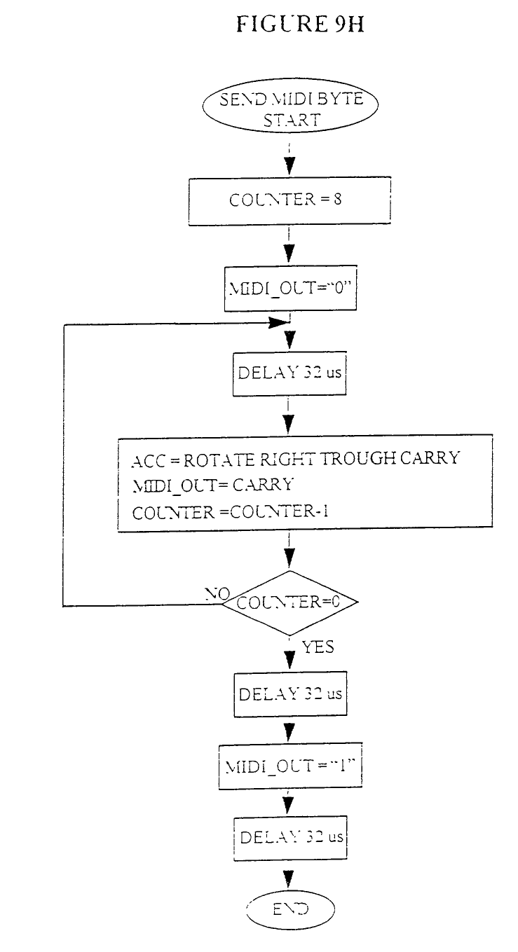

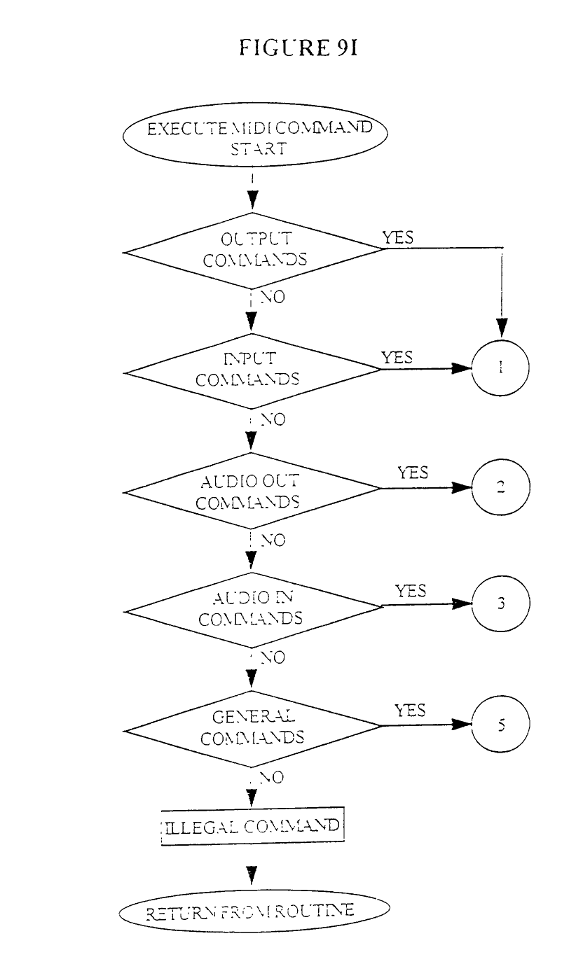

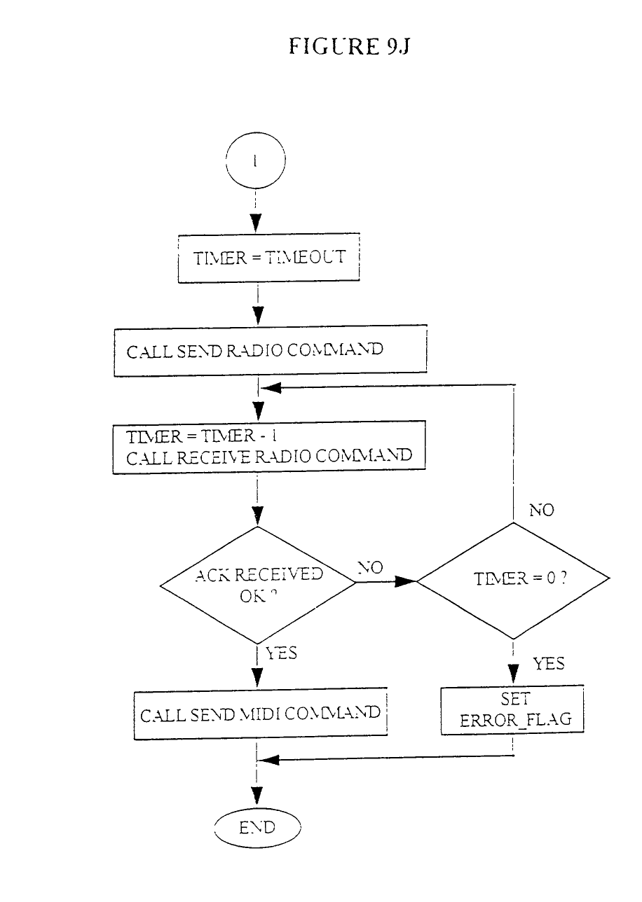

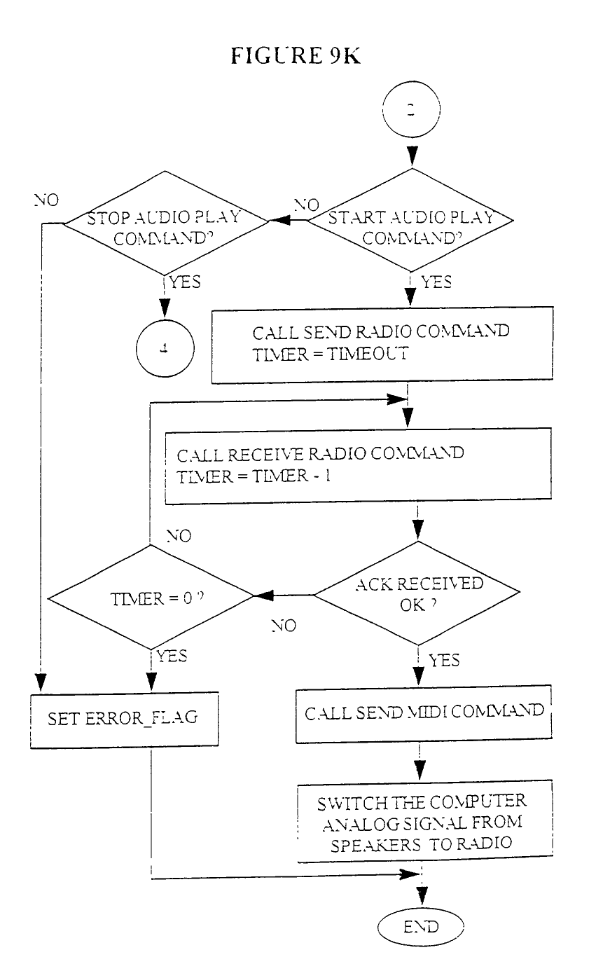

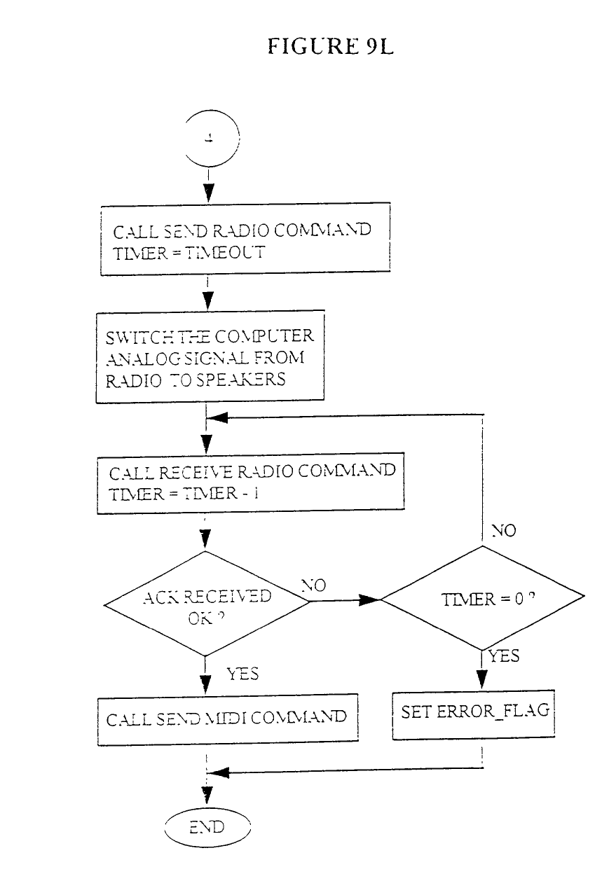

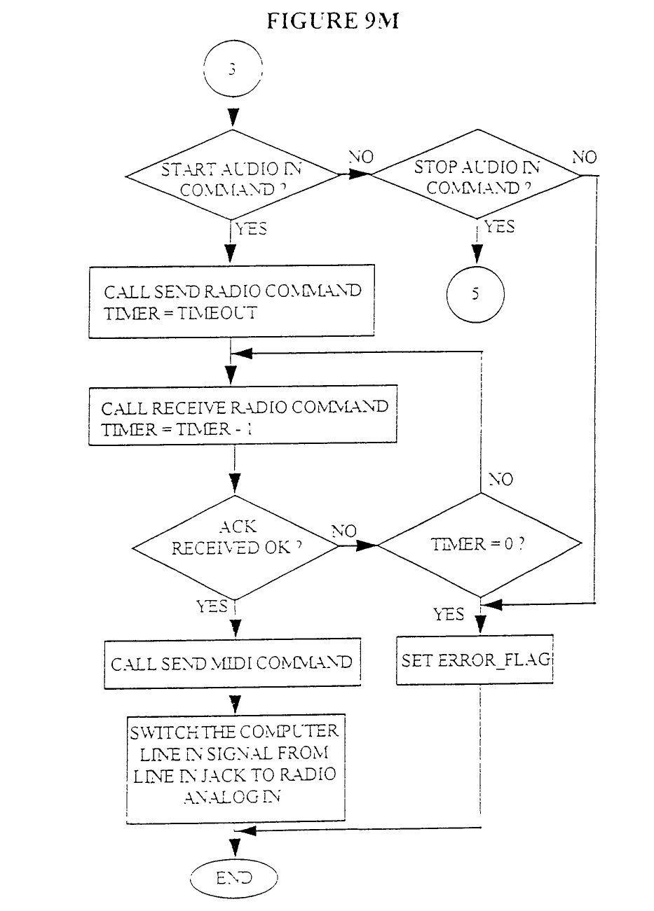

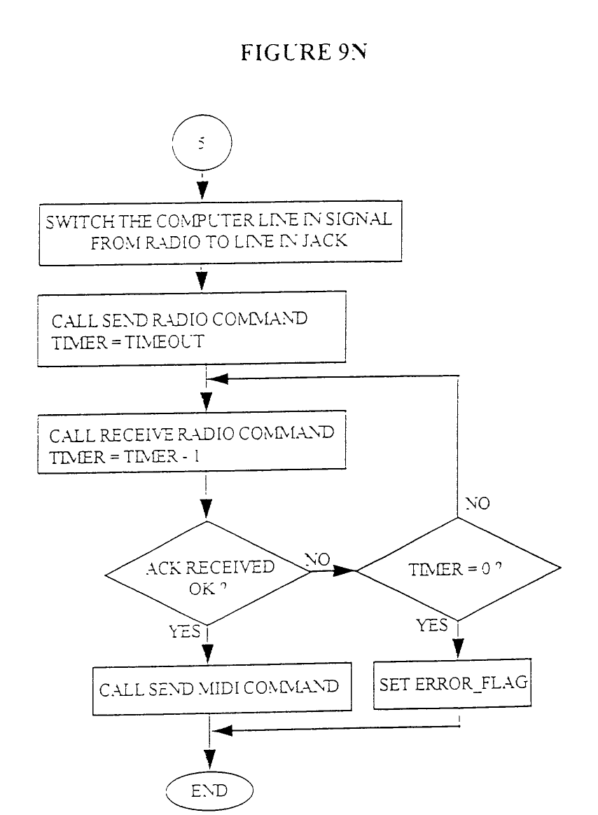

Appendix A is a computer listing of a preferred software implementation of the method of FIGS. 9A-9N, together with the method of FIGS. 8D-8M;

Appendix B is a computer listing of a preferred software implementation of the method of FIGS. 8A-8T;

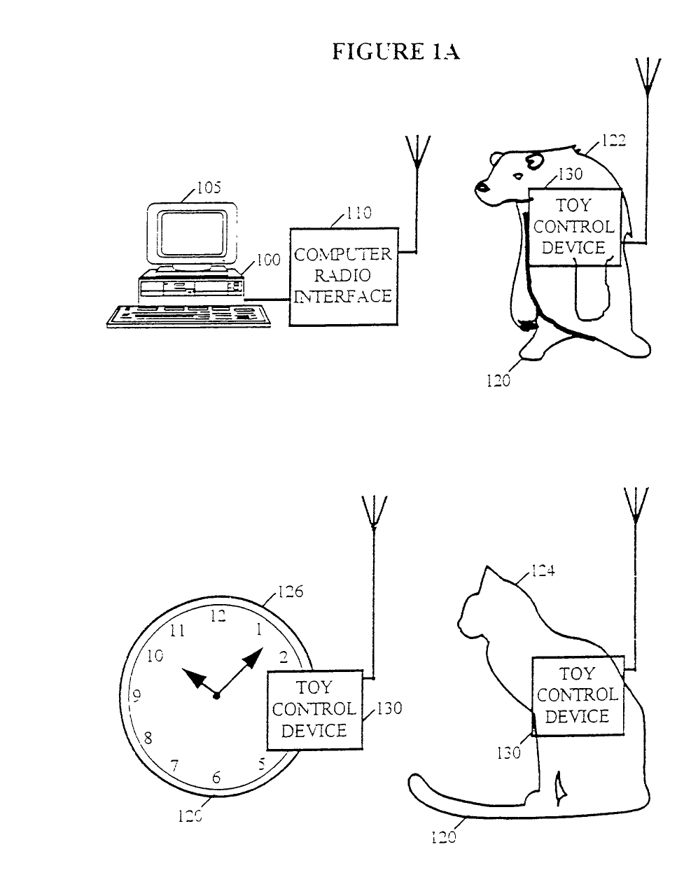

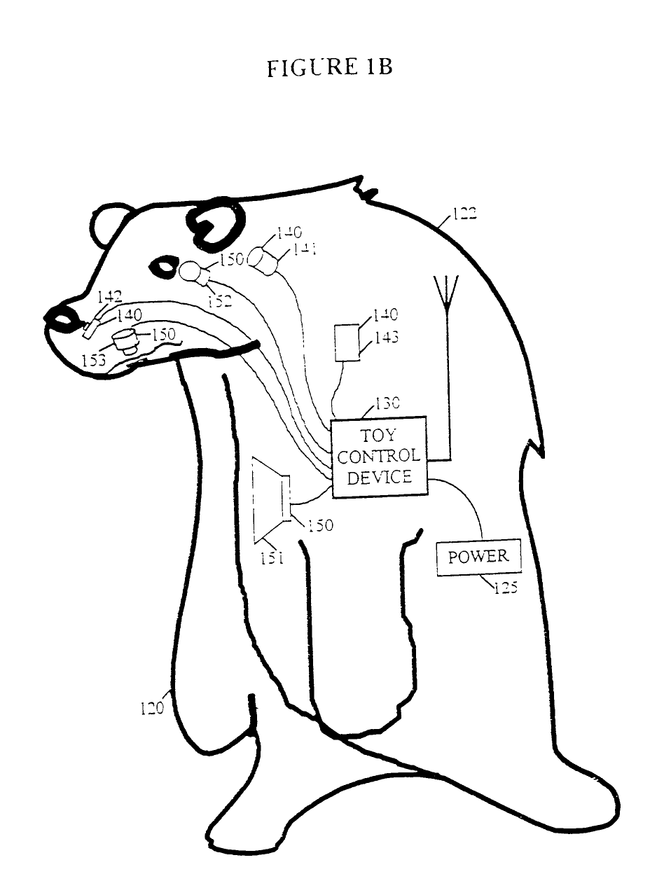

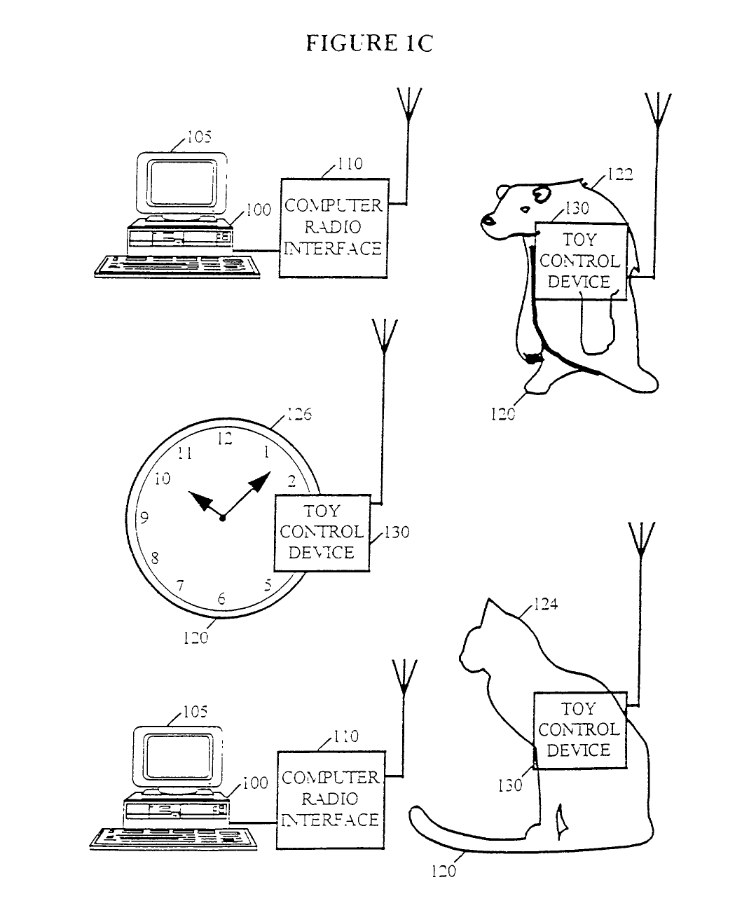

Appendix C is a computer listing of a preferred software implementation of an example of a computer game for use in the computer 100 of FIG. 1;

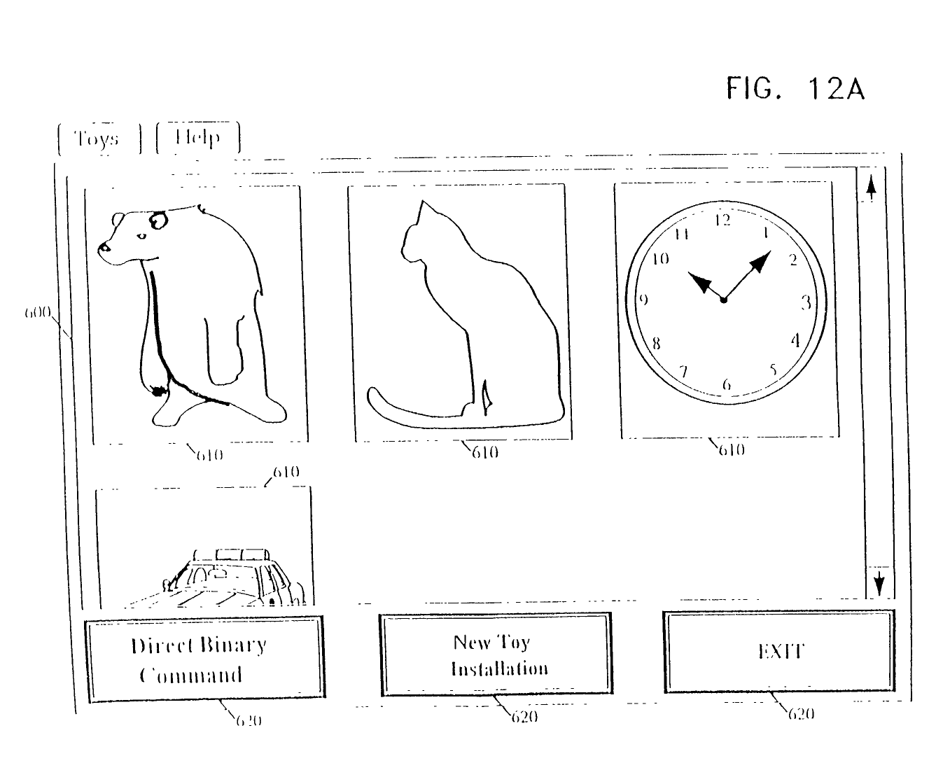

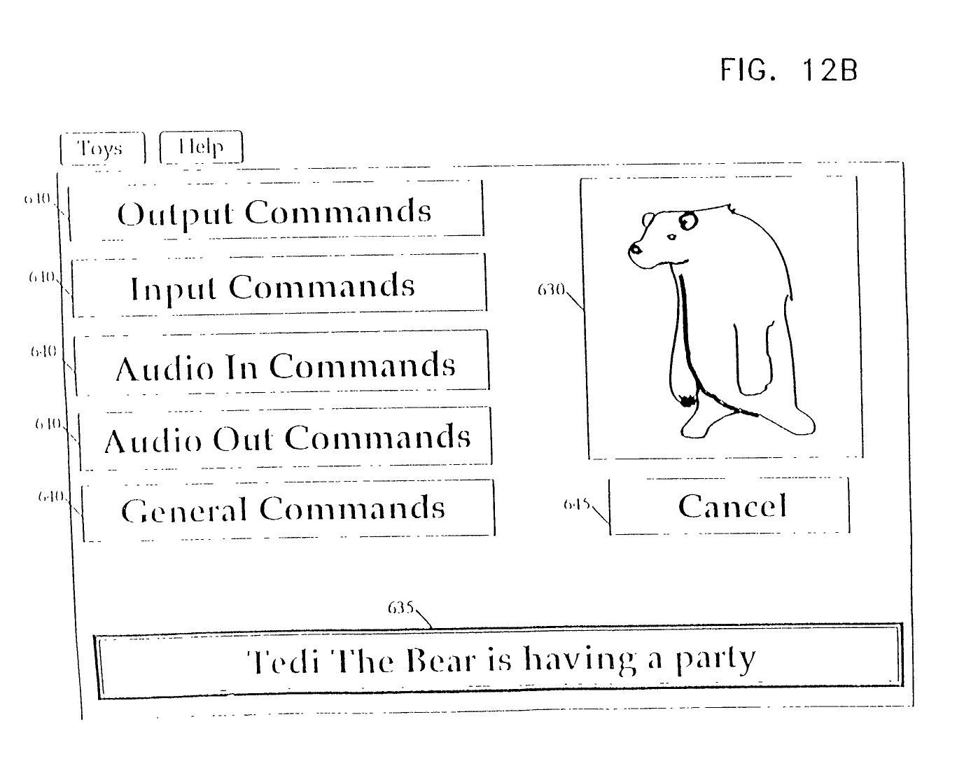

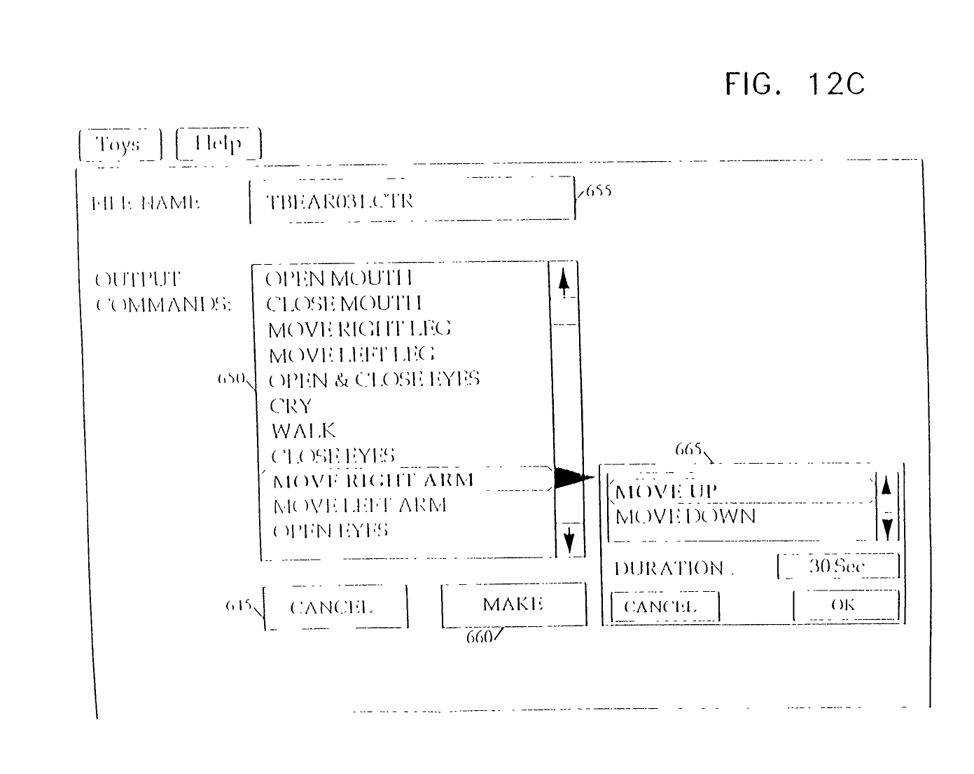

Appendix D is a computer listing of a preferred software implementation of the method of FIGS. 11 and FIGS. 12A-12C;

Appendices E-H, taken together, are computer listings from which a first, DLL-compatible, functions library may be constructed;

Appendices I-O, taken together, are computer listings of a second functions library which may be used to generate a variety of games for any of the computer control systems shown and described herein; and

Appendices P-W, taken together, are computer listings of another preferred software implementation, alternative to the implementation of Appendices A-O.

### DETAILED DESCRIPTION OF PREFERRED EMBODIMENTS

Reference is now made to FIG. 1A which is a partly pictorial, partly block diagram illustration of a computer control system including a toy, constructed and operative in accordance with a preferred embodiment of the present invention. The system of FIG. 1A comprises a computer 100, which may be any suitable computer such as, for example, an IBM-compatible personal computer. The computer 100 is equipped with a screen 105. The computer 100 is preferably equipped with a sound card such as, for example, a Sound Blaster Pro card commercially available from Creative Labs, Inc., 1901 McCarthy Boulevard, Milpitas Calif. 95035 or from Creative Technology Ltd., 67 Ayer Rajah Crescent #03-18, Singapore, 0513; a hard disk; and, optionally, a CD-ROM drive.

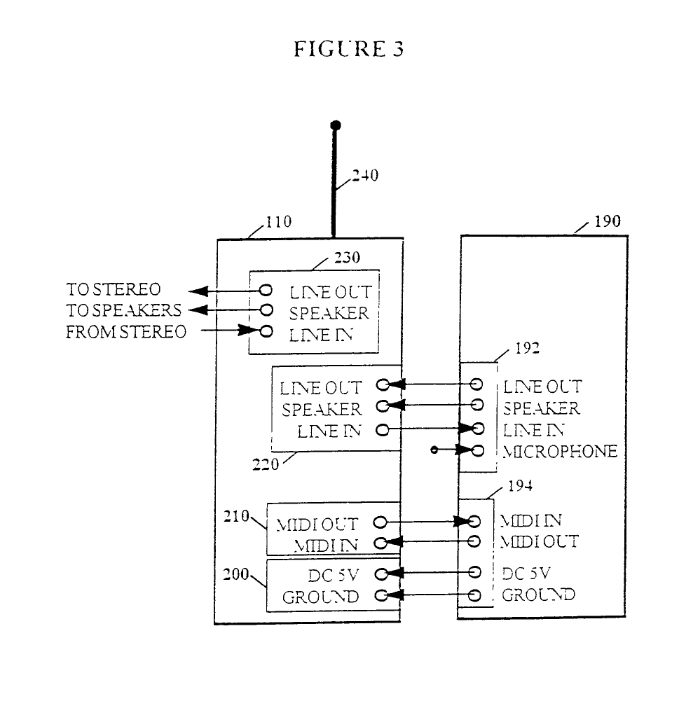

The computer 100 is equipped with a computer radio interface 110 operative to transmit signals via wireless transmission based on commands received from the computer 100 and, in a preferred embodiment of the present invention, also to receive signals transmitted elsewhere via wireless transmission and to deliver the signals to the computer 100. Typically, commands transmitted from the computer 100 to the computer radio interface 110 are transmitted via both analog signals and digital signals, with the digital signals typically being transmitted by way of a MIDI port. Transmission of the analog and digital signals is described below with reference to FIG. 3.

The transmitted signal may be an analog signal or a digital signal. The received signal may also be an analog signal or a digital signal. Each signal typically comprises a message. A preferred implementation of the computer radio interface 110 is described below with reference to FIG. 3.

The system of FIG. 1A also comprises one or more toys 120. The system of FIG. 1A comprises a plurality of toys, namely three toys 122, 124, and 126 but it is appreciated that, alternatively, either one toy only or a large plurality of toys may be used.

Reference is now additionally made to FIG. 1B, which is a partly pictorial, partly block diagram illustration of the toy 122 of FIG. 1A.

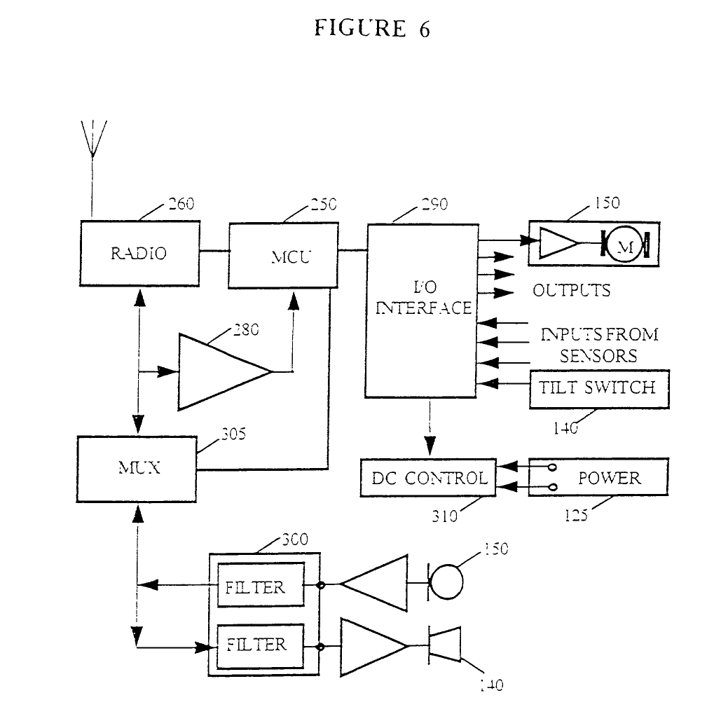

Each toy 120 comprises a power source 125, such as a battery or a connection to line power. Each toy 120 also comprises a toy control device 130, operative to receive a wireless signal transmitted by the computer 100 and to cause each toy 120 to perform an action based on the received signal. The received signal may be, as explained above, an analog signal or a digital signal. A preferred implementation of the toy control device 130 is described below with reference to FIG. 6.

Each toy 120 preferably comprises a plurality of input devices 140 and output devices 150, as seen in FIG. 1B. The input devices 140 may comprise, for example on or more of the following: a microphone 141; a microswitch sensor 142; a touch sensor (not shown in FIG. 1B); a light sensor (not shown in FIG. 1B); a movement sensor 143, which may be, for example, a tilt sensor or an acceleration sensor. Appropriate commercially available input devices include the following: position sensors available from Hamlin Inc., 612 East Lake Street, Lake Mills, Wis. 53551, USA; motion and vibration sensors available from Comus International, 263 Hillside Avenue, Nutley, N.J. 07110, USA; temperature, shock, and magnetic sensors available from Murata Electronics Ltd., Hampshire, England; and switches available from C & K Components Inc., 15 Riverdale Avenue, Newton, Mass. 02058-1082, USA or from Micro Switch Inc., a division of Honeywell, USA. The output devices 150 may comprise, for example, one or more of the following: a speaker 151; a light 152; a solenoid 153 which may be operative to move a portion of the toy; a motor, such as a stepping motor, operative to move a portion of the toy or all of the toy (not shown in FIG. 1B). Appropriate commercially available output devices include the following: DC motors available from Alkatel (dunkermotoren), Postfach 1240, D-7823, Bonndorf/Schwarzald, Germany; stepping motors and miniature motors available from Haydon Switch and Instruments, Inc. (HSI), 1500 Meriden Road, Waterbury, Conn., USA; and DC solenoids available from Communications Instruments, Inc., P.O. Box 520, Fairview, N.C. 28730, USA.

Examples of actions which the toy may perform include the following: move a portion of the toy; move the entire toy; or produce a sound, which may comprise one or more of the following: a recorded sound, a synthesized sound, music including recorded music or synthesized music, speech including recorded speech or synthesized speech.

The received signal may comprise a condition governing the action as, for example, the duration of the action, or the number of repetitions of the action.

Typically, the portion of the received signal comprising a message comprising a command to perform a specific action as, for example, to produce a sound with a given duration, comprises a digital signal. The portion of the received signal comprising a sound, for example, typically comprises an analog signal. Alternatively, in a preferred embodiment of the present invention, the portion of the received signal comprising a sound, including music, may comprise a digital signal, typically a signal comprising MIDI data.

The action the toy may perform also includes reacting to signals transmitted by another toy, such as, for example, playing sound that the other toy is monitoring and transmitting.

In a preferred embodiment of the present invention, the toy control device 130 is also operative to transmit a signal intended for the computer 100, to be received by the computer radio interface 110. In this embodiment, the computer radio interface 110 is preferably also operative to poll the toy control device 130, that is, transmit a signal comprising a request that the toy control device 130 transmit a signal to the computer radio interface 110. It is appreciated that polling is particularly preferred in the case where there are a plurality of toys having a plurality of toy control devices 130.

The signal transmitted by the toy control device 130 may comprise one or more of the following: sound, typically sound captured by a microphone input device 141; status of sensor input devices 140 as, for example, light sensors or micro switch; an indication of low power in the power source 125; or information identifying the toy.

It is appreciated that a sound signal transmitted by the device 130 may also include speech. The computer system is operative to perform a speech recognition operation on the speech signals.

Appropriate commercially available software for speech recognition is available from companies such as: Stylus Innovation Inc., One Kendall Square, Building 300, Cambridge, Mass. 02139, USA; A & G Graphics Interface, USA, Telephone No. (617) 492-0120, Telefax No. (617) 427-3625; “Dragon Dictate For Windows”, available from Dragon Systems Inc., 320 Nevada Street, Mass. 02160, USA, and “SDK” available from Lernout & Hausple Speech Products, Sint-Krispijnstraat 7, 8900 Leper, Belgium.

The signal from the radio control interface 110 may also comprise, for example, one or more of the following: a request to ignore input from one or more input devices 140; a request to activate one or more input devices 140 or to stop ignoring input from one or more input devices 140; a request to report the status of one or more input devices 140; a request to store data received from one or more input devices 140, typically by latching a transition in the state of one or more input devices 140, until a future time when another signal from the radio control interface 110 requests the toy control device 130 to transmit a signal comprising the stored data received from the one or more input devices 140; or a request to transmit analog data, typically comprising sound, typically for a specified period of time.

Typically, all signals transmitted in both directions between the computer radio interface 110 and the toy control device 130 include information identifying the toy.

Reference is now made to FIG. 1C, which is a partly pictorial, partly block diagram illustration of a computer control system including a toy, constructed and operative in accordance with an alternative preferred embodiment of the present invention. The system of FIG. 1C comprises two computers 100. It is appreciated that, in general, a plurality of computers 100 may be used. In the implementation of FIG. 1C, all signals transmitted in both directions between the computer radio interface 110 and the toy control device 130 typically include information identifying the computer.

The operation of the system of FIG. 1A is now briefly described. Typically, the computer 100 runs software comprising a computer game, typically a game including at least one animated character. Alternatively, the software may comprise educational software or any other interactive software including at least one animated object. As used herein, the term “animated object” includes any object which may be depicted on the computer screen 105 and which interacts with the user of the computer via input to and output from the computer. An animated object may be any object depicted on the screen such as, for example: a doll; an action figure; a toy, such as, for example, an activity toy, a vehicle, or a ride-on vehicle; a drawing board or sketch board; or a household object such as, for example, a clock, a lamp, a chamber pot, or an item of furniture.

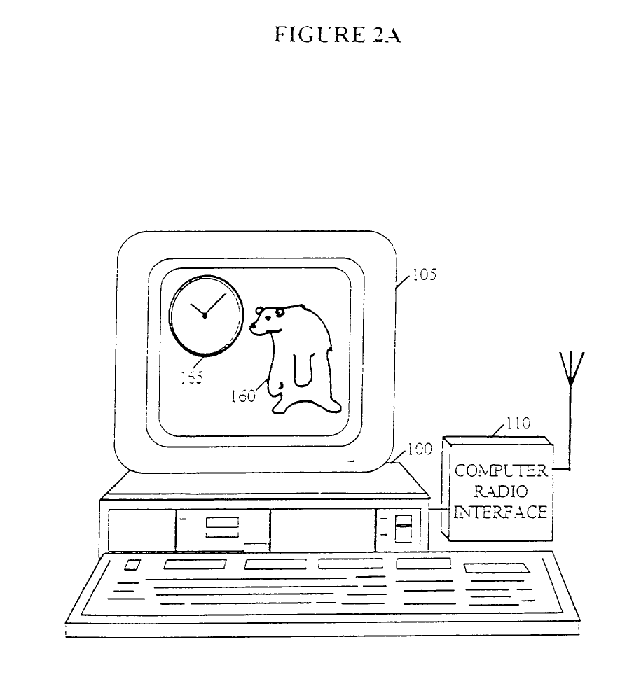

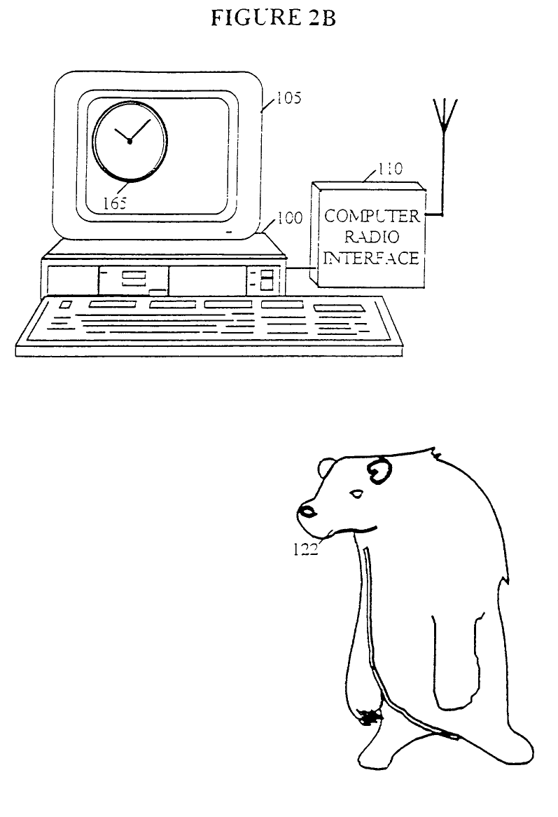

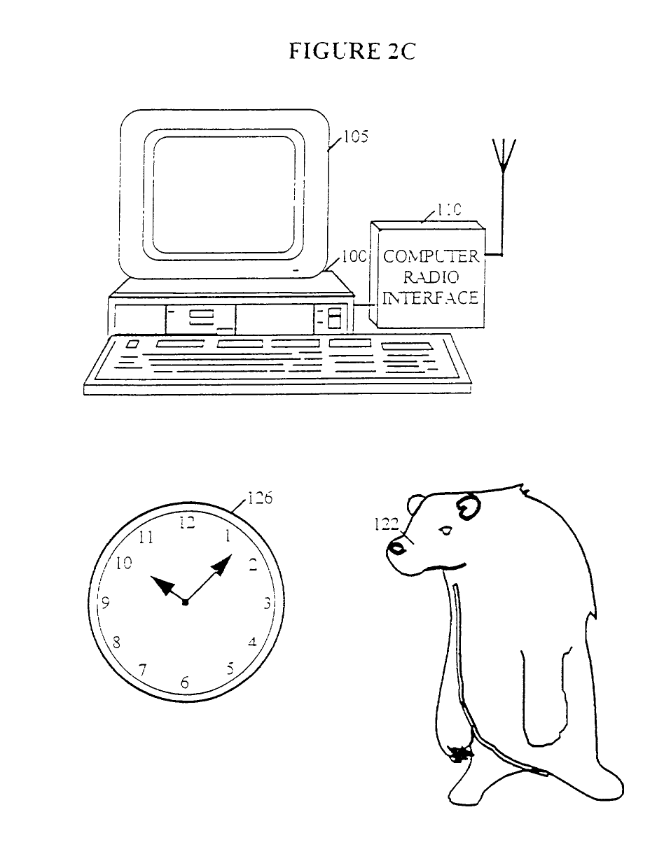

Reference is now additionally made to FIGS. 2A-2C, which depict a portion of the system of FIG. 1A in use. The apparatus of FIG. 2A comprises the computer screen 105 of FIG. 1A. On the computer screen are depicted animated objects 160 and 165.

FIG. 2B depicts the situation after the toy 122 has been brought into range of the computer radio interface 110 of FIG. 1A, typically into the same room therewith. Preferably, the toy 122 corresponds to the animated object 160. For example, in FIG. 2B the toy 122 and the animated object 160, shown in FIG. 2A, are both a teddy bear. The apparatus of FIG. 2B comprises the computer screen 105, on which is depicted the animated object 165. The apparatus of FIG. 2B also comprises the toy 122. The computer 100, having received a message via the computer radio interface 110, from the toy 122, no longer displays the animated object 160 corresponding to the toy 122. The functions of the animated object 160 are now performed through the toy 122, under control of the computer 100 through the computer radio interface 110 and the toy control device 130.

FIG. 2C depicts the situation after the toy 126 has also been brought into range of the computer radio interface 110 of FIG. 1A, typically into the same room therewith. Preferably, the toy 126 corresponds to the animated object 165. For example, in FIG. 2C the toy 126 and the animated object 165, shown in FIGS. 2A and 2B, are both a clock. The apparatus of FIG. 2C comprises the computer screen 105, on which no animated objects are depicted.

The apparatus of FIG. 2C also comprises the toy 126. The computer 100, having received a message via the computer radio interface 110 from the toy 126, no longer displays the animated object 165 corresponding to the toy 126. The functions of the animated object 165 are now performed through the toy 126, under control of the computer 100 through the computer radio interface 110 and the toy control device 130.

In FIG. 2A, the user interacts with the animated objects 160 and 165 on the computer screen, typically using conventional methods. In FIG. 2B the user also interacts with the toy 122, and in FIG. 2C typically with the toys 122 and 126, instead of interacting with the animated objects 160 and 165 respectively. It is appreciated that the user may interact with the toys 122 and 126 by moving the toys or parts of the toys; by speaking to the toys; by responding to movement of the toys which movement occurs in response to a signal received from the computer 100; by responding to a sound produced by the toys, which sound is produced in response to a signal received from the computer 100 and which may comprise music, speech, or another sound; or otherwise.

Reference is now made to FIG. 3 which is a simplified block diagram of a preferred embodiment of the computer radio interface 110 of FIG. 1A. The apparatus of FIG. 3 comprises the computer radio interface 110. The apparatus of FIG. 3 also comprises a sound card 190, as described above with reference to FIG. 1A. In FIG. 3, the connections between the computer radio interface 110 and the sound card 190 are shown.

The computer radio interface 110 comprises a DC unit 200 which is fed with power through a MDI interface 210 from a sound card MIDI interface 194, and the following interfaces: a MIDI interface 210 which connects to the sound card MIDI interface 194; an audio interface 220 which connects to an audio interface 192 of the sound card 190; and a secondary audio interface 230 which preferably connects to a stereo sound system for producing high quality sound under control of software running on the computer 100 (not shown).

The apparatus of FIG. 3 also comprises an antenna 240, which is operative to send and receive signals between the computer radio interface 10 and one or more toy control devices 130.

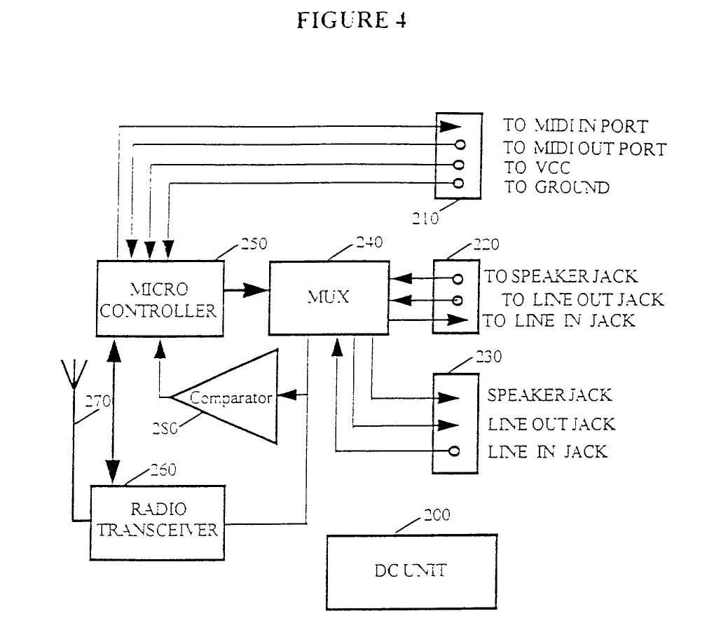

FIG. 4 is a more detailed block diagram of the computer radio interface 110 of FIG. 3. The apparatus of FIG. 4 comprises the DC unit 200, the MIDI interface 210, the audio interface 220, and the secondary audio interface 230. The apparatus of FIG. 4 also comprises a multiplexer 240, a micro controller 250, a radio transceiver 260, a connection unit 270 connecting the radio transceiver 260 to the micro controller 250, and a comparator 280.

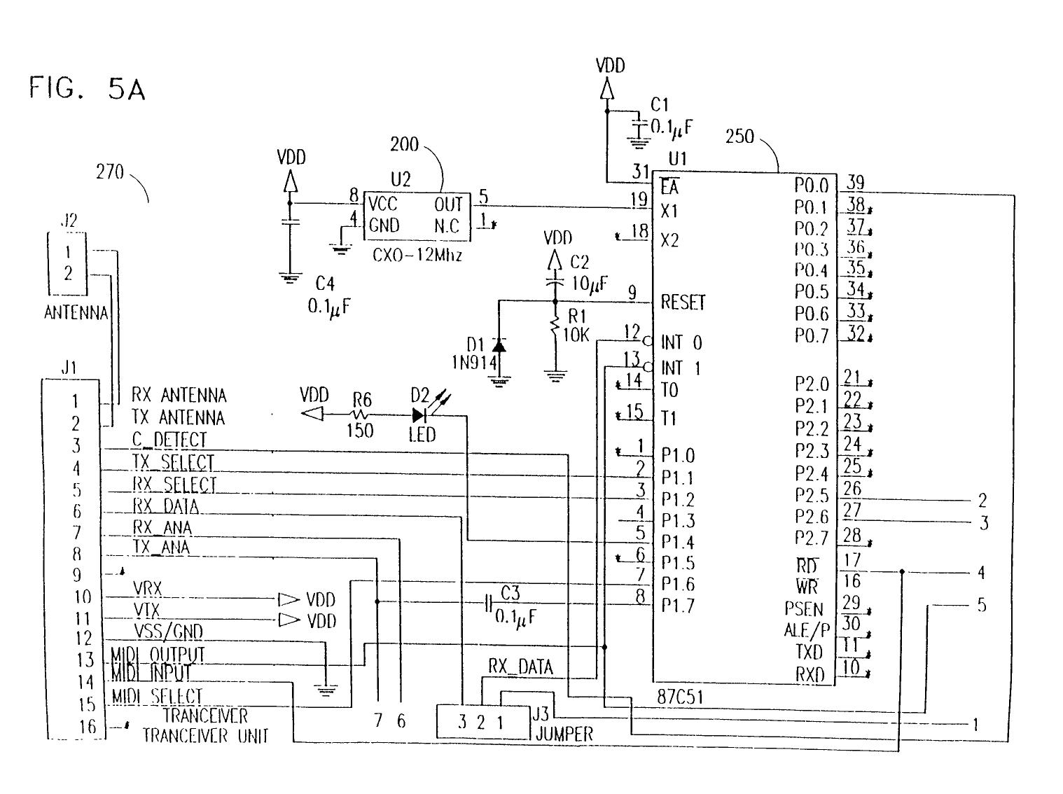

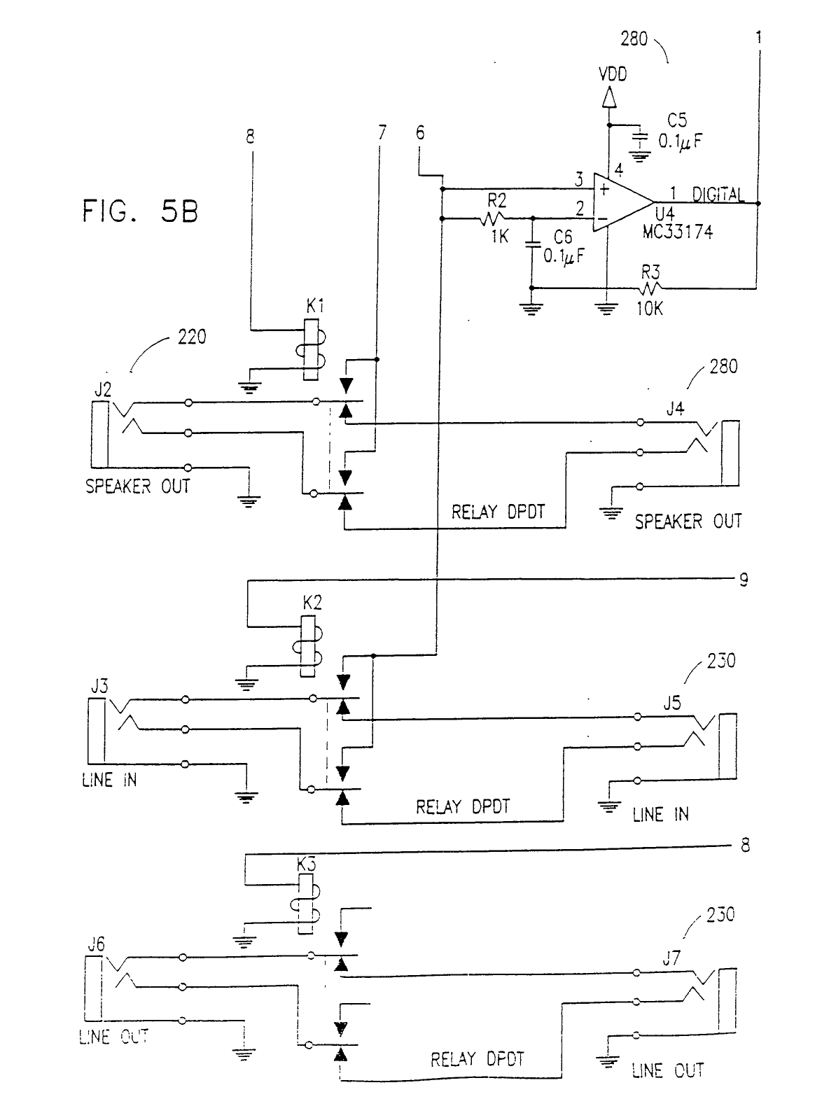

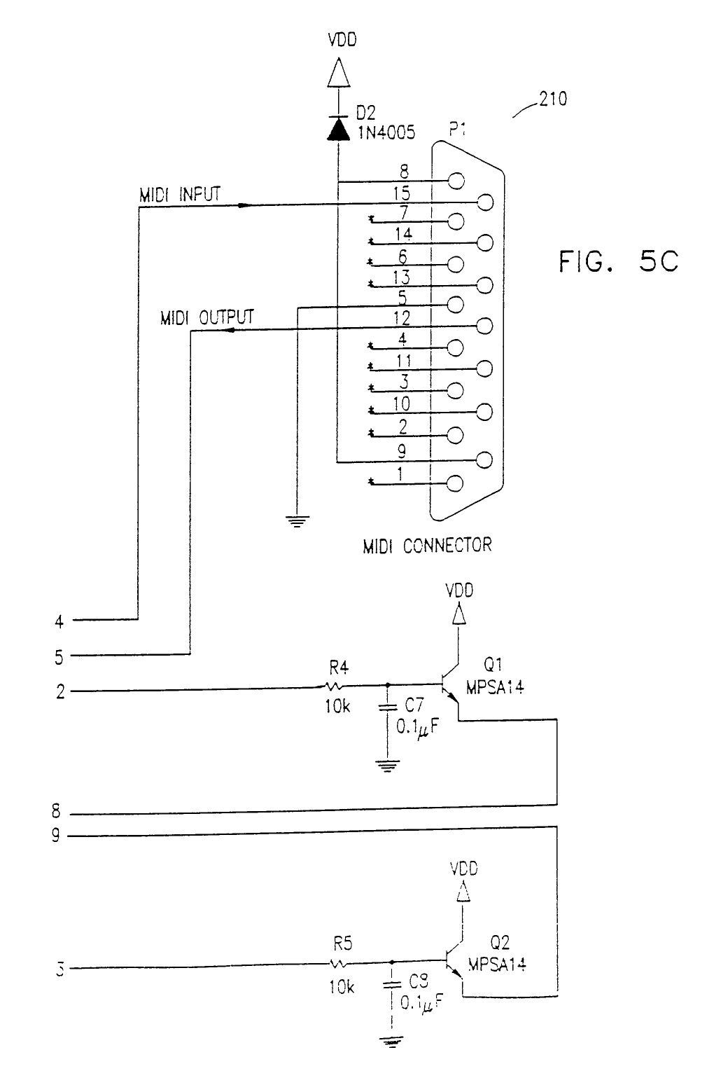

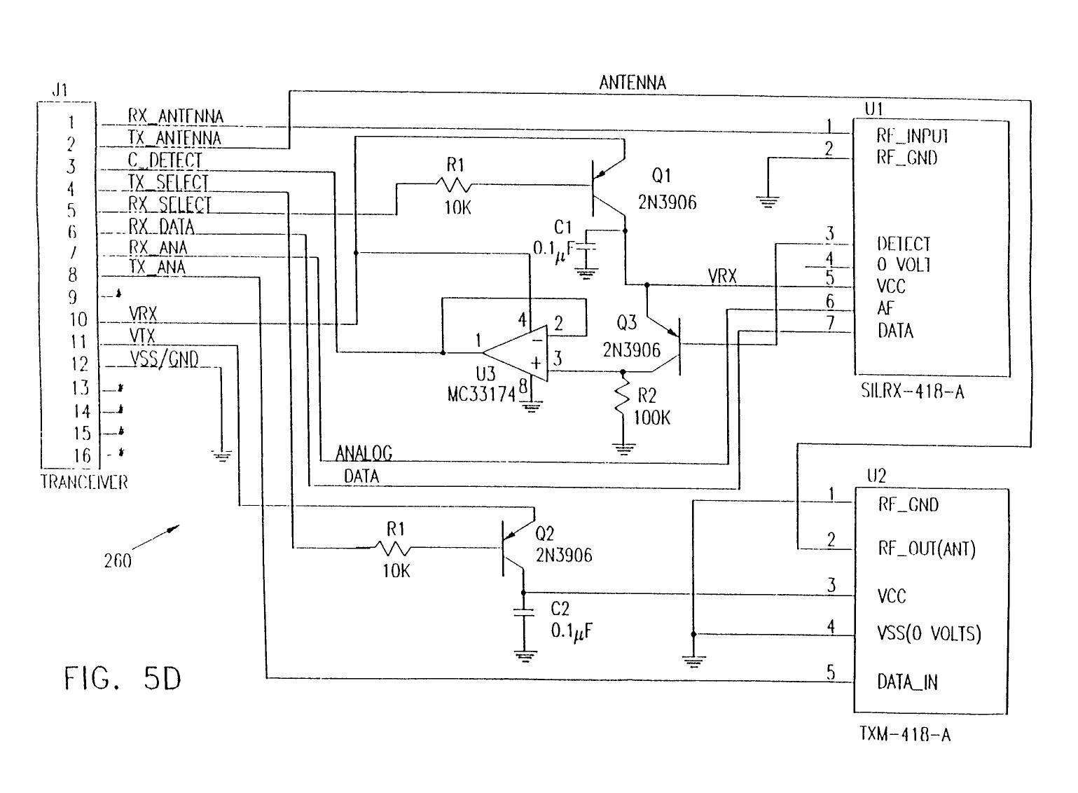

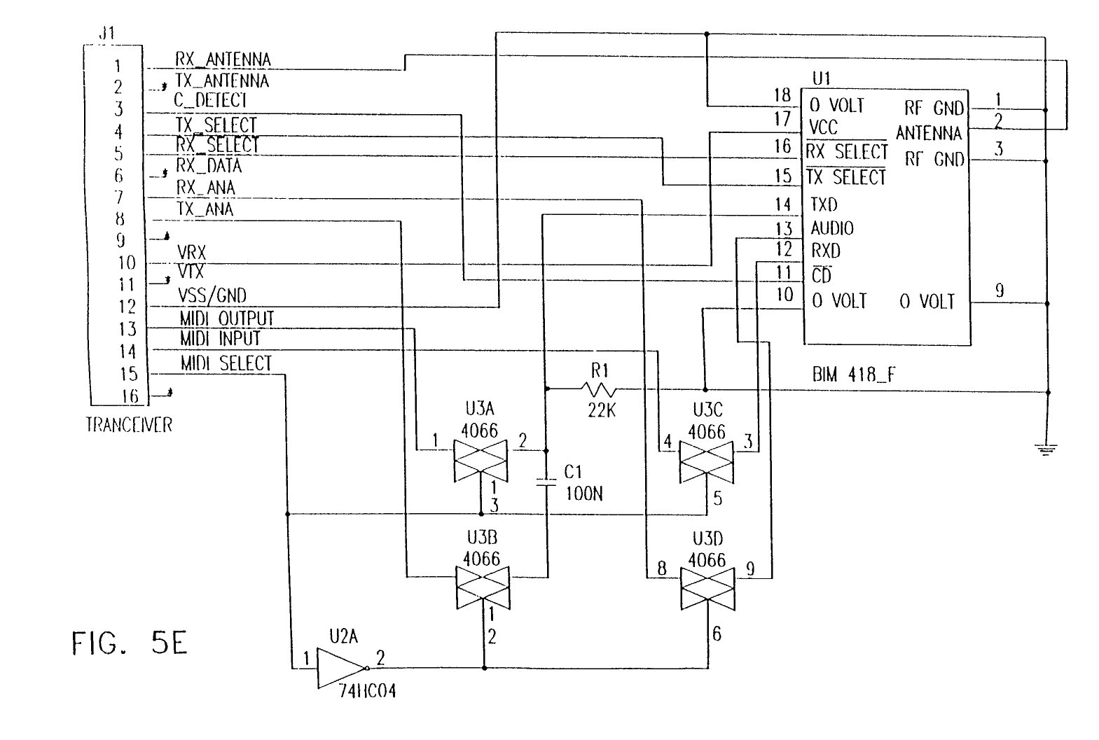

Reference is now made to FIGS. 5A-5D, which taken together comprise a schematic diagram of the apparatus of FIG. 4.

The following is a preferred parts list for the apparatus of FIGS. 5A-5C:

1. K1 Relay Dept, Idec, 1213 Elco Drive, Sunnyvale, Calif. 94089-2211, USA.

2. U1 8751 microcontroller, Intel Corporation, San Tomas 4, 2700 San Tomas Expressway, 2nd Floor, Santa Clara 95051, Calif. USA.

3. U2 CXO-12MHZ (crystal oscillator),Raltron, 2315 N.W. 107th Avenue, Miami Fla. 33172, USA.

4. U4 MC33174, Motorola, Phoenix, Ariz., USA., Tel. No. (602) 897-5056.

5. Diodes 1N914, Motorola, Phoenix, Ariz., USA. Tel. No. (602)897-5056.

6. Transistors 2N2222 and MPSA14, Motorola, Phoenix, Ariz., USA. Tel. No.(602)897-5056.

The following is a preferred parts list for the apparatus of FIG. 5D:

1. U1 SILRAX-418-A UHF radio telemetry receive module, Ginsburg Electronic GmbH, Am Moosfeld 85, D-81829, Munchen, Germany.

Alternatively, U1 of FIG. 5D may be replaced by:

U1 433.92 MHz Receive Module Part No. 0927, available from CEL SALES LTD., Cel House, Unit 2, Block 6, Shenstone Trading Estate, Bromsgrove, Halesowen, West Midlands B36 3XB, UK.

2. U2 TXM-418-A low power UHF radio telemetry transmit module, Ginsburg Electronic GmbH, Am Moosfeld 85, D-1829, Munchen, Germany.

Alternatively, U2 of FIG. 5D may be replaced by:

U2 433.92 SIL FM Transmitter Module Part No, 5229, available from CEL SALES LTD., Cel House, Unit 2, Block 6, Shenstone Trading Estate, Bromsgrove, Halesowen, West Midlands B36 3XB UK.

Reference is now additionally made to FIG. 5E, which is a schematic diagram of an alternative implementation of the apparatus of FIG. 5D. The following is a preferred parts list for the apparatus of FIG. 5E:

1. U1 BIM-418-F low power UHF data transceiver module, Ginsburg Electronic GmbH, Am Moosfeld 85, D-81829, Munchen, Germany.

Alternate 1. U1 S20043 spread spectrum full duplex transceiver, AMI Semiconductors-American Microsystems, Inc., Idaho, USA.

Alternate 1. U1 SDT-300 synthesized transceiver, Circuit Design, Inc., Japan.

Alternatively, U1 may be replaced by:

U1 RY3GB021 RF 900Mhz units, available from SHARP ELECTRONIC COMPONENTS GROUP, 5700 Northwest, Pacific Rim Boulevard #20, Camas, Wash., USA.

U1 RY3GB100 RF Units For DECT, available from SHARP ELECTRONIC COMPONENTS GROUP 5700 Northwest, Pacific Rim Boulevard #20, Camas, Wash., USA.

In the parts list for FIG. 5E, one of item 1 or either of the alternate items 1 may be used for U1.

It is appreciated that the appropriate changes will have to be made to all the circuit boards for alternate embodiments of the apparatus.

The apparatus of FIG. 5E has similar functionality to the apparatus of FIG. 5D, but has higher bit rate transmission and reception capacity and is, for example, preferred when MIDI data is transmitted and received.

FIGS. 5A-5E are self-explanatory with regard to the above parts lists.

Reference is now made to FIG. 6 which is a simplified block diagram of a preferred embodiment of the toy control device 130 of FIG. 1A. The apparatus of FIG. 6 comprises a radio transceiver 260, similar to the radio transceiver 260 of FIG. 4. The apparatus of FIG. 6 also comprises a microcontroller 250 similar to the microcontroller 250 of FIG. 4.

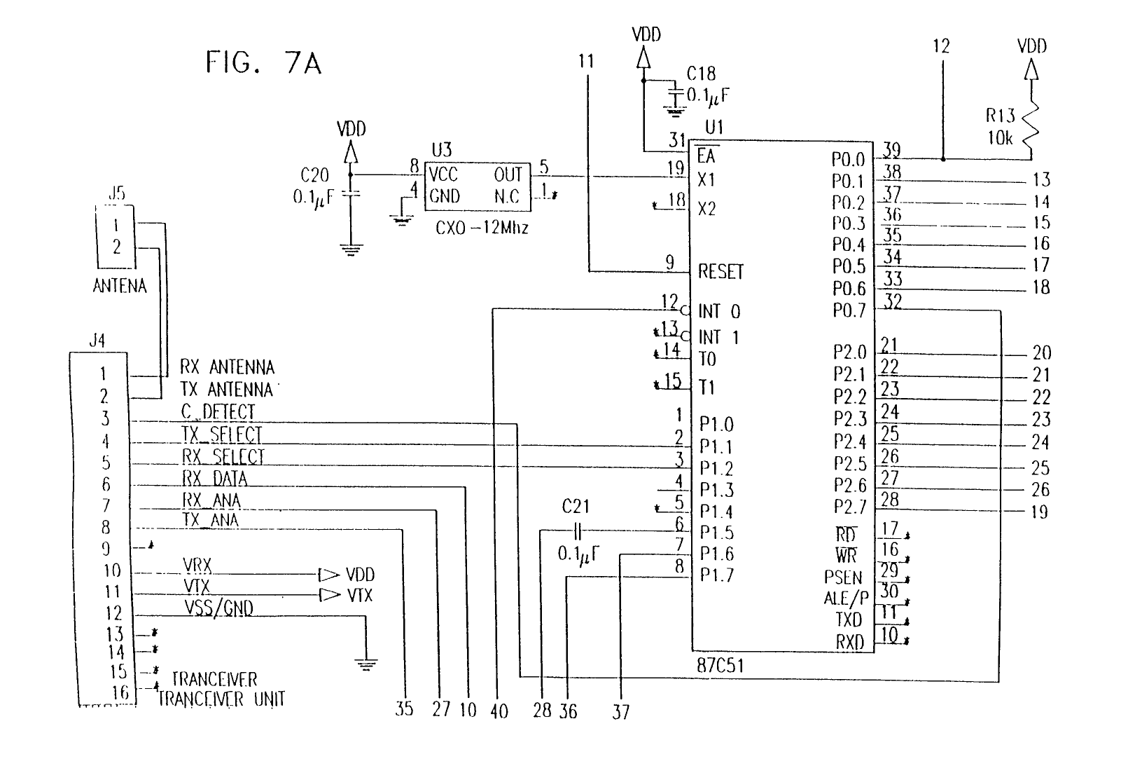

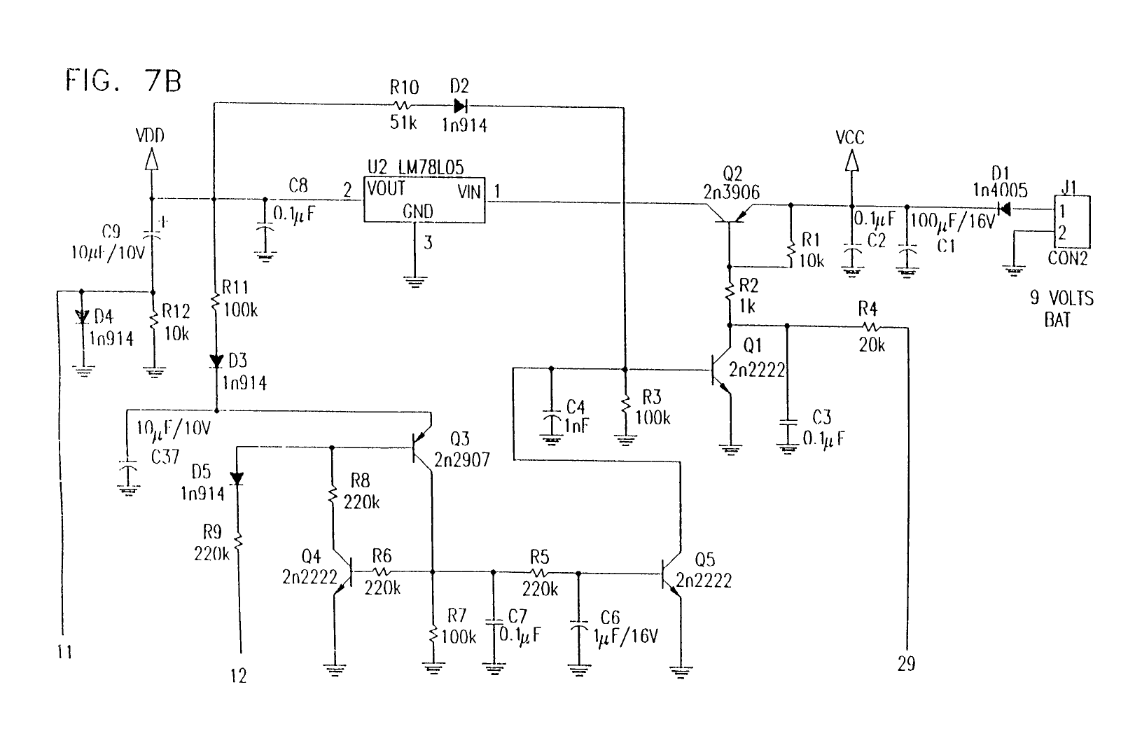

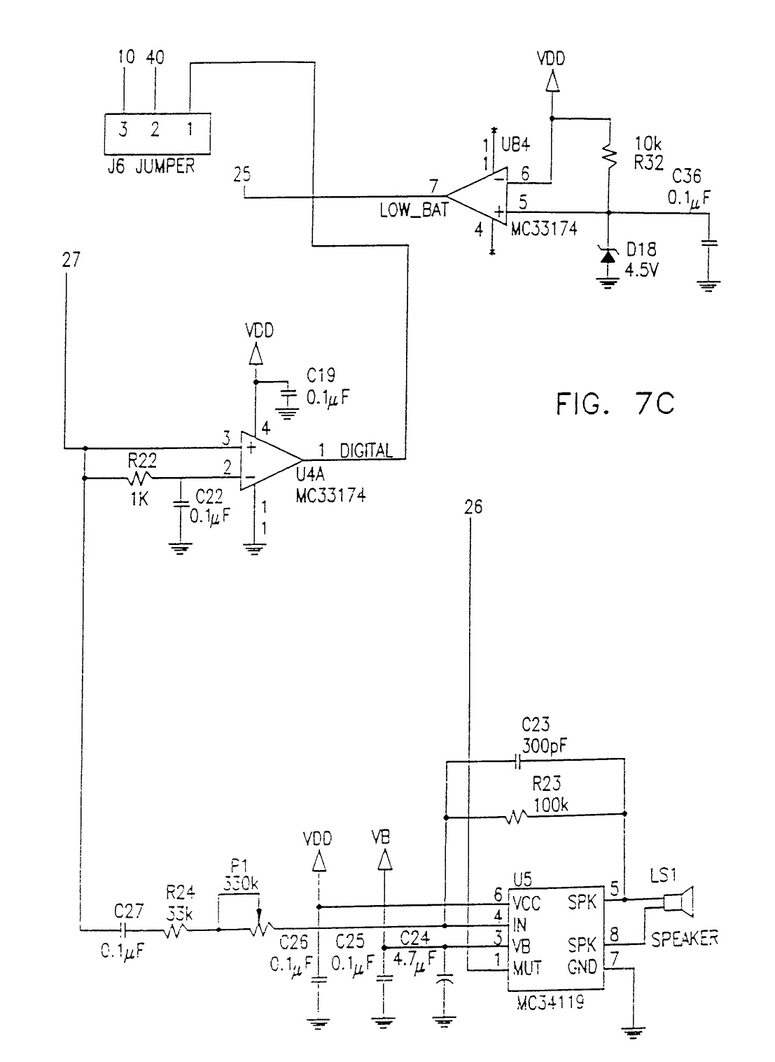

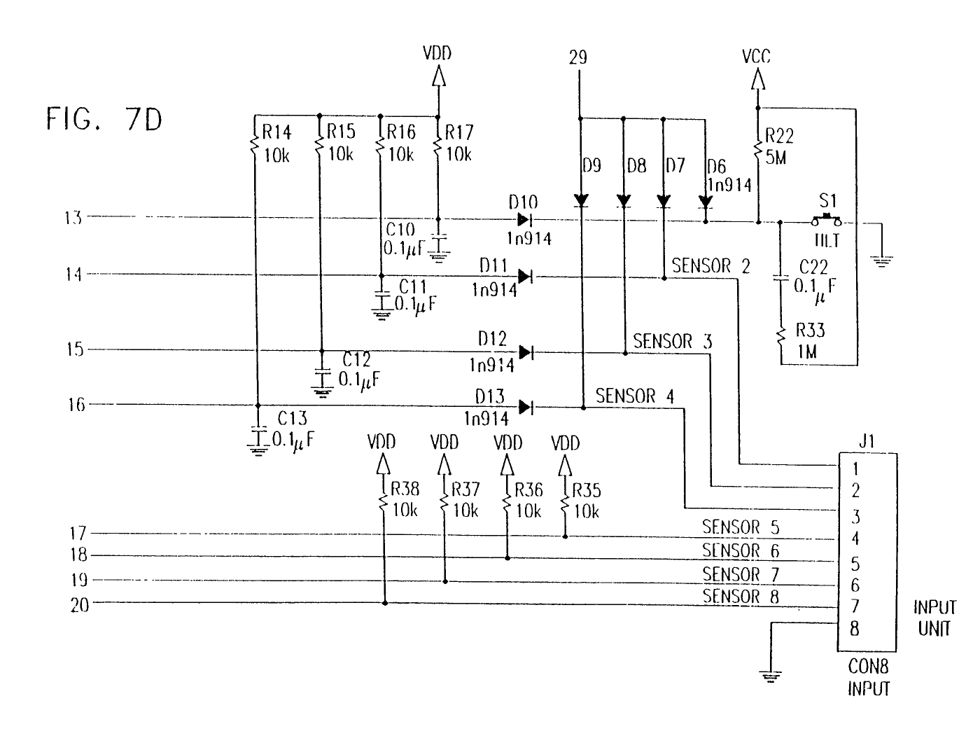

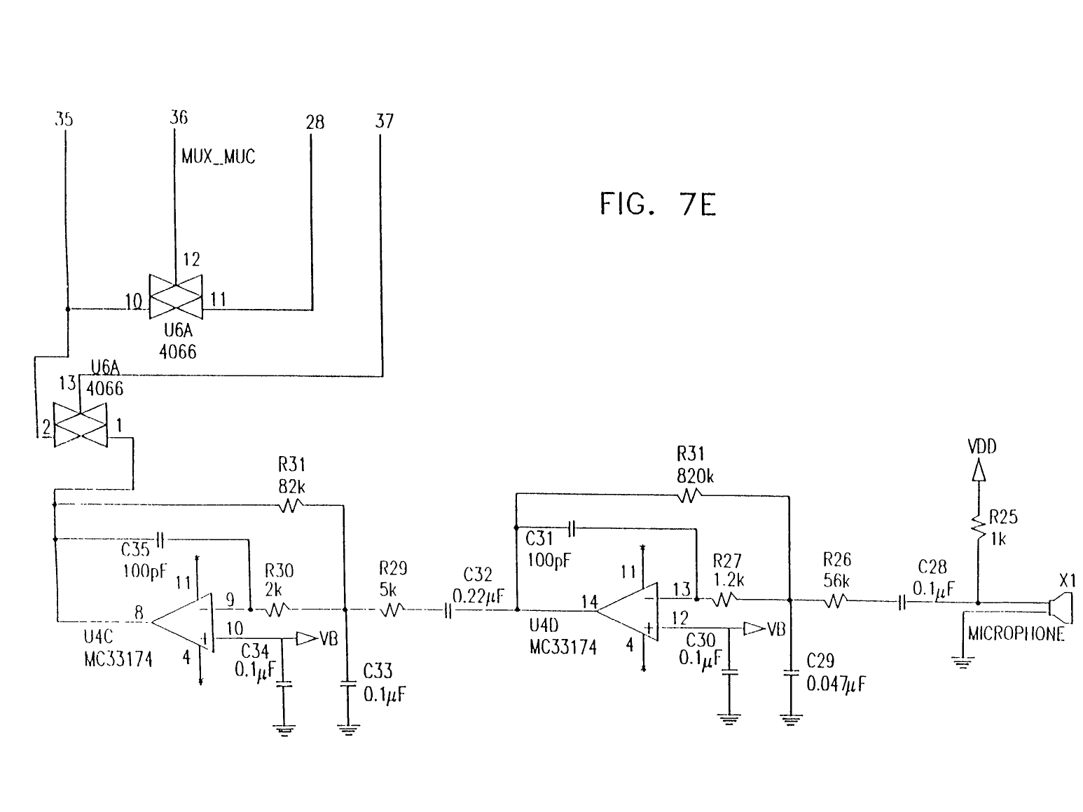

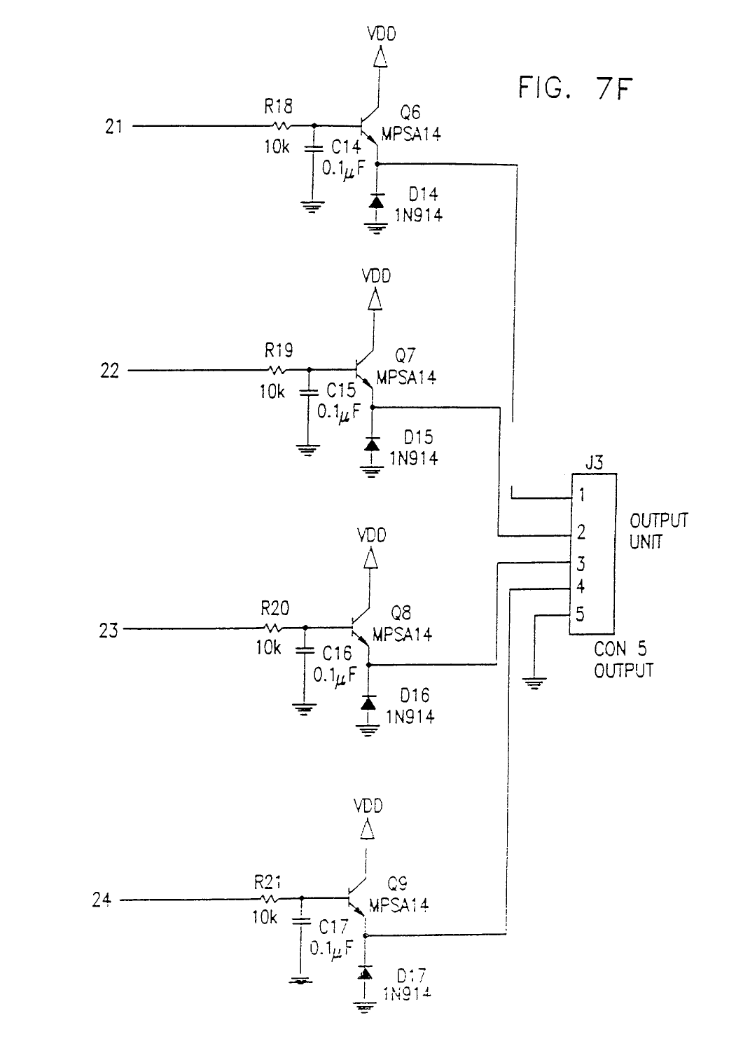

The apparatus of FIG. 6 also comprises a digital input/output interface (digital I/O interface) 290, which is operative to provide an interface between the microcontroller 250 and a plurality of input and output devices which may be connected thereto such as, for example, four input device and four output devices. A preferred implementation of the digital I/O interface 290 is described in more detail below with reference to FIG. 7A-7F.

The apparatus of FIG. 6 also comprises an analog input/output interface (analog I/O interface) 300 operatively connected to the radio transceiver 260, and operative to receive signals therefrom and to send signals thereto.

The apparatus of FIG. 6 also comprises a multiplexer 305 which is operative, in response to a signal from the microcontroller 250, to provide output to the analog I/O interface 300 only when analog signals are being transmitted by the radio transceiver 260, and to pass input from the analog I/O interface 300 only when such input is desired.

The apparatus of FIG. 6 also comprises input devices 140 and output devices 150. In FIG. 6, the input devices 140 comprise, by way of example, a tilt switch operatively connected to the digital I/O interface 290, and a microphone operatively connected to the analog I/O interface 300. It is appreciated that a wide variety of input devices 140 may be used.

In FIG. 6, the output devices 150 comprise, by way of example, a DC motor operatively connected to the digital I/O interface 290, and a speaker operatively connected to the analog I/O interface 300. It is appreciated that a wide variety of output devices 150 may be used.

The apparatus of FIG. 6 also comprises a DC control 310, a preferred implementation of which is described in more detail below with reference to FIGS. 7A-7F.

The apparatus of FIG. 6 also comprises a comparator 280, similar to the comparator 280 of FIG. 4.

The apparatus of FIG. 6 also comprises a power source 125, shown in FIG. 6 by way of example as batteries, operative to provide electrical power to the apparatus of FIG. 6 via the DC control 310.

Reference is now made to FIGS. 7A-7F which, taken together with either FIG. 5D or 5E, comprise a schematic diagram of the toy control device of FIG. 6. If the schematics of FIG. 5E is employed to implement the computer radio interface of FIG. 4, using RY3GB021 as U1 of FIG. 5E, then the same schematics of FIG. 5E are preferably employed to implement the toy control device of FIG. 6 except that RY3GH021 is used to implement U1 rather than RY3GB021.

The following is a preferred parts list for the apparatus of FIGS. 7A-7F:

1. U1 8751 microcontroller, Intel Corporation, San Tomas 4, 2700 San Tomas Expressway, 2nd Floor, Santa Clara 95051, Calif. USA.

2. U2 LM78L05, National Semiconductor, 2900 Semiconductor Drive, Santa Clara, Calif. 95052, USA.

3. U3 CXO-12 MHz (crystal oscillator), Raltron, 2315 N.W. 107th Avenue, Miami, Fla. 33172, USA.

4. U4 MC33174, Motorola, Phoenix, Ariz., USA. Tel. No. (602) 897-5056.

5. U5 MC34119, Motorola, Phoenix, Ariz., USA. Tel. No. (602) 897-5056.

6. U6 4066, Motorola, Phoenix, Ariz., USA. Tel. No. (602) 897-5056.

7. Diode 1N914, 1N4005, Motorola, Phoenix, Ariz., USA. Tel. No. (602) 897-5056.

8. Transistor 2N2222, 2N3906, Motorola, Phoenix, Ariz., USA. Tel. No. (602) 897-5056.

9. Transistors 2N2907 and MPSA14, Motorola, Phoenix, Ariz., USA. Tel. No. (602) 897-5056.

FIGS. 7A-7F are self-explanatory with reference to the above parts list.

As stated above with reference to FIG. 1A, the signals transmitted between the computer radio interface 110 and the toy control device 130 may be either analog signals or digital signals. It the case of digital signals, the digital signals preferably comprise a plurality of predefined messages, known to both the computer 100 and to the toy control device 130.

Each message sent by the computer radio interface 110 to the toy control device 130 comprises an indication of the intended recipient of the message. Each message sent by the toy control device 130 to the computer radio interface 110 comprises an indication of the sender of the message.

In the embodiment of FIG. 1C described above, messages also comprise the following:

each message sent by the computer radio interface 110 to the toy control device 130 comprises an indication of the sender of the message; and

each message sent by the toy control device 130 to the computer radio interface 110 comprises an indication of the intended recipient of the message.

A preferred set of predefined messages is as follows:

COMMAND STRUCTURE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |

COMMANDS LIST
From the Computer to the Toy control device.
A. OUTPUT COMMANDS
SET_IO_TO_DATA

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 00 | 01 | 00 | IO | 00 | D | x | x | |

Set Toy control device output pin to a digital level D.

| | | |
|---|---|---|
| P: | Computer address | 00-03 H |
| A: | unit address - | 00-FF H |
| IO: | i/o number - | 00-03 H |
| D: | Data - | 00-01 H |

| Example | | | | | | | | | | | | | |
|---|---|---|---|---|---|---|---|---|---|---|---|---|---|
| 1. 01 00 00 05 00 01 03 01 00 00 | | | | set io 3 to “1” | | | | | | | | | |
| 2. 01 00 00 05 00 01 03 00 00 00 | | | | set io 3 to “0” | | | | | | | | | |
| CHANGE_IO_FOR_TIME | | | | | | | | | | | | | |
| byte 0 | byte 1 | | byte 2 | byte 3 | byte 4 | byte 5 | byte 6 | | byte 7 | | byte 8 | | byte 9 |
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 00 | 02 | 00 | IO | 00 | D | T1 | T2 | |

Change Toy control device output pin to D for a period of time and then return to previous state.

| | | |
|---|---|---|
| P: | Computer address | 00-03 H |
| A: | unit address - | 00-FF H |
| IO: | i/o number - | 00-03 H |
| T1, T2: | time - | 00-FF H |
| D: | Data - | 00-01 H |

| | |
|---|---|
| example: | |
| 1. 01 00 00 05 00 02 03 05 00 00 | set io 3 to “1” for 5 seconds |

B. INPUT COMMANDS
SEND_STATUS_OF_SENSORS

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 00 | x | x | x | x | x | x | |

send the Toy control device status of all sensors.

| | | |
|---|---|---|
| P: | Computer address | 00-03 H |
| A: | unit address - | 00-FF H |

| example: | | | | | | | | | | | | | |
|---|---|---|---|---|---|---|---|---|---|---|---|---|---|
| 1. 01 00 00 05 01 00 00 00 00 00 | | | | send current status of sensors | | | | | | | | | |
| SENSORS_SCAN_MODE_ON | | | | | | | | | | | | | |
| byte 0 | byte 1 | | byte 2 | byte 3 | byte 4 | byte 5 | byte 6 | | byte 7 | | byte 8 | | byte 9 |
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 01 | x | x | x | x | x | x | |

Start scanning the Toy control device sensors, and if one of them is closed (pressed to ‘0’), send back an ack.

| | | |
|---|---|---|
| P: | Computer address | 00-03 H |
| A: | unit address - | 00-FF H |

| | |
|---|---|
| example: | |
| 1. 01 00 00 05 01 01 00 00 00 00 | scan mode of sensors ON |

SENSORS_SCAN_MODE_ON_ONCE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 02 | x | x | x | x | x | x | |

Start scanning the Toy control device sensors, and if one of them is closed (pressed to ‘0’), send back an ack,
then disable scanning the sensors.

| | | |
|---|---|---|
| P: | Computer address | 00-03 H |
| A: | unit address - | 00-FF H |

| | |
|---|---|
| 1. 01 00 00 05 01 02 00 00 00 00 | scan mode of sensors ON once |

SENSORS_SCAN_MODE_OFF

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 03 | x | x | x | x | x | x | |

Stop scanning the Toy control device sensors.

| | | |
|---|---|---|
| P: | Computer address | 00-03 H |
| A: | unit address - | 00-FF H |

| | |
|---|---|
| example: | |
| 1. 01 00 00 05 01 03 00 00 00 00 | scan mode of sensors OFF |

C. AUDIO OUT COMMANDS
START_AUDIO_PLAY

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 02 | 00 | x | x | x | x | xx | xx | |

Start playing an audio in a speaker of the Toy control device The Audio is sent to the Toy control device
by the computer sound card and the Computer radio interface.

| | | |
|---|---|---|
| P: | Computer address | 00-03 H |
| A: | unit address - | 00-FF H |

| 1. 01 00 00 05 02 00 00 00 00 00 | | | | Start audio-play | | | | | | | | | |
|---|---|---|---|---|---|---|---|---|---|---|---|---|---|
| STOP_AUDIO_PLAY | | | | | | | | | | | | | |
| byte 0 | byte 1 | | byte 2 | byte 3 | byte 4 | byte 5 | byte 6 | | byte 7 | | byte 8 | | byte 9 |
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 02 | 01 | x | x | x | x | x | x | |

Stop playing an audio in a speaker of the Toy control device.

| | | |
|---|---|---|
| P: | Computer address | 00-03 H |
| A: | unit address - | 00-FF H |

| | |
|---|---|
| 1. 01 00 00 05 02 01 00 00 00 00 | Stop audio-play |

START_AUDIO_AND_IO_PLAY_FOR_TIME

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 02 | 04 | T1 | T2 | T0 | td | SC | IO | |

Start playing an audio in a speaker of the Toy control device and set an io pin to “1”. After time T, stop audio and set
IO to ‘0’. start this command after a delay td* 100 ms. if SC=“1” then after the execution of this command,
start the input command SCAN_SENSORS_ON_ONCE (if any sensor is pressed, even during the audio play,
send a message to the computer).

| | | | |
|---|---|---|---|
| P: | Computer address | 00-03 H | |
| A: | unit address - | 00-FF H | |
| IO: | i/o number - | 0-3 H | (if IO>3 then don't set IO) |
| T0,T1,T2: | TIME | 000-FFF H | (*100 ms) (T0=MMSB, T1=MSB, T0=LSB) |
| td: | delay time befor execute | 0-F H | (*100 ms) |

| | |
|---|---|
| 1. 01 00 00 05 02 04 80 2A 03 00 | Start audio-play and IO #3 for 6.4 second |
| | 640=280H |
| | delay before execution = 10* 100 ms=1 sec |
| 2. 01 00 00 05 02 04 80 2A 13 00 | Start audio-play and IO #3 for 6.4 second and |
| | set scan sensors on once mode. |
| | delay before execution = 10* 100 ms=1 sec |

D. AUDIO IN COMMANDS
TRANSMIT_MIC_FOR_TIME

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 03 | 00 | T1 | t2 | x | x | x | x | |

Requests the Toy control device to Transmit microphone audio from the Toy control device to the Computer
radio interface and to the sound card of the computer for time T.

| | | |
|---|---|---|
| P: | Computer address | 00-03 H |
| A: | unit address - | 00-FF H |
| T1,T2: | TIME | 00-FF H (SEC) |

| | |
|---|---|
| example: | |
| 1. 01 00 00 05 03 00 0A 00 00 00 | start mic mode for 10 seconds |

E. GENERAL TOY COMMANDS
GOTO_SLEEP_MODE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 01 | x | x | x | x | x | x | |

Requests the Toy control device to go into power save mode (sleep)

| | | |
|---|---|---|
| P: | Computer address | 00-03 H |
| A: | unit address - | 00-FF H |

| 1. 01 00 00 05 04 01 00 00 00 00 | | | | switch the Toy control device into sleep mode. | | | | | | | | | |
|---|---|---|---|---|---|---|---|---|---|---|---|---|---|
| GO_TO_AWAKE_MODE | | | | | | | | | | | | | |
| byte 0 | byte 1 | | byte 2 | byte 3 | byte 4 | byte 5 | byte 6 | | byte 7 | | byte 8 | | byte 9 |
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 02 | x | x | x | x | x | x | |

Requests the Toy control device to go into an awake mode.

| | | |
|---|---|---|
| P: | Computer address | 00-03 H |
| A: | unit address - | 00-FF H |

| 1. 01 00 00 05 04 02 00 00 00 00 | | | | switch the Toy control device into awake mode. | | | | | | | | | |
|---|---|---|---|---|---|---|---|---|---|---|---|---|---|
| TOY_RESET | | | | | | | | | | | | | |
| byte 0 | byte 1 | | byte 2 | byte 3 | byte 4 | byte 5 | byte 6 | | byte 7 | | byte 8 | | byte 9 |
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 0F | x | x | x | x | x | x | |

Requests the Toy control device to perform RESET

| | | |
|---|---|---|
| P: | Computer address | 00-03 H |
| A: | unit address - | 00-FF H |

| | |
|---|---|
| 1. 01 00 00 05 04 0F 00 00 00 00 | Toy reset |

TOY_USE_NEW_RF_CHANNELS

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 0A | CH1 | Ch2 | x | x | x | x | |

Requests the Toy control device to switch to new RF transmit and receive channels.

| | | |
|---|---|---|
| P: | Computer address | 00-03 H |
| A: | unit address - | 00-FF H |
| CH 1: | Transmit RF channel number | 0-F H |
| CH2: | Receive RF Channel number | 0-F H |

| | |
|---|---|
| 1. 01 00 00 05 04 0A 12 00 00 00 | Switch to new RX and TX RF channels |

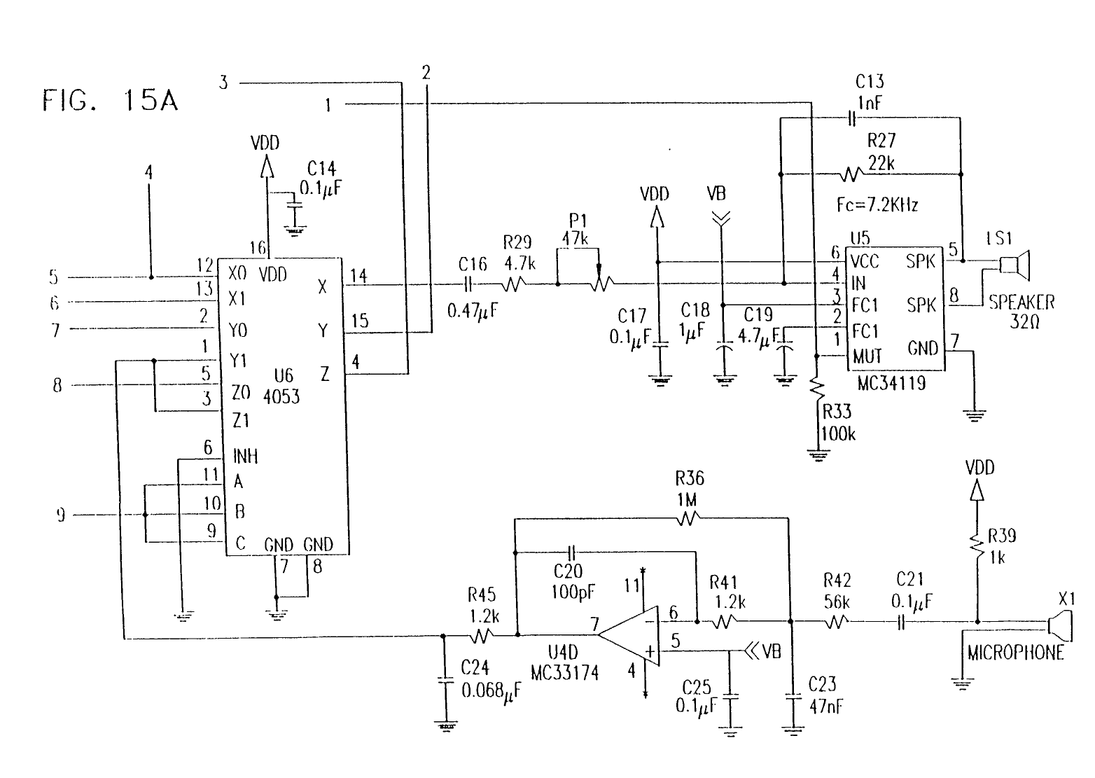

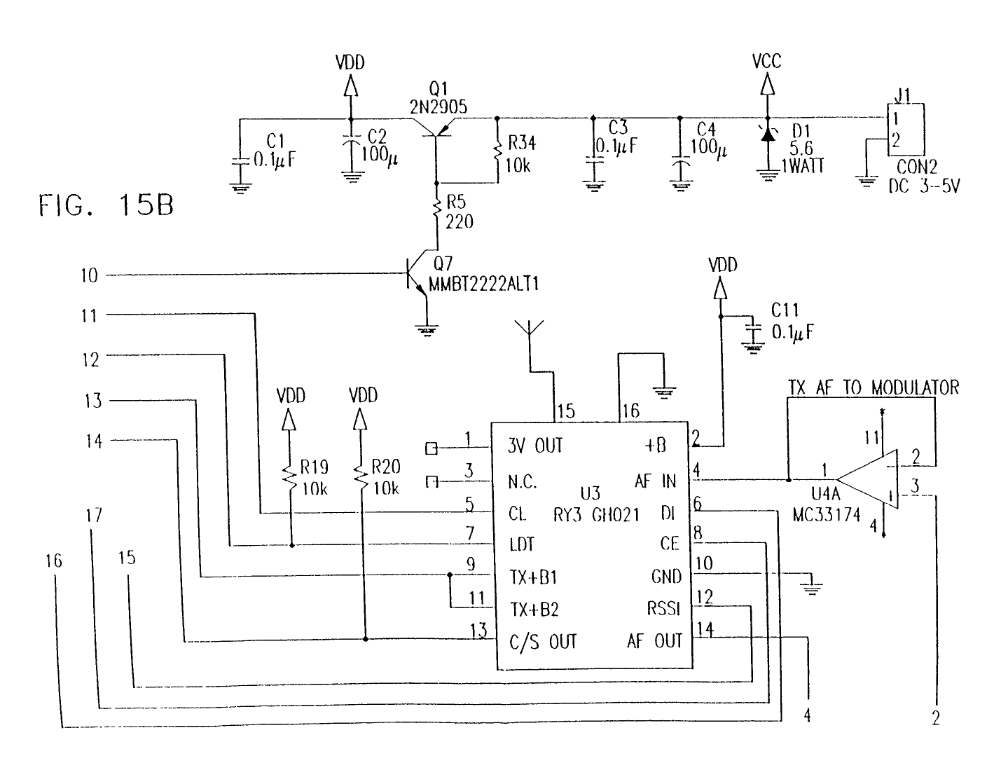

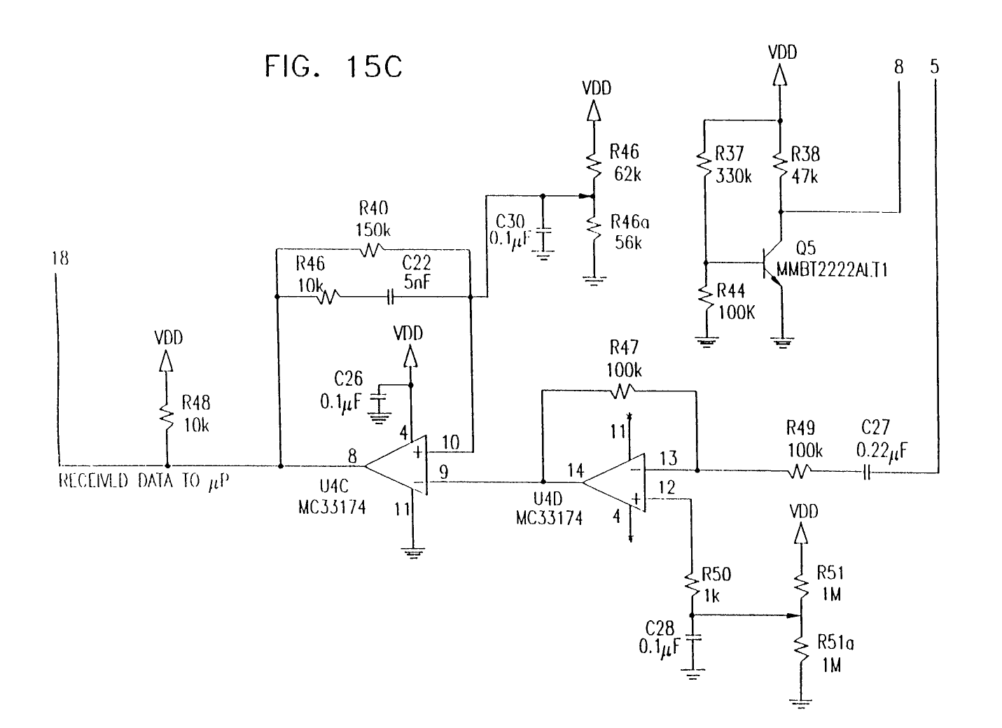

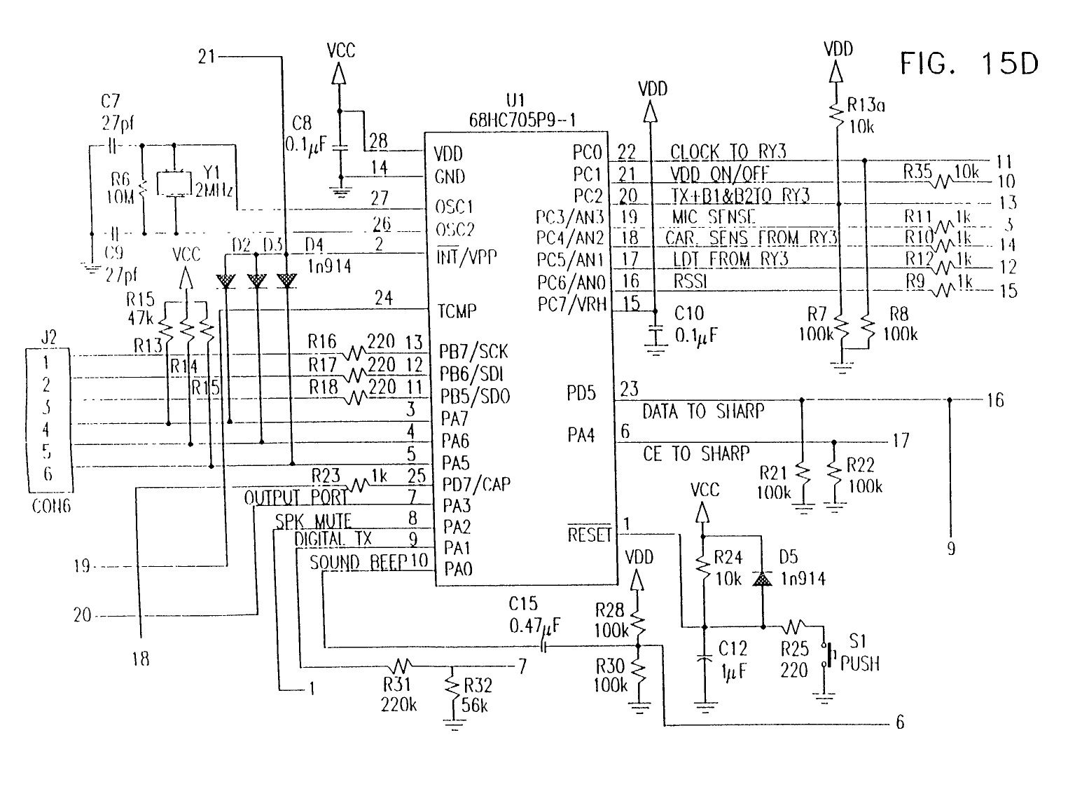

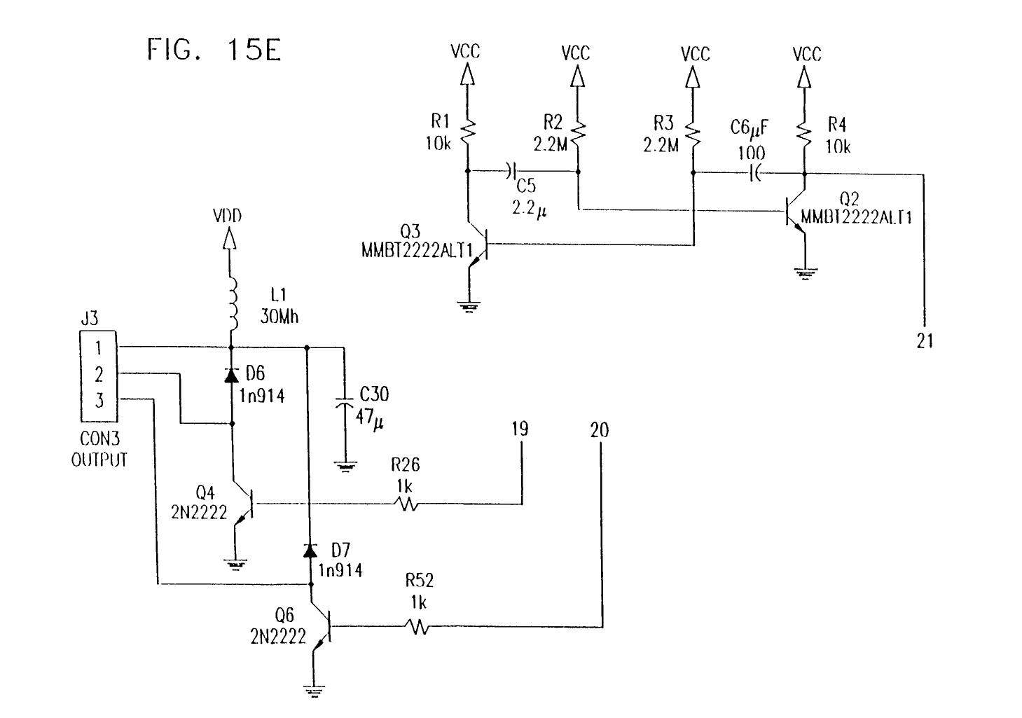

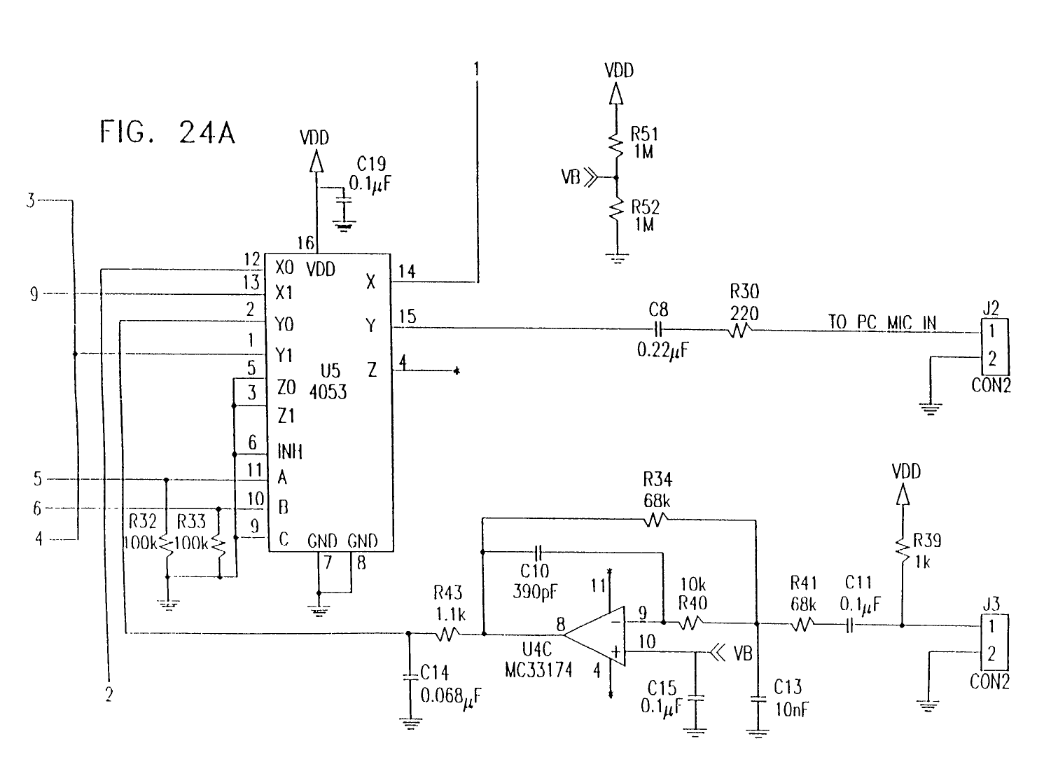

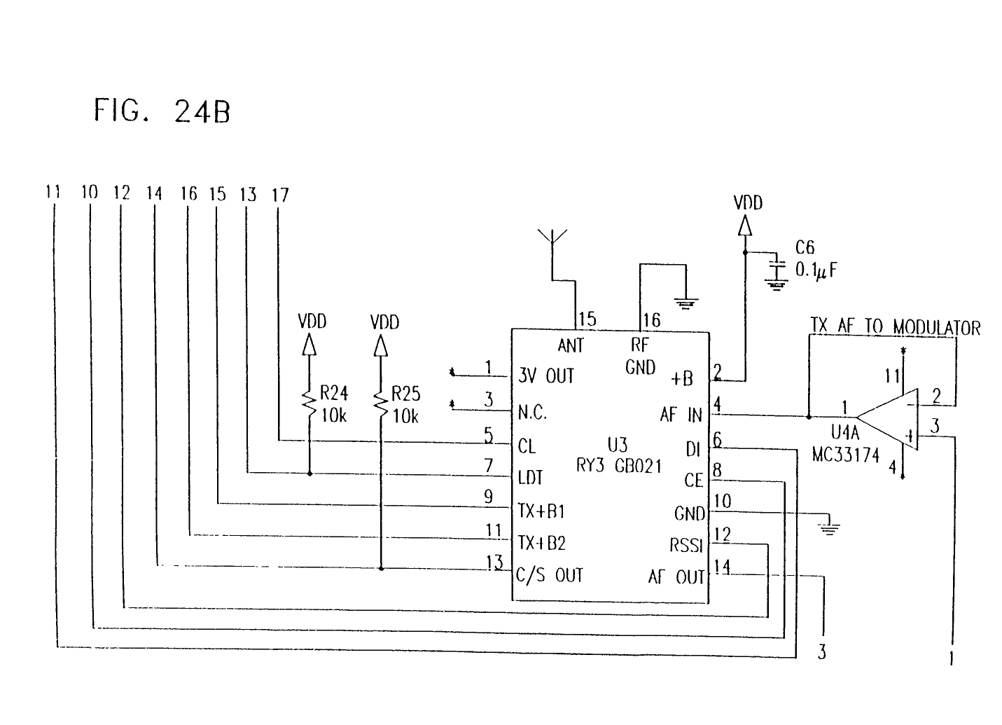

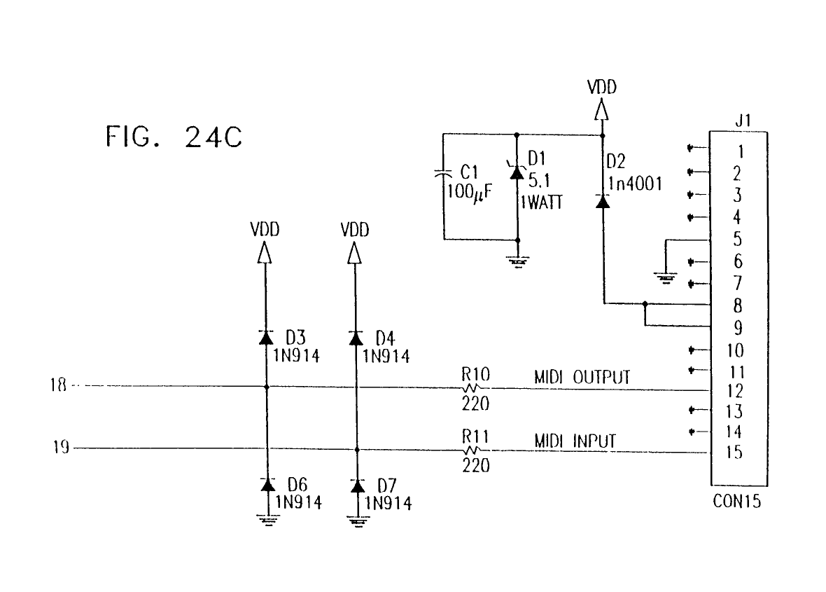

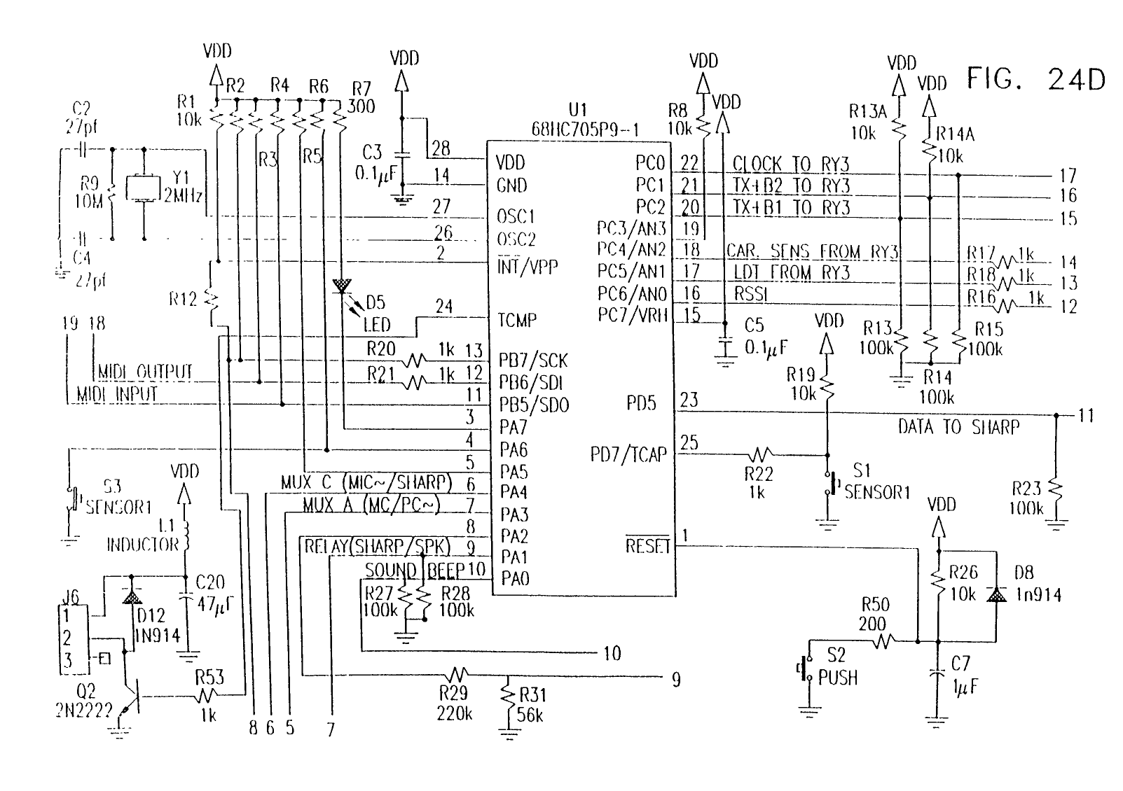

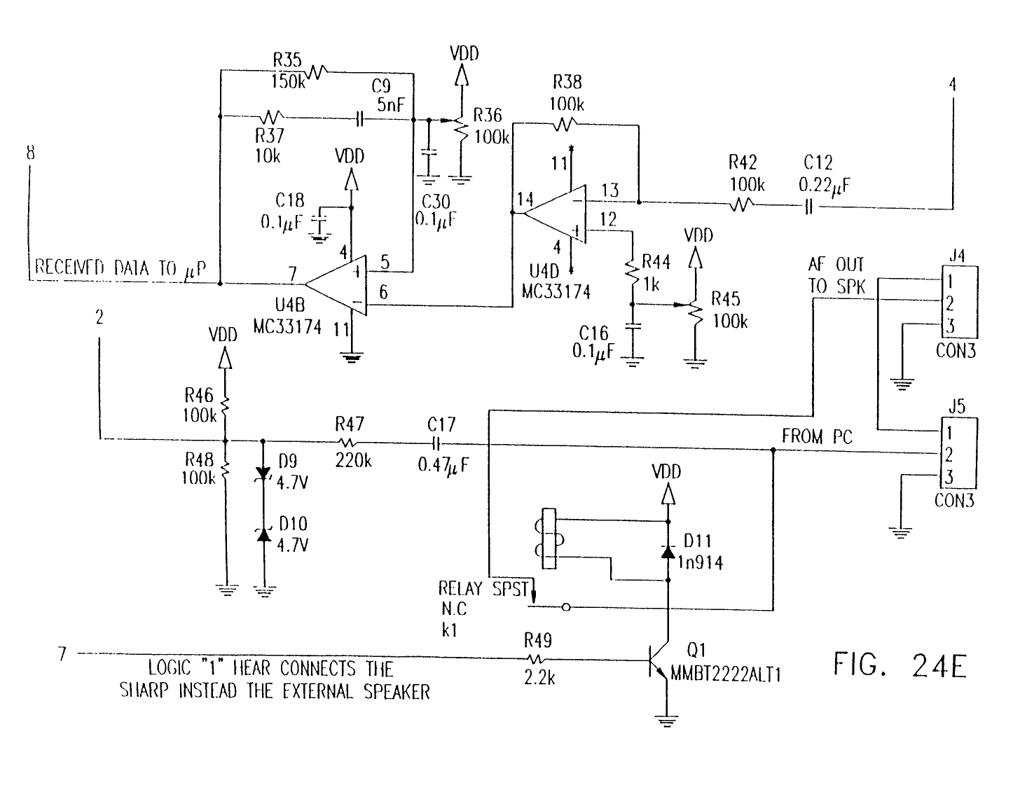

Note: This command is available only with enhanced radio modules (alternate U1 of FIG. 5E) or with the
modules described if FIG. 15A-15E and 24A-24E.
F. TELEMETRY
Information sent by the Toy control device, as an ACK to the command received from the Computer radio interface.
OK_ACK

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 0A | 00 | cmd1 | cmd2 | cmd3 | cmd4 | sen1 | sen2 | |

Send back an ACK about the command that was received ok.

| | | |
|---|---|---|
| P: | Computer address | 00-03 H |
| A: | unit address - | 00-FF H |
| cmd 1,2: | Received command MSB ok ack. | 00-FF H |
| cmd 3,4: | Received command LSB ok ack. | 00-FF H |
| sen 1,2 | Sensors 0-7 status | 00-FF H |

| | |
|---|---|
| 1. 01 60 00 05 0A 00 01 01 FF 00 | OK ack for 0101 command. (sensors scan mode |
| | on command). status: all sensors are not |
| | pressed (FF). |
| | the computer_radio_interface number is 6. |
| 2. 01 60 00 05 0A 00 01 01 FE 00 | OK ack for 0101 command. (sensors scan mode |
| | on command). status: sensor #8 is pressed (FE) |
| | the computer_radio_interface number is 6. |
| G. REQUESTS | |

Requests sent by the Toy control device, after an event.
TOY_IS_AWAKE_REQ

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 0A | 00 | c1 | c2 | x | x | x | x | |

Send a message to the Computer radio interface if the Toy control device goes from sleep mode to awake mode.

| | | |
|---|---|---|
| P: | Computer address | 00-03 H |
| A: | unit address - | 00-FF H |
| c1,c2: | status command | AB H |

| | |
|---|---|
| 1. 01 60 00 05 0A 00 AB 00 FF 00 | Toy is awake message. |

H. CRI (Computer Radio Interface) - commands
Commands that are sent only to the Computer radio interface.
SWITCH_AUDIO_OUT_TO_RADIO_&_TRANSMIT

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 00 | x | x | x | x | x | x | |

Requests the Computer radio interface to switch audio_out from the computer sound card to the radio wireless
transceiver and transmit.

| | | |
|---|---|---|
| P: | Computer address | 00-03 H |

SWITCH_AUDIO_OUT_TO_JACK_&_STOP_TRANSMIT

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 01 | x | x | x | x | x | x | |

Requests the Computer radio interface to switch audio_out from the radio RF wireless transceiver to the speakers jack
and to stop transmit.

| | | |
|---|---|---|
| P: | Computer address | 00-03 H |

MUTE_RADIO

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 02 | x | x | x | x | x | x | |

Mute the radio transmit.

| | | |
|---|---|---|
| P: | Computer address | 00-03 H |

UN-MUTE_RADIO

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | 00 | 00 | 00 | x | 0C | 03 | x | x | x | x | x | x | |

UN-Mute the radio transmit.
CRI_RESET

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 0F | x | x | x | x | x | x | |

Perform software reset on the Computer radio interface unit.

| | | |
|---|---|---|
| P: | Computer address | 00-03 H |

I. CRI - ACK
ACK sent only to the Computer by the Computer radio interface, only after CRI commands.
CRI_COMMAND_ACK

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0D | 00 | cmd1 | cmd2 | cmd3 | cmd4 | x | x | |

This is an ACK for a CRI command. this ACK is sent to the computer by the computer-radio-interface,
after executing a command successfully.

| | | |
|---|---|---|
| P: | Computer address | 00-03 H |
| cmd 1,2: | Received CRI command MSB ok ack. | 00-FF H |
| cmd 3,4: | Received CRI command LSB ok ack. | 00-FE H |

| | |
|---|---|
| 1. 01 60 00 00 0D 00 0C 01 00 00 | OK ack for 0C01 CRI command (SWITCH |
| | AUDIO OUT TO JACK) |
| | the computer_radio_interface number is 6. |
| 2. 01 60 00 00 0D 00 0C OF 00 00 | OK ack for 0C0F CRI command (CRI reset) |
| | the computer_radio_interface number is 6. |
| | This ack is also sent on POWER UP RESET |

Reference is now made to FIG. 8A, which is a simplified flowchart illustration of a preferred method for receiving radio signals, executing commands comprised therein, and sending radio signals, within the toy control device 130 of FIG. 1A. Typically, each message as described above comprises a command, which may include a command to process information also comprised in the message. The method of FIG. 8A preferably comprises the following steps:

A synchronization signal or preamble is detected (step 400). A header is detected (step 403).

A command contained in the signal is received (step 405).

The command contained in the signal is executed (step 410). Executing the command may be as described above with reference to FIG. 1A.

A signal comprising a command intended for the computer radio interface 110 is sent (step 420).

Reference is now made to FIGS. 8B-8T which, taken together, comprise a simplified flowchart illustration of a preferred implementation of the method of FIG. 8A. The method of FIGS. 8B-8T is self-explanatory.

Reference is now made to FIG. 9A, which is a simplified flowchart illustration of a preferred method for receiving MIDI signals, receiving radio signals, executing commands comprised therein, sending radio signals, and sending MIDI signals, within the computer radio interface 110 of FIG. 1A. Some of the steps of FIG. 9A are identical to steps of FIG. 8A, described above. FIG. 9A also preferably comprises the following steps:

A MIDI command is received from the computer 100 (step 430). The MIDI command may comprise a command intended to be transmitted to the toy control device 130, may comprise an audio in or audio out command, or may comprise a general command.

A MIDI command is sent to the computer 100 (step 440). The MIDI command may comprise a signal received from the toy control device 130, may comprise a response to a MIDI command previously received by the computer radio interface 110 from the computer 100, or may comprise a general command.

The command contained in the MIDI command or in the received signal is executed (step 450). Executing the command may comprise, in the case of a received signal, reporting the command to the computer 100, whereupon the computer 100 may typically carry out any appropriate action under program control as, for example, changing a screen display or taking any other appropriate action in response to the received command. In the case of a MIDI command received from the computer 100, executing the command may comprise transmitting the command to the toy control device 130. Executing a MIDI command may also comprise switching audio output of the computer control device 110 between the secondary audio interface 230 and the radio transceiver 260. Normally the secondary audio interface 230 is directly connected to the audio interface 220 preserving the connection between the computer sound board and the peripheral audio devices such as speakers, microphone and stereo system.

Reference is now made to FIGS. 9B-9N, and additionally reference is made back to FIGS. 8D-8M, all of which, taken together, comprise a simplified flowchart illustration of a preferred implementation of the method of FIG. 9A. The method of FIGS. 9B-9M, taken together with FIGS. 8D-8M, is self-explanatory.

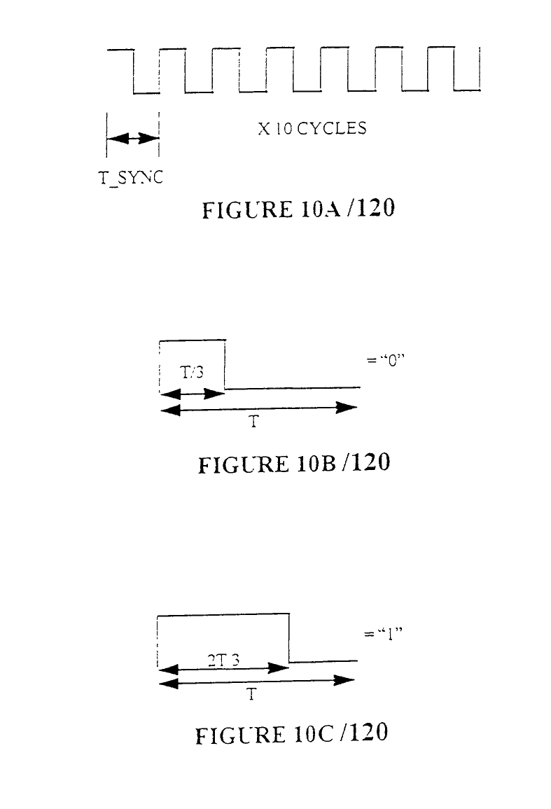

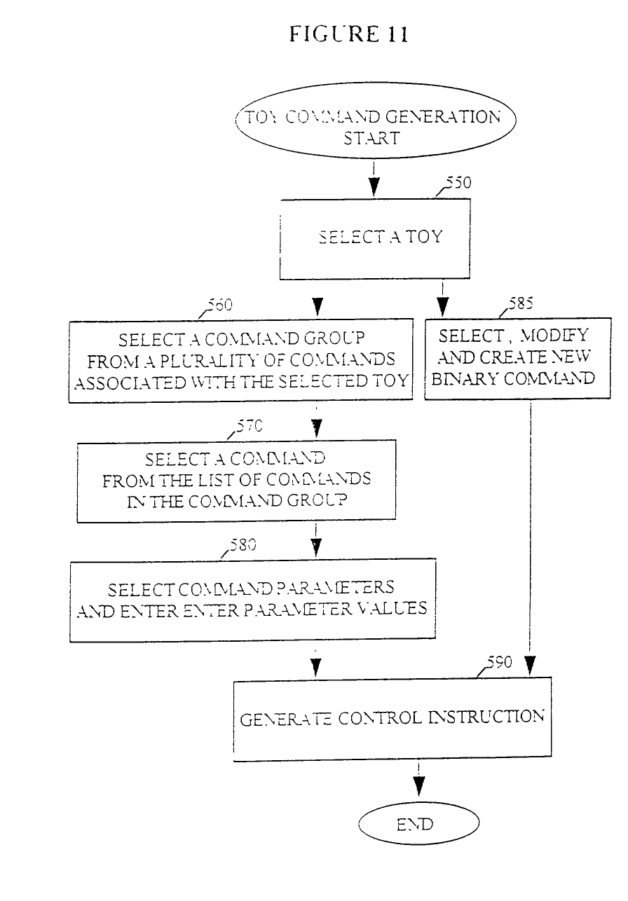

Reference is now additionally made to FIGS. 10A-10C, which are simplified pictorial illustrations of a signal transmitted between the computer radio interface 110 and the toy control device 130 of FIG. 1A. FIG. 10A comprises a synchronization preamble. The duration T_SYNC of the synchronization preamble is preferably 0.500 millisecond, being preferably substantially equally divided into on and off components.

FIG. 10B comprises a signal representing a bit with value 0, while FIG. 10C comprises a signal representing a bit with value 1.

It is appreciated that FIGS. 10B and 10C refer to the case where the apparatus of FIG. 5D is used. In the case of the apparatus of FIG. 5E, functionality corresponding to that depicted in FIGS. 10B and 10C is provided within the apparatus of FIG. 5E.

Preferably, each bit is assigned a predetermined duration T, which is the same for every bit. A frequency modulated carrier is transmitted, using the method of frequency modulation keying as is well known in the art. An “off” signal (typically less than 0.7 Volts) presented at termination 5 of U2 in FIG. 5D causes a transmission at a frequency below the median channel frequency. An “on” signal (typically over 2.3 Volts) presented at pin 5 of U2 in FIG. 5D causes a transmission at a frequency above the median frequency. These signals are received by the corresponding receiver U1. Output signal from pin 6 of U1 is fed to the comparator 280 of FIGS. 4 and 6 that is operative to determine whether the received signal is “off” or “on”, respectively.

It is also possible to use the comparator that is contained within U1 by connecting pin 7 of U1 of FIG. 5D, through pin 6 of the connector J1 of FIG. 5D, pin 6 of connector J1 of FIG. 5A, through the jumper to pin 12 of U1 of FIG. 5A.

Preferably, receipt of an on signal or spike of duration less than 0.01*T is ignored. Receipt of an on signal as shown in FIG. 10B, of duration between 0.01*T and 0.40*T is preferably taken to be a bit with value 0. Receipt of an on signal as shown in FIG. 10C, of duration greater than 0.40*T is preferably taken to be a bit with value 1. Typically, T has a value of 1.0 millisecond.

Furthermore, after receipt of an on signal, the duration of the subsequent off signal is measured. The sum of the durations of the on signal and the off signal must be between 0.90 T and 1.10 T for the bit to be considered valid. Otherwise, the bit is considered invalid and is ignored.

Reference is now made to FIG. 11, which is a simplified flowchart illustration of a method for generating control instructions for the apparatus of FIG. 1A. The method of FIG. 11 preferably includes the following steps:

A toy is selected (step 550). At least one command is selected, preferably from a plurality of commands associated with the selected toy (steps 560-580). Alternatively, a command may be entered by selecting, modifying, and creating a new binary command (step 585).

Typically, selecting a command in steps 560-580 may include choosing a command and specifying one or more control parameters associated with the command. A control parameter may include, for example, a condition depending on a result of a previous command, the previous command being associated either with the selected toy or with another toy. A control parameter may also include an execution condition governing execution of a command such as, for example: a condition stating that a specified output is to occur based on a status of the toy, that is, if and only if a specified input is received; a condition stating that the command is to be performed at a specified time; a condition stating that performance of the command is to cease at a specified time; a condition comprising a command modifier modifying execution of the command, such as, for example, to terminate execution of the command in a case where execution of the command continues over a period of time; a condition dependent on the occurrence of a future event; or another condition.

The command may comprise a command to cancel a previous command.

The output of the method of FIG. 11 typically comprises one or more control instructions implementing the specified command, generated in step 590. Typically, the one or more control instructions are comprised in a command file. Typically, the command file is called from a driver program which typically determines which command is to be executed at a given point in time and then calls the command file associated with the given command.

Preferably, a user of the method of FIG. 11 performs steps 550 and 560 using a computer having a graphical user interface. Reference is now made to FIGS. 12A-12C, which are pictorial illustrations of a preferred embodiment of a graphical user interface implementation of the method of FIG. 11.

FIG. 12A comprises a toy selection area 600, comprising a plurality of toy selection icons 610, each depicting a toy. The user of the graphical user interface of FIGS. 12A-12C typically selects one of the toy selection icons 610, indicating that a command is to be specified for the selected toy.

FIG. 12A also typically comprises action buttons 620, typically comprising one or more of the following:

a button allowing the user, typically an expert user, to enter a direct binary command implementing an advanced or particularly complex command not otherwise available through the graphical user interface of FIGS. 12A-12C;

a button allowing the user to install a new toy, thus adding a new toy selection icon 610; and

a button allowing the user to exit the graphical user interface of FIGS. 12A-12C.

FIG. 12B depicts a command generator screen typically displayed after the user has selected one of the toy selection icons 610 of FIG. 12A. FIG. 12B comprises an animation area 630, preferably comprising a depiction of the selected toy selection icon 610, and a text area 635 comprising text describing the selected toy.

FIG. 12B also comprises a plurality of command category buttons 640, each of which allow the user to select a category of commands such as, for example: output commands; input commands; audio in commands; audio out commands; and general commands.

FIG. 12B also comprises a cancel button 645 to cancel command selection and return to the screen of FIG. 12A.

FIG. 12C comprises a command selection area 650, allowing the user to specify a specific command. A wide variety of commands may be specified, and the commands shown in FIG. 12C are shown by way of example only.

FIG. 12C also comprises a file name area 655, in which the user may specify the name of the file which is to receive the generated control instructions. FIG. 12C also comprises a cancel button 645, similar to the cancel button 645 of FIG. 12B. FIG. 12C also comprises a make button 660. When the user actuates the make button 660, the control instruction generator of FIG. 11 generates control instructions implementing the chosen command for the chosen toy, and writes the control instructions to the specified file.

FIG. 12C also comprises a parameter selection area 665, in which the user may specify a parameter associated with the chosen command.

Reference is now made to Appendix A, which is a computer listing of a preferred software implementation of the method of FIGS. 8A-8T.

Appendix A is an INTEL hex format file. The data bytes start from character number 9 in each line. Each byte is represented by 2 characters. The last byte (2 characters) in each line, should be ignored.

For example, for a sample line:

| | |
|---|---|
| The original line reads: | 07000000020100020320329F |
| The data bytes: | 02010002032032 (02,01,00,02,03,20,32) |
| Starting address of the data | 0000 (00,00) |
| bytes: | |

Appendix A may be programmed into the memory of microcontroller 250 of FIG. 6.

Appendix B is a computer listing of a preferred software implementation of the method of FIGS. 9A-9N, together with the method of FIGS. 8D-8M.

Appendix B is an INTEL hex format file. The data bytes start from character number 9 in each line. Each byte is represented by 2 characters. The last byte (2 characters) in each line, should be ignored.

For example, for a sample line:

| | |
|---|---|
| The original line reads: | 070000000201000205A73216 |
| The data bytes: | 0201000205A732 (02,01,00,02,05,A7,32) |
| Starting address of the data | 0000 (00,00) |
| bytes: | |

Appendix B may be programmed into the memory of microcontroller 250 of FIG. 4.

Appendix C is a computer listing of a preferred software implementation of an example of a computer game for use in the computer 100 of FIG. 1.

Appendix D is a computer listing of a preferred software implementation of the method of FIGS. 11 and FIGS. 12A-12C.

For Appendices C and D, these programs were developed using VISUAL BASIC. To run the programs you need to install the VISUAL BASIC environment first. The application needs a Visual Basic custom control for performing MIDI I/O similar to the one called MIDIVBX. VBX. VISUAL BASIC is manufactured by Microsoft Corporation, One Microsoft Way, Redmond, Wash. 98052-6399, USA. MIDIVBX.VBX is available from Wayne Radinsky, electronic mail address a-wayner@microsoft.com.

The steps for programming the microcontrollers of the present invention include the use of a universal programmer, such as the Universal Programmer, type EXPRO 60/80, manufactured by Sunshine Electronics Co. Ltd., Taipei, Japan.

The method for programming the microcontrollers with the data of Appendices A and B, includes the following steps:

1. Run the program EXPRO.EXE, which is provided with the EXPRO 60/80″.

2. Choose from the main menu the EDIT/VIEW option.

3. Choose the EDIT BUFFER option.

4. Enter the string E 0000.

5. Enter the relevant data (given in Appendices A or B), byte after byte, starting from the address 0000. In each line there is a new starting address for each data byte which appears in this line.

6. Press ESC.

7. Enter the letter Q.

8. Choose from the main menu the DEVICE option.

9. Choose the MPU/MCU option.

10. Choose the INTEL option.

11. Choose the 87C51.

12. Choose from the main menu the RUNFUNC option.

13. Choose the PROGRAM option. 14. Place the 87C51 chip in the programmer's socket.

15. Enter Y and wait until the OK message.

16. The chip is now ready to be installed in the board.

The method for creating the relevant files for the computer 100, with the data of Appendices C and D, includes using a HEX EDITOR which is able to edit DOS formatted files. A typical HEX and ASCII editor is manufactured by Martin Doppelbauer, Am Spoerkel 17, 44227 Dortmund, Germany, UET401 at electronic mail address hrz.unidozr.uni-dortmund.de.

The steps necessary for creating the files by means of a HEX editor, such as by the Martin Doppelbauer editor include the following:

1. Copy any DOS file to a new file with the desired name and with the extension .EXE. (For example, write COPY AUTOEXEC.BAT TOY1.EXE).

2. Run the program ME.EXE.

3. From the main menu press the letter L (load file).

4. Write the main menu of the new file (for example TOY1.EXE).

5. From the main menu, press the letter (insert).

6. Enter the relevant data (written in Appendices C or D), byte after byte, starting from the address 0000.

7. Press ESC.

8. From the main menu, enter the letter W(write file).

9. Press the RETURN key and exit from the editor by pressing the letter Q.

The above-described embodiment of FIG. 1C includes a description of a preferred set of predefined messages including a category termed “General commands”. Other General Commands are defined by the following description:

MULTIPORT COMMANDS
AVAILABILITY_INTERROGATION_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 05 | 00 | 00 | 00 | 00 | x | x | |

A computer transmits this command to verify that the radio channel is vacant. If another computer is already using
this channel it will respond with the Availability Response Command. If no response is received within 250
msec the channel is deemed vacant.

| | | |
|---|---|---|
| P: | Computer address | 00-03 H |
| A: | unit address - | 00-FF H |

AVAILABILITY_RESPONSE_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 06 | 00 | 00 | 00 | 00 | x | x | |

A computer transmits this command in response to an Availability Interrogation Command to announce that the radio
channel is in use.

| | | |
|---|---|---|
| P: | Computer address | 00-03 H |
| A: | unit address - | 00-FF H |

TOY_AVAILABILITY_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 07 | 00 | 00 | 00 | 00 | x | x | |

A Toy transmits this command to declare its existence and receive in response a Channel Pair Selection Command
designating the computer that will control it and the radio channels to use.

| | | |
|---|---|---|
| P: | Computer address | 00-03 H |
| A: | unit address - | 00-FF H |

CHANNEL_PAIR_SELECTION_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | 8 bits | | 8 bits | | 8 bits | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 08 | CH1 | CH2 | 00 | 00 | x | x | |

A computer transmits this command in response to a Toy Availability Command to inform the toy the radio channels
to be used.

| | | |
|---|---|---|
| P: | Computer address | 00-03 H |
| A: | unit address - | 00-FF H |
| CH1: | Toy transmit channel | 0-F H |
| CH1: | Toy receive channel | 0-F H |

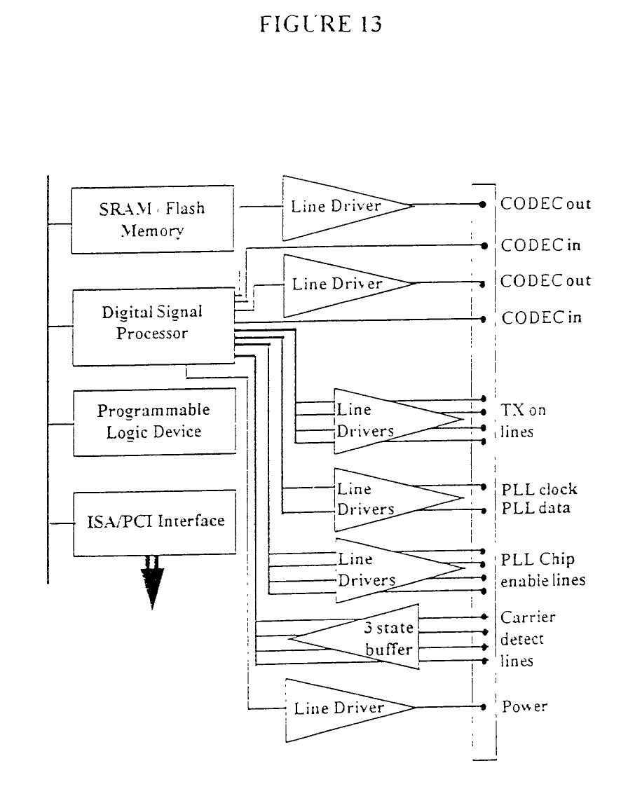

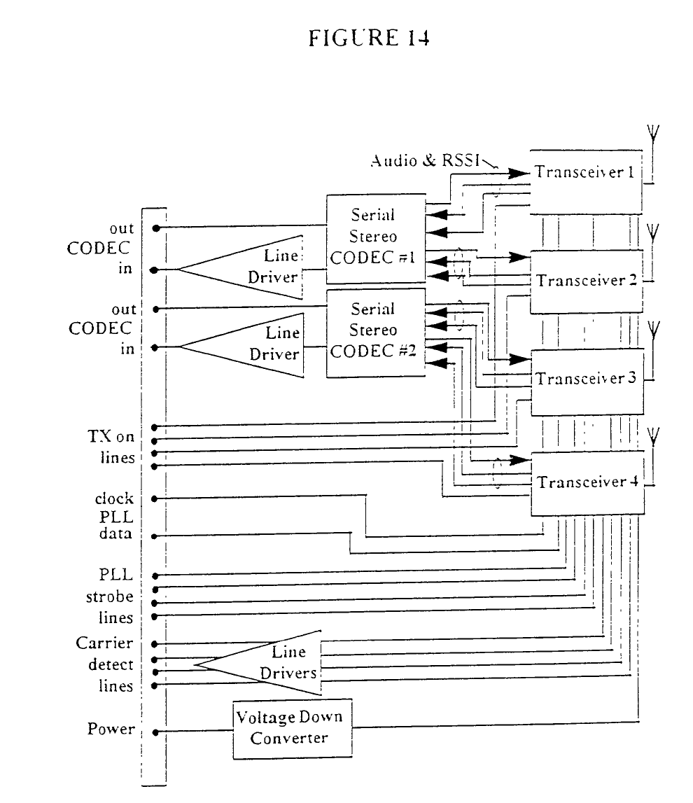

In FIGS. 13 and 14 there are illustrated block diagrams of multiport multi-channel implementation of the computer radio interface 110 of FIG. 1A. FIG. 13 illustrates the processing subunit of the computer interface that is implemented as an add-in board installed inside a PC. FIG. 14 is the RF transceiver which is a device external to the computer and connects to the processing subunit by means of a cable. In the present application of the RF unit there are 4 transceivers each capable of utilizing two radio channels simultaneously.

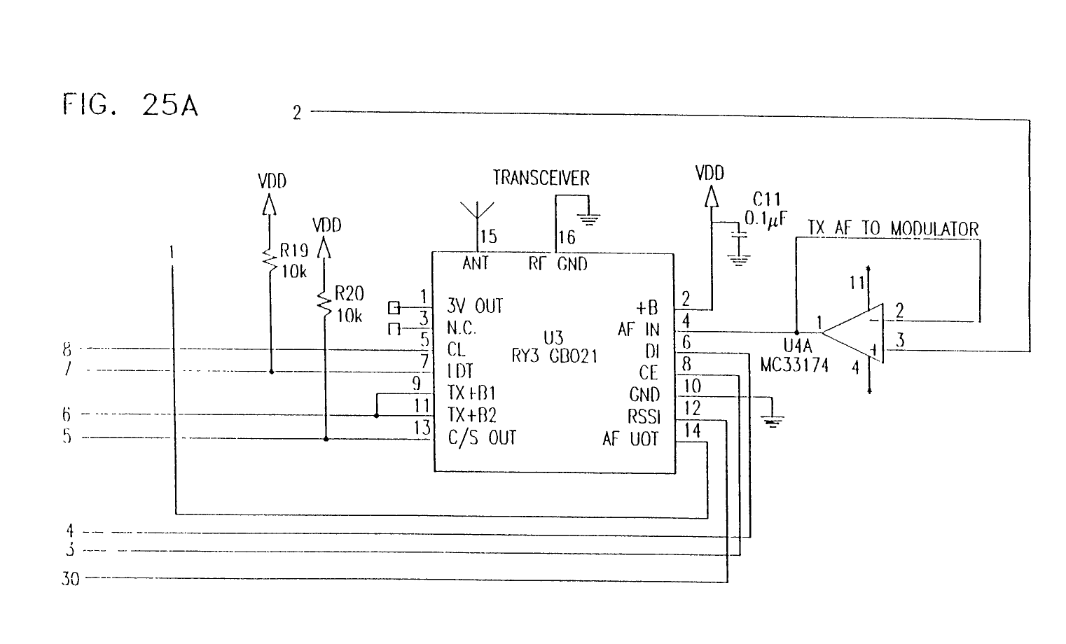

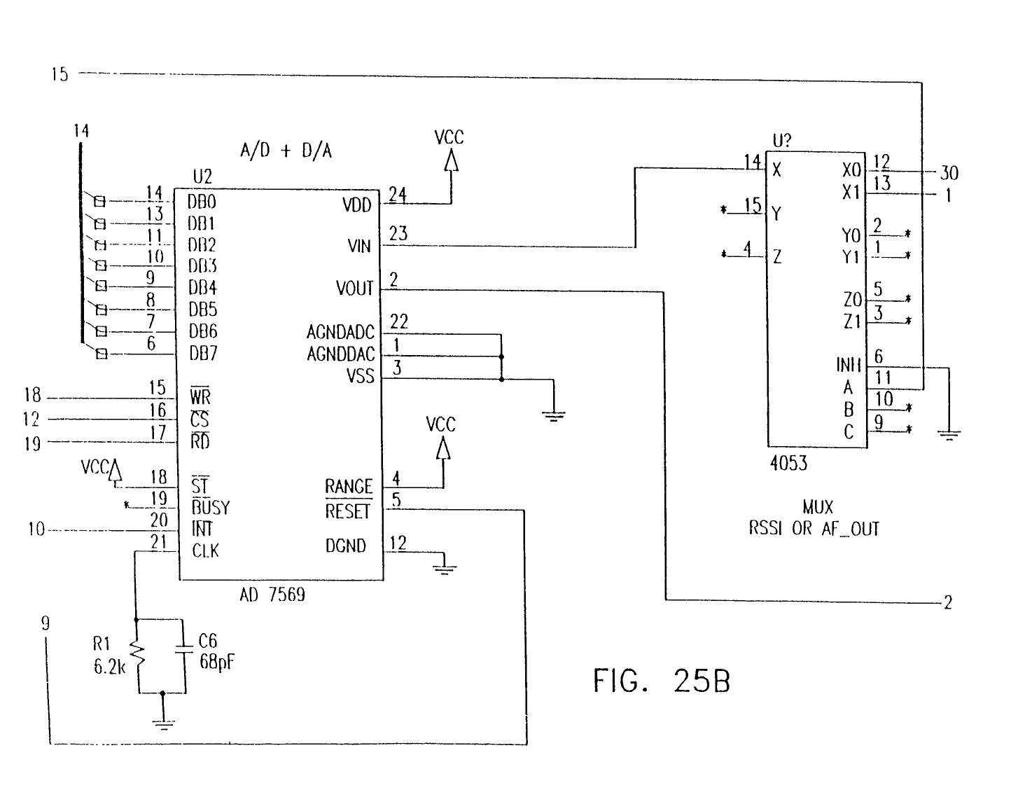

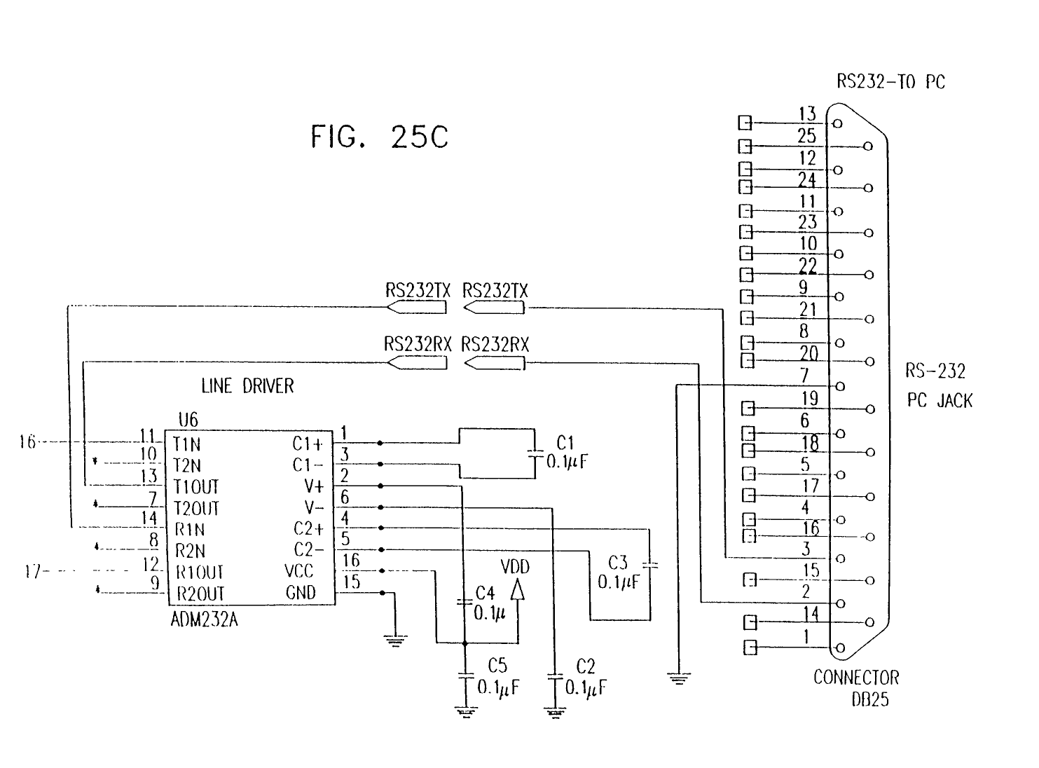

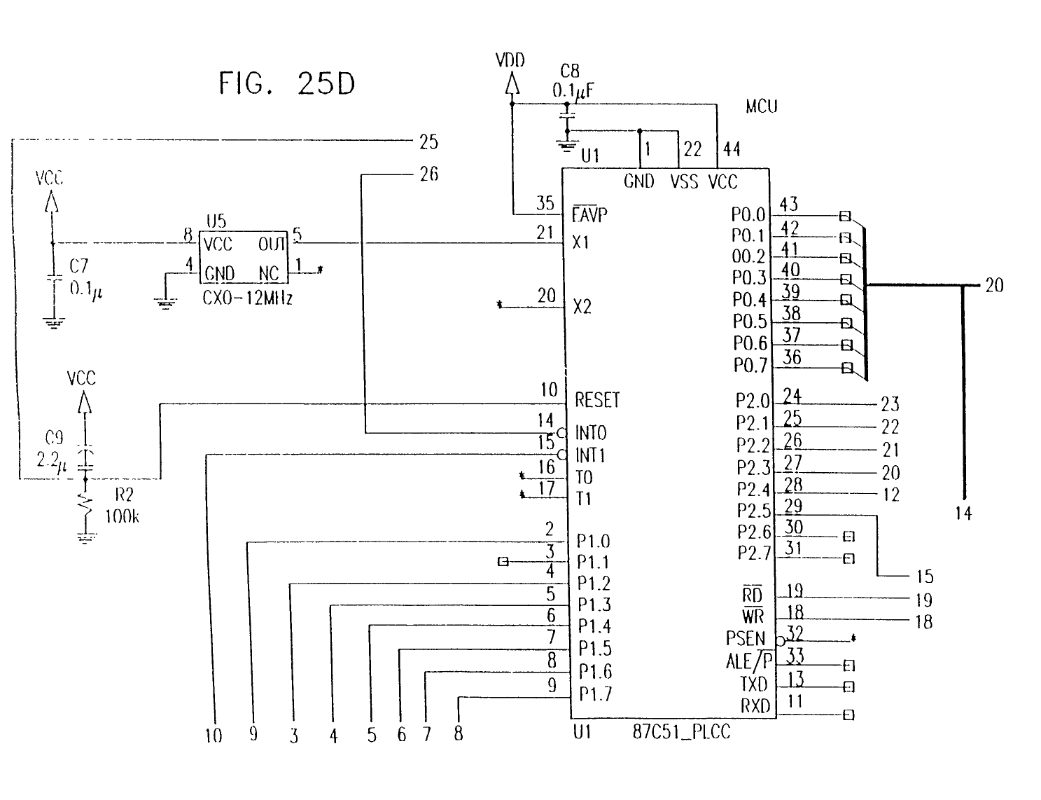

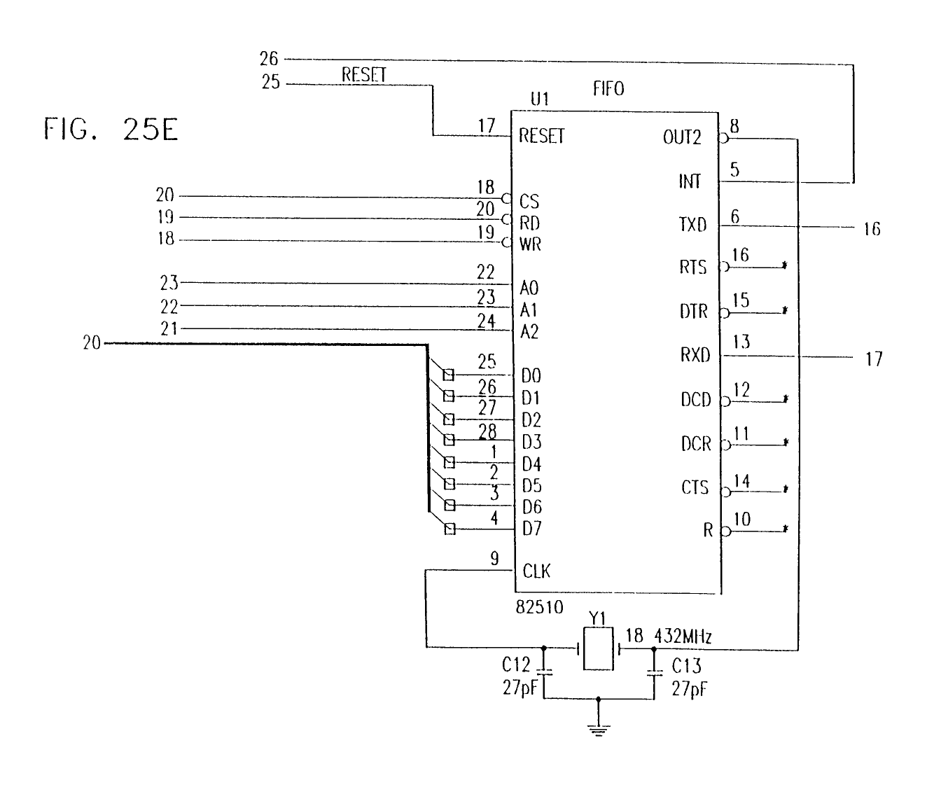

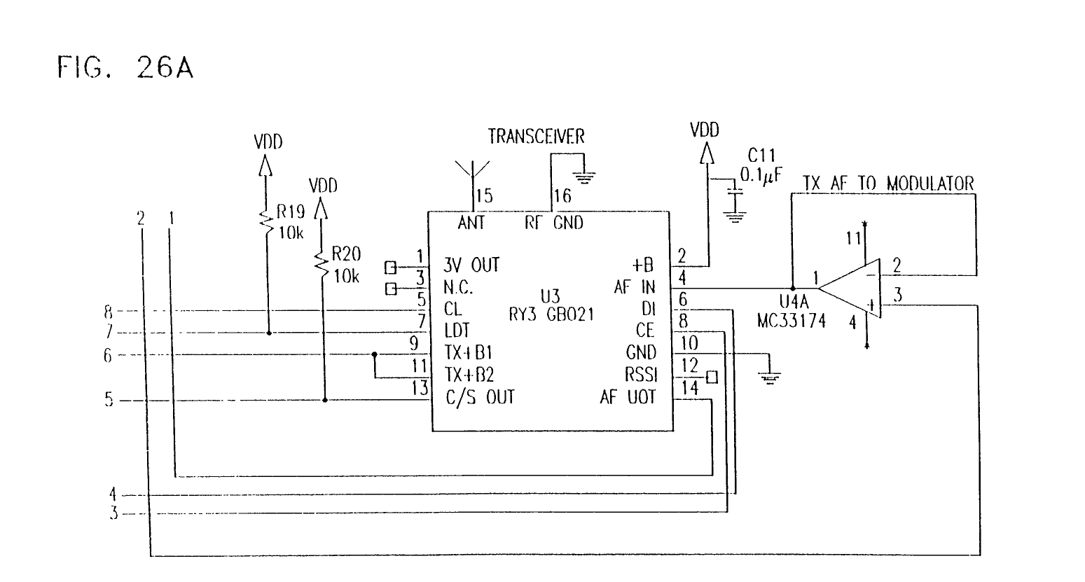

Referring briefly to FIG. 3, it is appreciated that, optionally, both sound and control commands may be transmitted via the MIDI connector 210 rather than transmitting sound commands via the analog connector 220. It is additionally appreciated that the functions of the interfaces 210 and 220 between the computer radio interface 110 and the sound card 190 may, alternatively, be implemented as connections between the computer radio interface 110 to the serial and/or parallel ports of the computer 100, as shown in FIGS. 25A-25F.

If it is desired to provide full duplex communication, each transceiver 260 which forms part of the computer radio interface 110 of FIG. 1A preferably is operative to transmit on a first channel pair and to receive on a different, second channel pair. The transceiver 260 (FIG. 4) which forms part of the toy control device 130 of FIG. 1A preferably is operative to transmit on the second channel and to receive on the first channel.

Any suitable technology may be employed to define at least two channel pairs such as narrow band technology or spread spectrum technologies such as frequency hopping technology or direct sequence technology, as illustrated in FIGS. 15A-15E, showing a Multi-Channel Computer Radio Interface, and in FIGS. 24A-24E showing a Multi-Channel Toy Control Device.

Appendices E-H, taken together, are computer listings from which a first, DLL-compatible, functions library may be constructed. The DLL-compatible functions library may be subsequently used by a suitable computer system such as an IBM PC to generate a variety of games for any of the computer control systems shown and described herein. Alternatively, games may be generated using the applications generator of FIGS. 11-12C.

To generate a DLL (dynamic loading and linking) function library based on Appendices E-H, the following operations are performed:

1) Open Visual C++4.0

2) Go to File Menu

3) Choose New from File Menu

4) Choose Project Workspace

5) Choose Dynamic-Link Library

6) The Project Name is: DLL32.MDP

7) Press Create button

8) Go to File Menu

9) Choose New from File Menu

10) Choose Text File

11) Now write the Source

12) Write on the current page a file containing the contents of Appendix E

13) Press the mouse right button and choose: Insert File Into Project

14) Click on DLL32 project

15) On the save dialog write CREATOR.C

16) Press the OK button

17) Go to File Menu

18) Choose New from File Menu

19) Choose Text File

20) Write on this page a file containing the contents of Appendix F; 21) Go to File Menu

22) Press Save

23) On the save dialog write CRMIDI.H

24) Press the OK button

25) Go to File Menu

26) Choose New from File Menu

27) Choose Text File

28) Write on this page a file containing the contents of Appendix G;

29) Go to File Menu

30) Press Save

31) On the save dialog write a file CREATOR.H

32) Press the OK button

33) Go to File Menu

34) Choose New from File Menu

35) Choose Text File

36) Write on this page a file containing the contents of Appendix H;

37) Press the mouse right button and choose: Insert File Into Project

38) Click on DLL32 project

39) On the save dialog write CREATOR.DEF

40) Press the OK button

41) Go to Insert Menu

42) Press File Into Project . . .

43) On the List Files of Type: Choose Library Files (*.lib)

44) Go to the Visual C++ library directory and choose WINMM.LIB

45) Press the OK button

46) Go to the Build menu

47) Press Rebuild ALL

A description of the commands included in the DLL function library based on Appendices E-H now follows:

A. MIDI input functions 1-2:

1. Open MIDI input device

Syntax: long MIDIInOpen(long Device)

This function opens the MDI device for input.

Return 0 for success,−1 otherwise.

Delphi Example:

Device:=0;

if MIDIInOpen(Device) <>0 Then

MessageDlg(‘Error opening MIDI input device’, mtError, mbOk, 0);

2. Reset MIDI input device

Syntax: long MIDInReset(void)

this function resets MIDI input device.

Return 0 for success,−1 otherwise.

Delphi Example:

if MIDIInRest <>0 Then

MessageDlg(‘Error resetting MIDI input device’, mtError, mbOk, 0);

B. MIDI output functions 3-6:

3. Close MIDI input device

Syntax: long MIDIInClose(void)

This function close MIDI input device.

Return 0 for success,−1 otherwise.

Delphi Example:

if MIDIInClose <>0 Then

MessageDlg(‘Error closing MIDI input device’, mtError, mbOk, 0);

4. Open MIDI output device

Syntax: long MIDIOutOpen(long Device)

This function opens MIDI output device.

Return 0 if success,−1 otherwise.

Delphi Example:

Device:=0;

if MIDIOutOpen(Device) <>0 Then

MessageDlg(‘Error opening MIDI output device’, mtError, mbOk, 0);

5. Reset MIDI Output device

Syntax: long MIDIOutReset(void)

This function resets MIDI output device.

Return 0 if success,−1 otherwise.

Delphi Example:

if MIDIOutReset <>0 Then

MessageDlg(‘Error resetting MIDI output device’, mtError, mbOk, 0);

6. Close MIDI output device

Syntax: long MIDIOutClose(void)

This function close MIDI output device.

Return 0 if success,−1 otherwise.

Delphi Example:

Device:=0;

if MIDIOutClose <>0 Then

MessageDlg(‘Error opening MIDI output device’, mtError, mbOk, 0);

C. General functions 7-10:

7. Send Data

Syntax: long SendData(long Data)

This function sends 4 bytes to toy card.

Currently used to send 144 for init toy card.

Return 0 if successful, −1 otherwise.

Delphi Example:

If SendData(144) <>0 Then

MessageDlg(‘Error sending data to toy’, mtError, mbOk, 0);

8. Send Message

Syntax: long SendMessage(char *Mess)

This function sends string to toy card.

Return 1 if successful, or errorcode otherwise.

Delphi Example:

Mess:=‘00 01 00 00 00 00 00 05 00 00 00 01 00 03 00 01 00 00 00’;

If SendMessage(Mess) <>1 Then

MessageDlg(‘Error opening MIDI output device’, mtError, mbOk, 0);

9. Check message

Syntax: long CheckMessage(void)

This function returns 0 if no message found from toy card.

Delphi Example:

If CheckMessage Then

Mess:=GetMessage;

10. Get Message

Syntax: char * GetMessage(char *Mess)

This function returns 20 chars toy message if present, or “Time Out” otherwise.

Delphi Example:

If GetMessage=“Time Out” Then

MessageDlg(‘No message received’, mtError, mbOk, 0);

D. Toy control functions 11-16:

11. Get Toy Number

Syntax: char * GetToyNumber(void)

This function returns Toy Number of last receiving message, or “00 00 00 00” if no message was received.

12. Get Sensor Number

Syntax: long GetSensorNumber(void)

This function returns Sensor Number of last receiving message, or 255 if no message was received.

13. Toy Reset

Syntax: long ToyReset(char *ToyNumber)

This function sends a reset string to toy.

Return 0 if successful, or −1 otherwise.

14. Toy Transceive

Syntax: char *ToyTranceive(char *ToyNumber,char *Mess)

This function sends message to toy and waits 3 sec to acknowledge.

Return “Ack. Ok” if received, or “Time Out” if not.

15. Prepare Toy Talk

Syntax: char *PrepareToyTalk(char *ToyNumber, char *WaveFile)

This function prepares toy card to generate sound using toy speaker.

After calling this function, WaveFile may be played and heard at toy speaker.

Return “Ack. Ok” if successful, or “Time Out” otherwise.

16. Go To Sleep Mode

Syntax: char *GoSleep(char *ToyNumber)

This function sends to toy the sleep command.

Return “Ack. Ok” if successful, or “Time Out” otherwise.

Appendices I-O, taken together, are computer listings of a second functions library which may be used to generate a variety of games for any of the computer control systems shown and described herein in conjunction with a Director 5.0 software package, marketed by Macromedia Inc., 600 Townsend St., San Francisco, Calif., 94103.

To generate an XObject function library based on Appendices I-O, the following operations are performed:

1) Create a new directory: C:\XOBJECT\ by writing (MD C:\XOBJECT\)

2) Open Visual C++ 1.5

3) On the File menu choose NEW

4) Generate a file which contains the contents of Appendix I;

5) Choose Save As from the File Menu

6) Give the file generated in step (4) a name by punching C:\XOBJECT\CREATOR.MAK

7) Press the OK button

8) On the File menu choose NEW

9) Generate a file which contains the contents of Appendix J;

10) On the File menu choose Save As.

11) In the File Name: dialog, write C:\XOBJECT\CREATOR.C

12) Press the OK button

13) On the File menu choose NEW

14) Generate a file which contains the contents of Appendix K;

15) On the File menu choose Save As.

16) In the File Name: dialog write C:\XOBJECT\CREATOR.H

17) Press the OK button

18) On the File menu choose NEW

19) Generate a file which contains the contents of Appendix L;

20) On the File menu choose Save As.

21) In the File Name: dialog write C:\XOBJECT\CRMIDI.H

22) Press the OK button

23) On the File menu choose NEW

24) Generate a file which contains the

contents of Appendix M;

25) On the File menu choose Save As.

26) In the File Name: dialog write C:\XOBJECT\XOBJECT.H

27) Press the OK button

28) On the File menu choose NEW

29) Generate a file which contains the contents of Appendix N;

30) On the File menu choose Save As.

31) In the File Name: dialog write C:\XOBJECT\CR\BATOR.DEF

32) Press the OK button

33) On the File menu choose NEW

34) Generate a file which contains the contents of Appendix O;

35) On the File menu choose Save As.

36) In the File Name: dialog write C:\XOBJECT\CREATOR.RC

37) Press the OK button

38) On the Project Menu choose Open

39) In the File Name dialog write C:\\AOBJECT\CREATOR.MAK

40) Press Rebuild All from the Project Menu

A description of the commands included in the XObject function library based on Appendices I-O now follows:

A. MIDI input functions 1-3:

1. Open MIDI input device

Syntax: long MIDIInOpen(long Device)

This function opens the MIDI device for input.

Return 0 for success, −1 otherwise.

Delphi Example:

Device:=0;

if MIDIInOpen(Device) <>0 Then

MessageDlg(‘Error opening MIDI input device’, mtError, mbOk, 0);

2. Reset MIDI input device

Syntax: long MIDInReset(void)

This function resets MIDI input device.

Return 0 for success, −1 otherwise.

Delphi Example:

if MIDIInRest <>0 Then

MessageDlg(‘Error resetting MIDI input device’, mtError, mbOk, 0);

3. Close MIDI input device

Syntax: long MIDIInClose(void)

This function turns off MIDI input device.

Return 0 for success, −1 otherwise.

Delphi Example:

if MIDIInClose <>0 Then

MessageDlg(‘Error closing MIDI input device’, mtError, mbOk, 0);

B. MIDI output functions 4-6:

4. Open MIDI output device

Syntax: long MIDIOutOpen(long Device)

This function opens MIDI output device.

Return 0 if success,−1 otherwise.

Delphi Example:

Device:=0;

if MIDIOutOpen(Device) <>0 Then

MessageDlg(‘Error opening MIDI output device’, mtError, mbOk, 0);

5. Reset MIDI Output device

Syntax: long MIDIOutReset(void)

This function resets MIDI output device.

Return 0 if success, −1 otherwise.

Delphi Example:

if MIDIOutReset <>0 Then

MessageDlg(‘Error resetting MIDI output device’, mtError, mbOk, 0);

6. Close MIDI output device

Syntax: long MIDIOutClose(void)

This function close MIDI output device.

Return 0 if success, −1 otherwise.

Delphi Example:

Device:=0;

if MIDIOutClose <>0 Then

MessageDlg(‘Error opening MIDI output device’, mtError, mbOk, 0);

C. General functions 7-1:

7. New

Syntax: Creator(mNew)

This function creates a new instance of the XObject

The result is 1 if successful, or error code otherwise.

Example:

openxlib “Creator.Dll”

Creator(mNew)

. . .

Creator(mDispose)

See also: Dispose

8. Dispose

Syntax: Creator(mNew)

This function disposes of XObject instance.

The result is 1 if successful, or error code otherwise.

Example:

openxlib “Creator.Dll”

Creator(mNew)

. . .

Creator(mDispose)

See also: New

9. Send Message

Syntax: long SendMessage(char *Mess)

This function sends string to toy card.

Return 1 if successful, or error code otherwise.

Delphi Example:

Mess:=‘00 01 00 00 00 00 00 05 00 00 00 01 00 03 00 01 00 00 00’;

If SendMessage(Mess) <>1 Then

MessageDlg(‘Error opening MIDI output device’, mtError, mbOk, 0);

10. Check message

Syntax: long CheckMessage(void)

This function returns 0 if no message found from toy card.

Delphi Example:

If CheckMessage Then

Mess:=GetMessage;

11. Get Toy Message

Syntax: GetToyMessage

This function receives message from toy.

The result is a message.

If during 3 sec there is no message, the result is “Time Out”.

Example:

set message=GetToyMessage

If message=“Time Out” Then

put “No message receiving”

End If

See also: Check for Message

D. Toy control functions 12-17:

12. Get Toy Number

Syntax: char * GetToyNumber(void)

This function returns Toy Number of last receiving message, or “00 00 00 00” if no message was received.

13. Get Sensor Number

Syntax: long GetSensorNumber(void)

This function returns Sensor Number of last receiving message, or 255 if no message was received.

14. Toy Reset

Syntax: long ToyReset(char *ToyNumber)

This function sends a reset string to toy.

Return 0 if successful, or −1 otherwise.

15. Toy Tranceive

Syntax: char *ToyTranceive(char *ToyNumber,char *Mess)

This function sends to toy message and waits 3 sec to acknowledge.

Return “Ack. Ok” if received, or “Time Out” if not.

16. Prepare Toy Talk

Syntax: char *PrepareToyTalk(char *ToyNumber, char *WaveFile)

This function prepares toy card to generate sound using from toy speaker.

After calling this function, WaveFile may be played and heard at toy speaker.

Return “Ack. Ok” if successful, or “Time Out” otherwise.

17. Go To Sleep Mode

Syntax: char *GoSleep(char *ToyNumber)

This function sends to toy the sleep command.

Return “Ack. Ok” if successful, or “Time Out” otherwise.

To use the XObject function library in conjunction with the Director, the following method may be employed:

1) Open Director Version 5.0 program

2) From File Menu, choose New

3) Press the Movie Option

4) Go to Windows menu and press Cast

5) Go to the first Script on the cast

6) On the Window menu choose Script

7) Write the script of the desired game.

8) Repeat from step 5 until all desired script(s) have been written. Press (Ctrl+Alt+P) to run the Application.

Appendices P-W, taken together, are computer listings of another preferred software implementation, alternative to the implementation of Appendices A-O.

To construct and operate the implementation of Appendices P-W, the following operations are performed:

1) Provide a computer capable of running the WINDOWS 95 operating system;

2) Prepare computer files for each of the files contained in Appendix P and place the computer files in a directory named “ocx”;

3) Prepare a computer file for the file contained in Appendix Q, extract the compressed contents of the file using Winzip version 6.2 available from Nico Mak Computing, Inc. of Bristol, Conn. 06011 USA, and place the extracted computer files in the directory named “ocx”;

4) Prepare computer files for each of the files contained in Appendix R and place the computer files in a directory named “player”;

5) Prepare a computer file for the file contained in Appendix S, extract the compressed contents of the file using Winzip version 6.2, and place the extracted computer files in a subdirectory named “res” contained in the directory named “player”;

6) Prepare computer files for each of the files contained in Appendices T and U and place the computer files in a directory named “xmidi5”;

7) Prepare a computer file for the file contained in Appendix V, extract the compressed contents of the file using Winzip version 6.2, and place the extracted computer files in the directory named “xmidi5”;

8) Prepare a computer file named NEWDEMO.CS the file contained in Appendix W and place the files in the directory named “player”;

9) Install the Microsoft Development Studio Version 5.0 available from Microsoft Corporation, One Microsoft Way, Redmond, Wash. USA;

10) Run the Microsoft Development Studio, select FILE/OPEN WORKSPACE from the menu, select the file \OCX\NEWSR.DSW, select BUILD from the menu, select BUILD NEWDEMO.OCX, select FILE/OPEN WORKSPACE from the menu, select the file \PLAYER\PLAYER.DSW, select BUILD from the menu, select BUILD PLAYER.EXE;

11) Compile \XMID\15\XMIDI.DSW using Visual C++ Version 5.0 and run the OCX registration program REGSVR32.EXE with XMIDI5.OCX on the command line;

12) Install the “American English Text To Speech Software Development Kit” for WINDOWS 95/WINDOWS NT from Lernout & Hauspie Speech Products, Sint-Krispisnstraat 7, 8900 Leper, Belgium;

13) Run PLAYER.EXE in DOS mode from the \PLAYER directory by invoking “player newdemo.cs”.

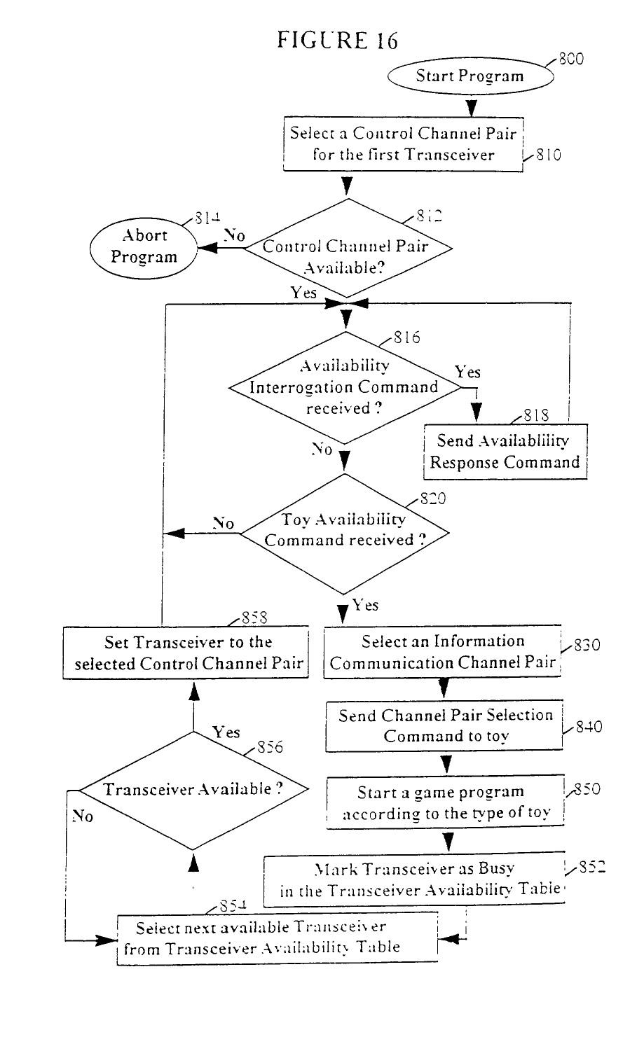

Reference is now made to FIG. 16 which is a simplified flowchart illustration of a preferred method of operation of a computer radio interface (CRI) 110 operative to service an individual computer 100 of FIG. 1A without interfering with other computers or being interfered with by the other computers, each of which is similarly serviced by a similar CRI. Typically, the method of FIG. 16 is implemented in software on the computer 100 of FIG. 1A.

The CRI includes a conventional radio transceiver (260 of FIG. 4) which may, for example, comprise an RY3 GB021 having 40 channels which are divided into 20 pairs of channels. Typically, 16 of the channel pairs are assigned to information communication and the remaining 4 channel pairs are designated as control channels.

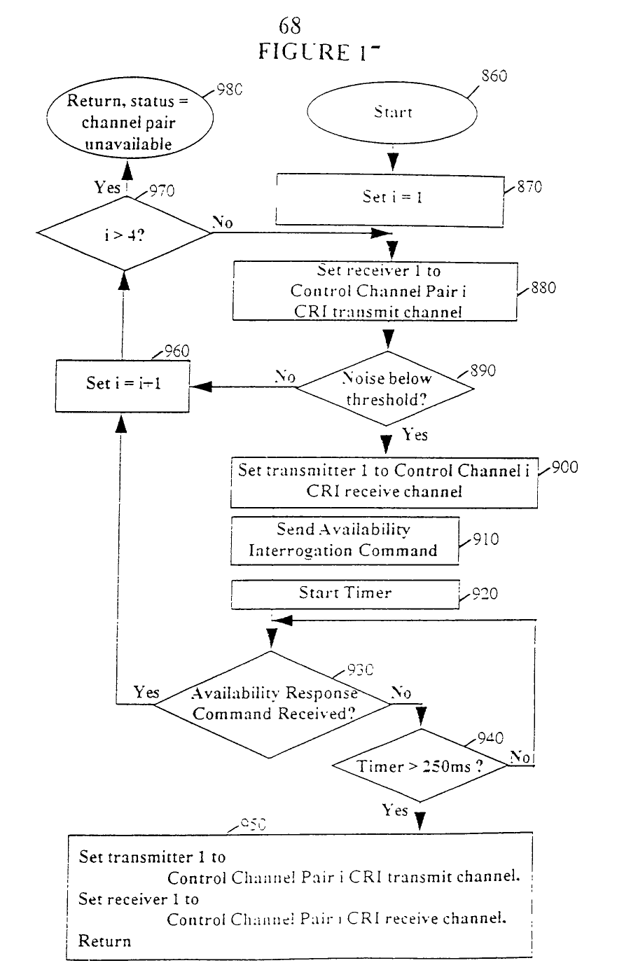

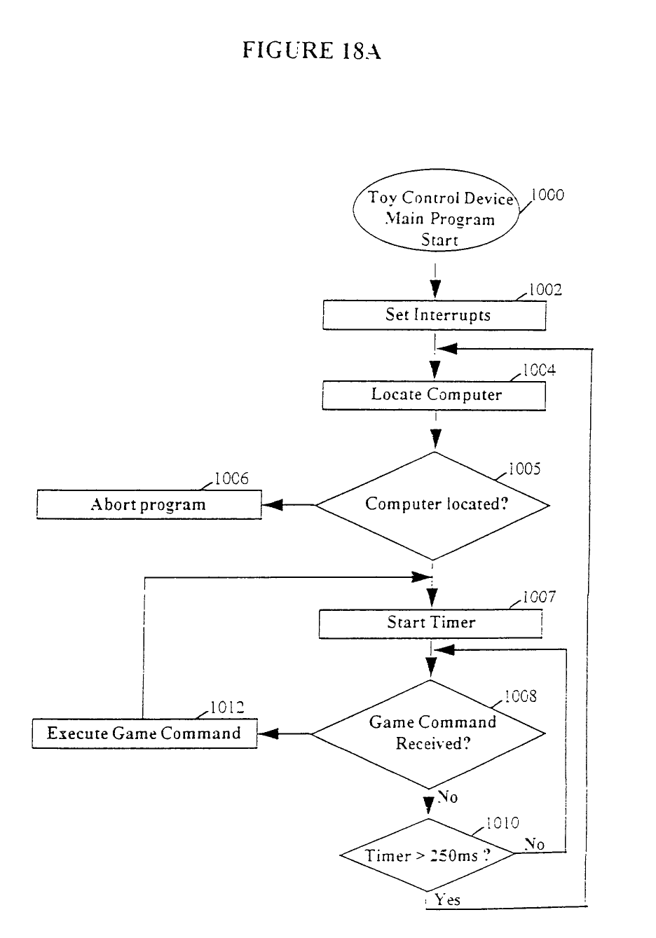

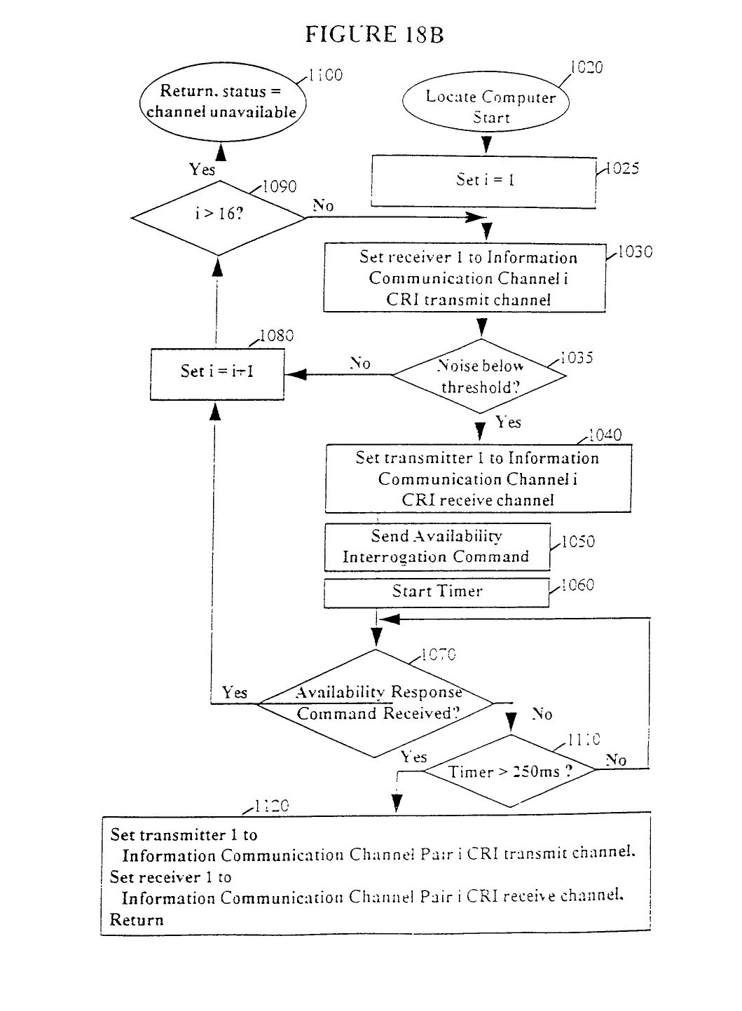

In the method of FIG. 16, one of the 4 control channel pairs is selected by the radio interface (step 810) as described in detail below in FIG. 17. The selected control channel pair i is monitored by a first transceiver (step 820) to detect the appearance of a new toy which is signaled by arrival of a toy availability command from the new toy (step 816). When the new toy is detected, an information communication channel pair is selected (step 830) from among the 16 such channel pairs provided over which game program information will be transmitted to the new toy. A preferred method for implementing step 830 is illustrated in self-explanatory flowchart FIG. 18A. The “Locate Computer” command in FIG. 18A (step 1004) is illustrated in the flowchart of FIG. 18B.

The identity of the selected information communication channel pair, also termed herein a “channel pair selection command”, is sent over the control channel pair to the new toy (step 840). A game program is then begun (step 850), using the selected information communication channel pair. The control channel pair is then free to receive and act upon a toy availability command received from another toy. Therefore, it is desirable to assign another transceiver to that control channel pair since the current transceiver is now being used to provide communication between the game and the toy.

To assign a further transceiver to the now un-monitored control channel, the transceiver which was formerly monitoring that control channel is marked as busy in a transceiver availability table (step 852). The transceiver availability table is then scanned until an available transceiver, i.e. a transceiver which is not marked as busy, is identified (step 854). This transceiver is then assigned to the control channel i (step 858).

FIG. 17 is a simplified flowchart illustration of a preferred method for implementing “select control channel pair” step 810 of FIG. 16. In FIG. 17, the four control channels are scanned. For each channel pair in which the noise level falls below a certain threshold (step 895), the computer sends an availability interrogation command (step 910) and waits for a predetermined time period, such as 250 ms, for a response (steps 930 and 940). If no other computer responds, i.e. sends back an “availability response command”, then the channel pair is deemed vacant. If the channel pair is found to be occupied the next channel is scanned. If none of the four channel pairs are found to be vacant, a “no control channel available” message is returned.

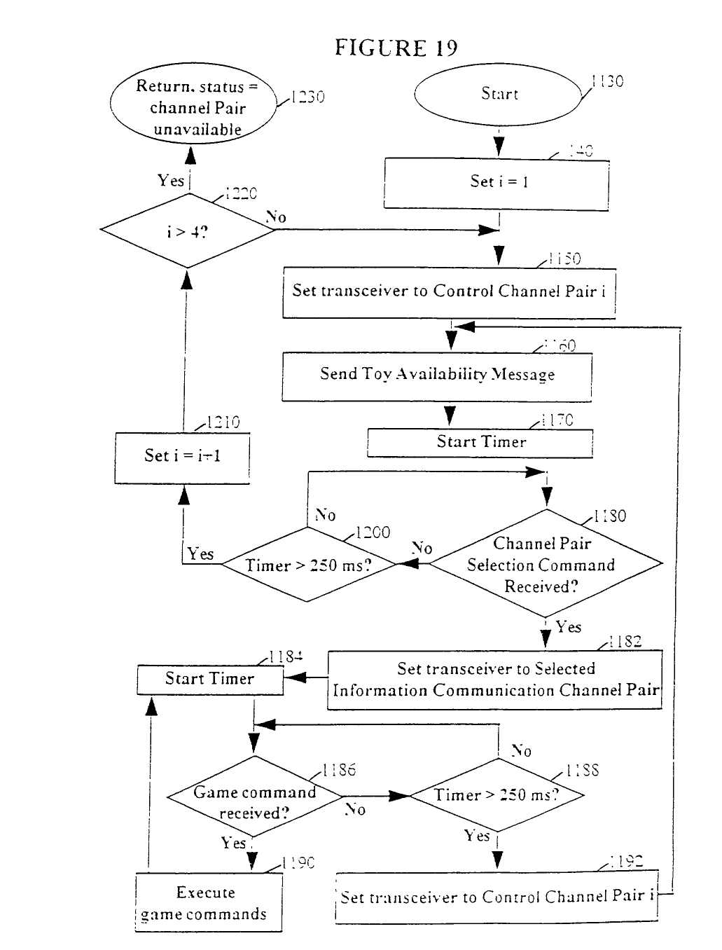

FIG. 19 is a self-explanatory flowchart illustration of a preferred method of operation of the toy control device 130 which is useful in conjunction with the “multi-channel” embodiment of FIGS. 16-18B. i=1, . . . , 4 is an index of the control channels of the system. The toy control device sends a “toy availability command” (step 1160) which is a message advertising the toy's availability, on each control channel i in turn (steps 1140, 1150, 1210), until a control channel is reached which is being monitored by a computer. This becomes apparent when the computer responds (step 1180) by transmitting a “channel pair selection command” which is a message designating the information channel pair over which the toy control device may communicate with the game running on the computer. At this point (step 1190), the toy control device may begin receiving and executing game commands which the computer transmits over the information channel pair designated in the control channel i.

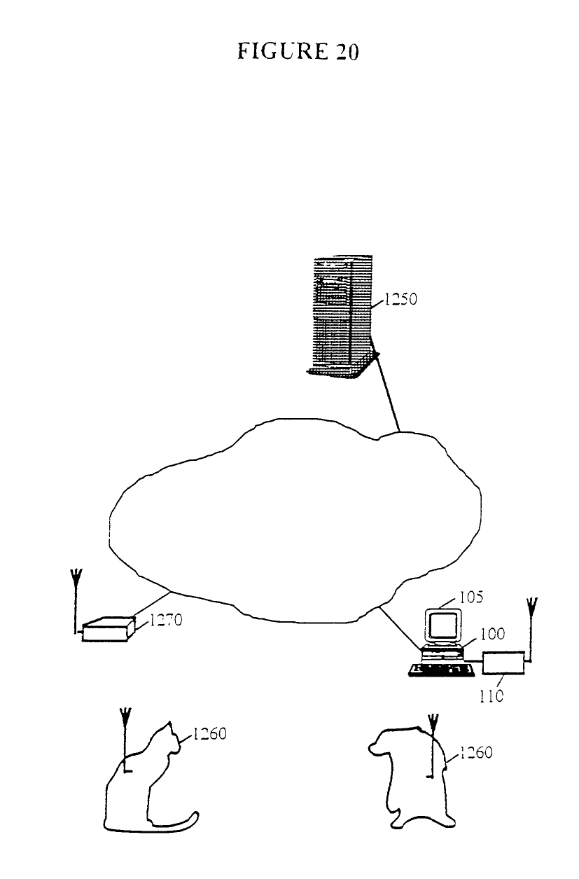

According to a preferred embodiment of the present invention, a computer system is provided, in communication with a remote game server, as shown in FIG. 20. The remote game server 1250 is operative to serve to the computer 100 at least a portion of at least one toy-operating game, which operates one or more toys 1260. Optionally, an entire game may be downloaded from the remote game server 1250. However, alternatively, a new toy action script or new text files may be downloaded from the remote game server 1250 whereas the remaining components of a particular game may already be present in the memory of computer 100.

Downloading from the remote game server 1250 to the computer 100 may take place either off-line, before the game begins, or on-line, in the course of the game. Alternatively, a first portion of the game may be received off-line whereas an additional portion of the game is received on-line.

The communication between the remote game server 1250 and the computer 100 may be based on any suitable technology such as but not limited to ISDN; X.25; Frame-Relay; and Internet.

An advantage of the embodiment of FIG. 20 is that a very simple computerized device may be provided locally, i.e. adjacent to the toy, because all “intelligence” may be provided from a remote source. In particular, the computerized device may be less sophisticated than a personal computer, may lack a display monitor of its own, and may, for example, comprise a network computer 1270.

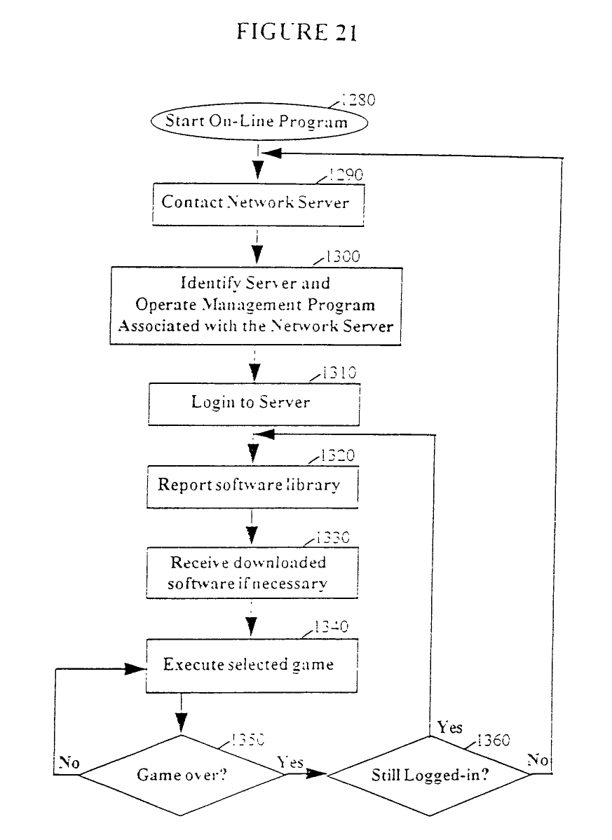

FIG. 21 is a simplified flowchart illustration of the operation of the computer 100 or of the network computer 1260 of FIG. 20, when operating in conjunction with the remote server 1250.

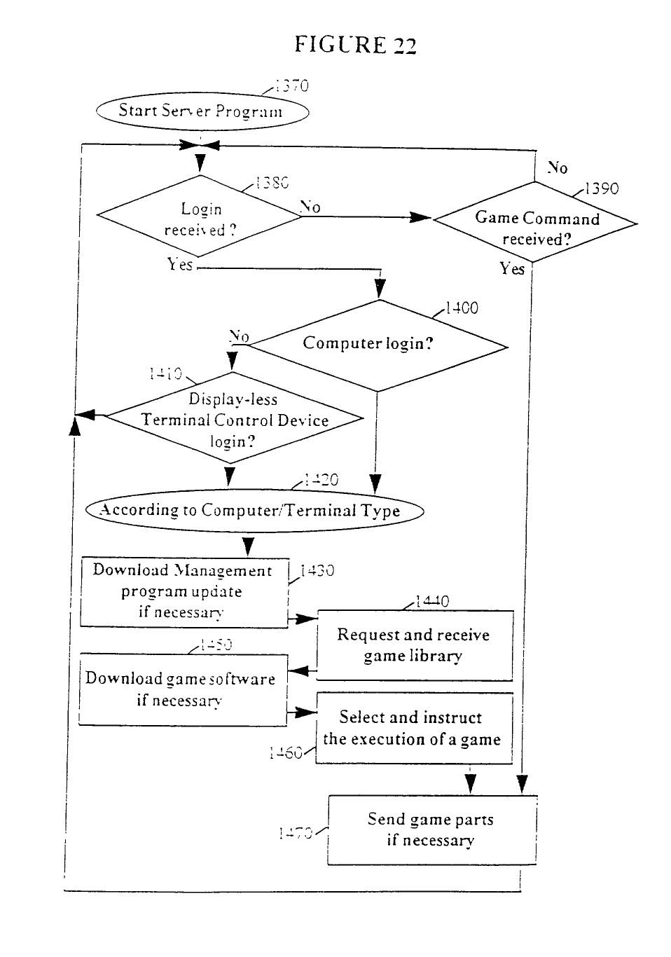

FIG. 22 is a simplified flowchart illustration of the operation of the remote game server 1250 of FIG. 20.

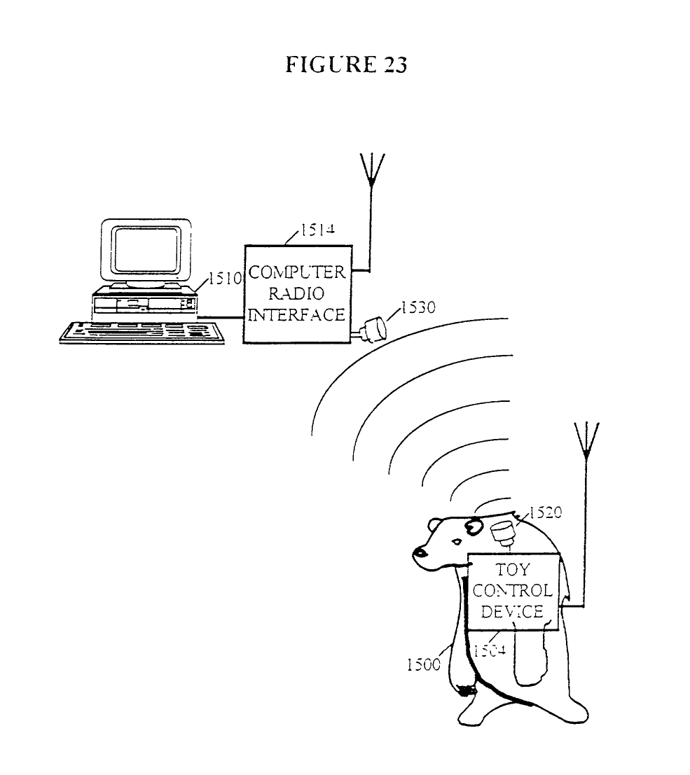

FIG. 23 is a semi-pictorial semi-block diagram illustration of a wireless computer controlled toy system including a toy 1500 having a toy control device 1504, a computer 1510 communicating with the toy control device 1504 by means of a computer-radio interface 1514 and a proximity detection subsystem operative to detect proximity between the toy and the computer. The proximity detection subsystem may for example include a pair of ultrasound transducers 1520 and 1530 associated with the toy and computer respectively. The toy's ultrasound transducer 1520 typically broadcasts ultrasonic signals which the computer's ultrasound transducer 1530 detects if the computer and toy are within ultrasonic communication range, e.g. are in the same room.

FIGS. 24A-24E, taken together, form a detailed electronic schematic diagram of a multi-channel implementation of the computer radio interface 110 of FIG. 3 which is similar to the detailed electronic schematic diagrams of FIGS. 5A-5D except for being multi-channel, therefore capable of supporting full duplex applications, rather than single-channel.

FIGS. 25A-25F, taken together, form a detailed schematic illustration of a computer radio interface which connects to a serial port of a computer rather than to the sound board of the computer.

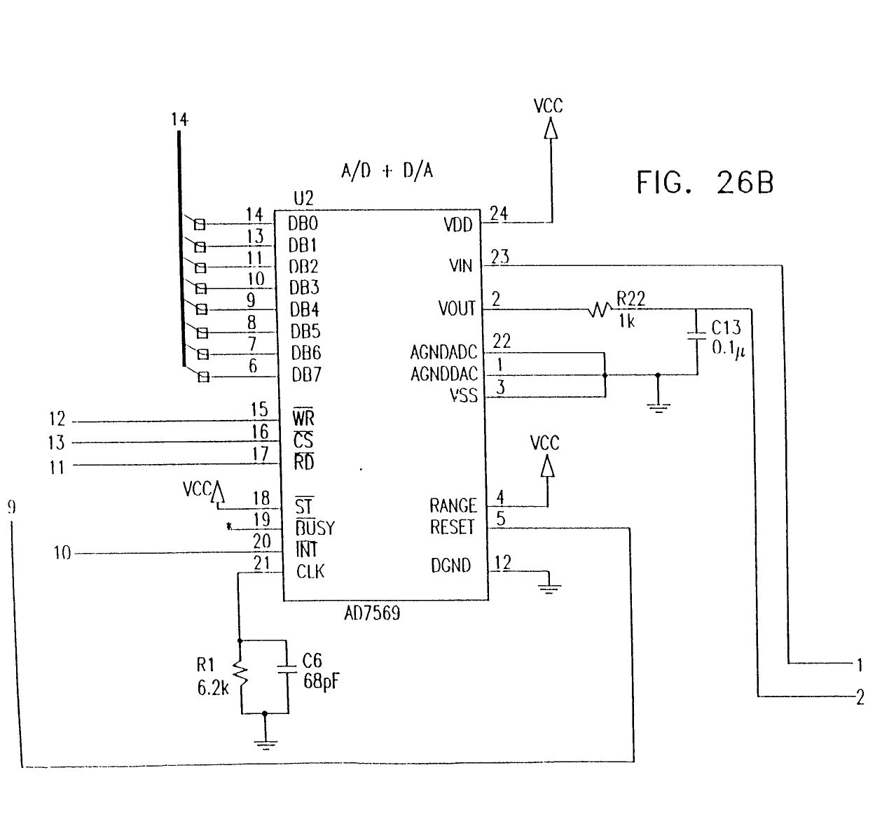

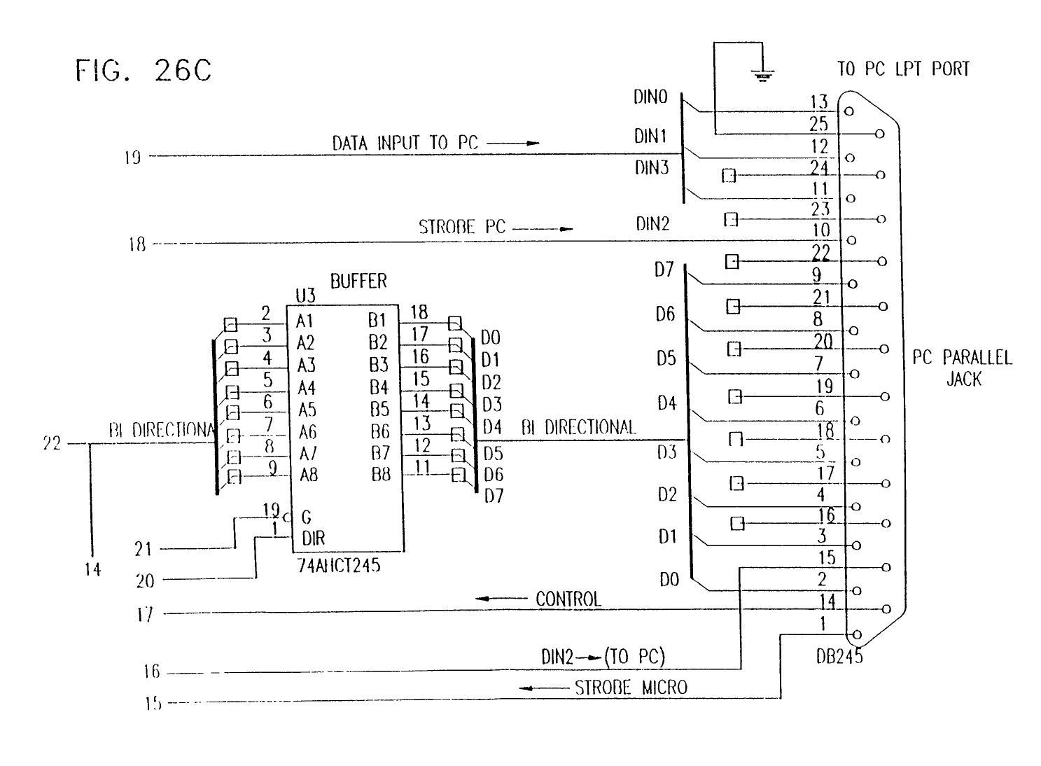

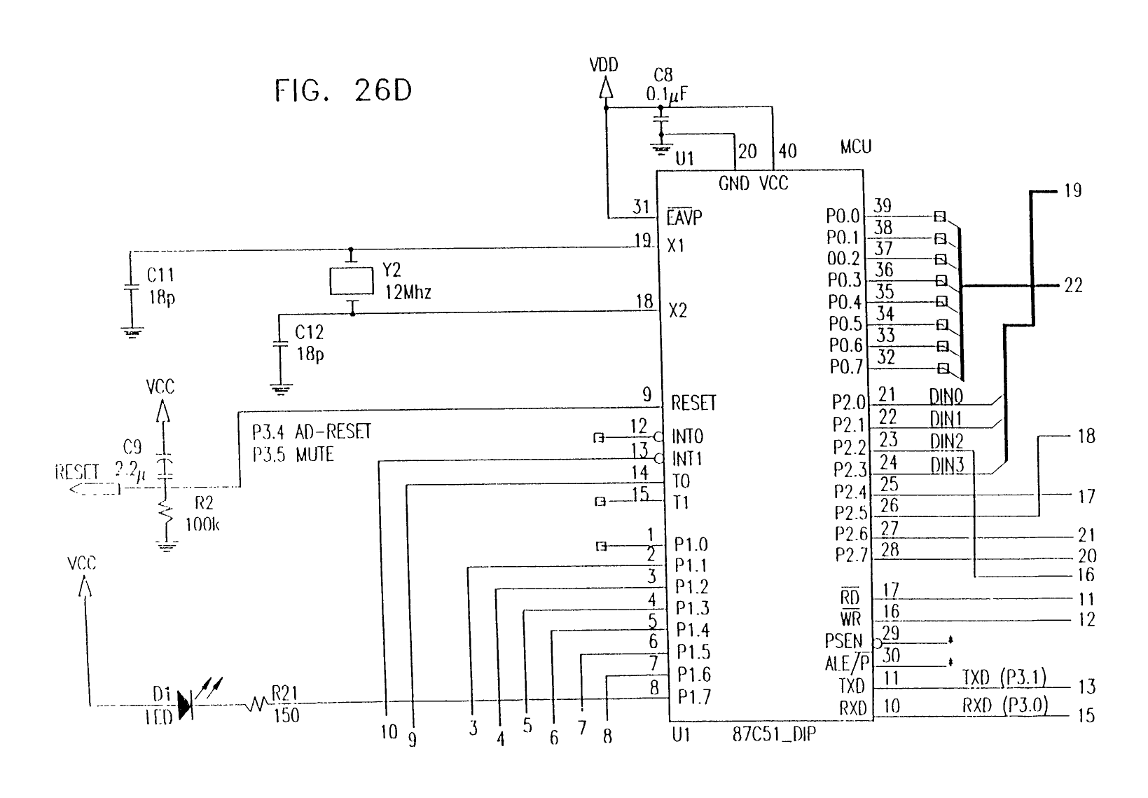

FIGS. 26A-26D, taken together, form a detailed schematic illustration of a computer radio interface which connects to a parallel port of a computer rather than to the sound board of the computer.

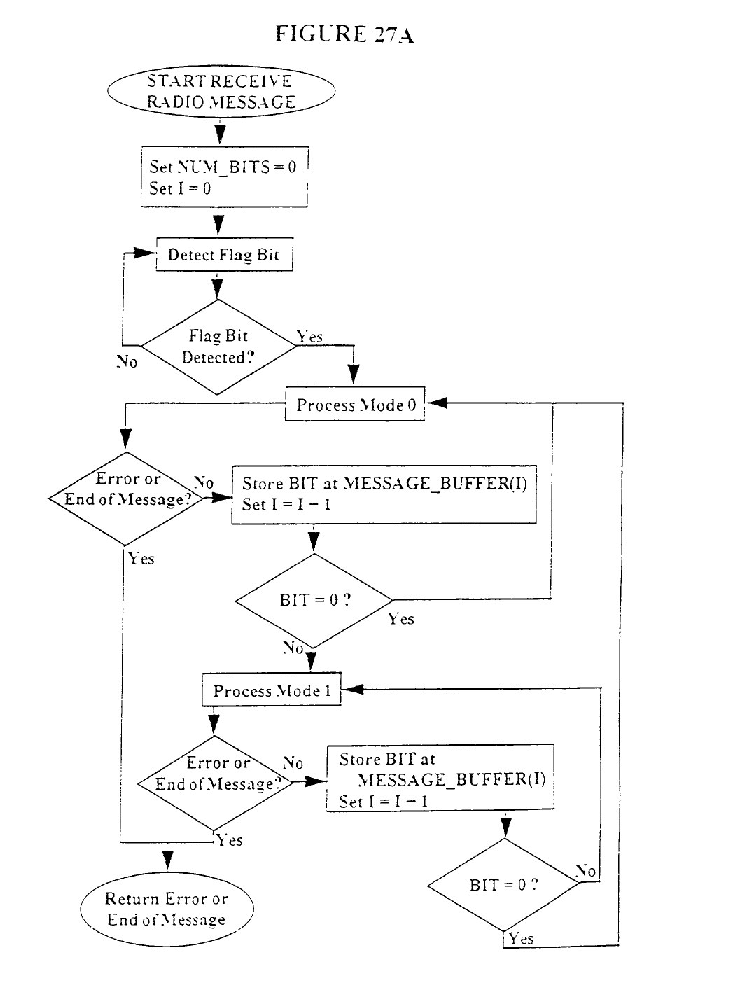

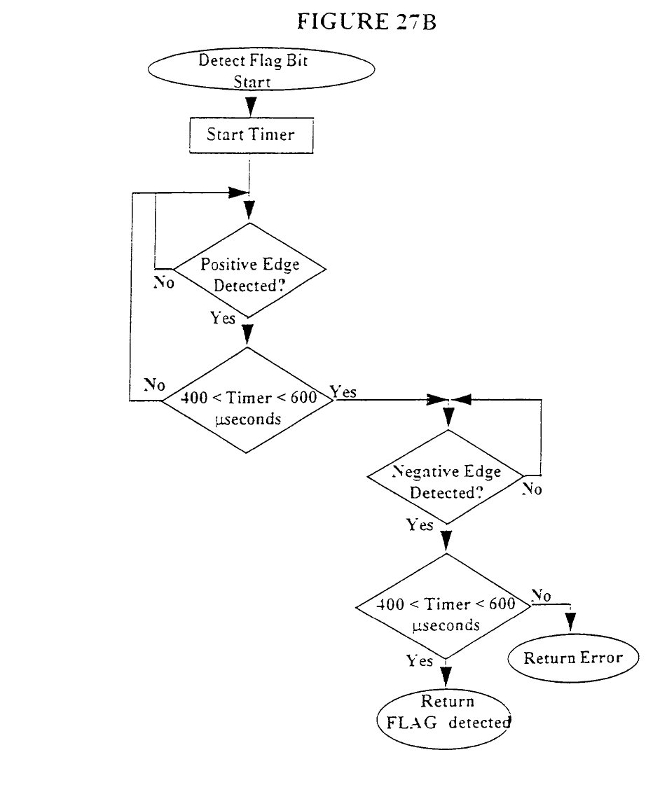

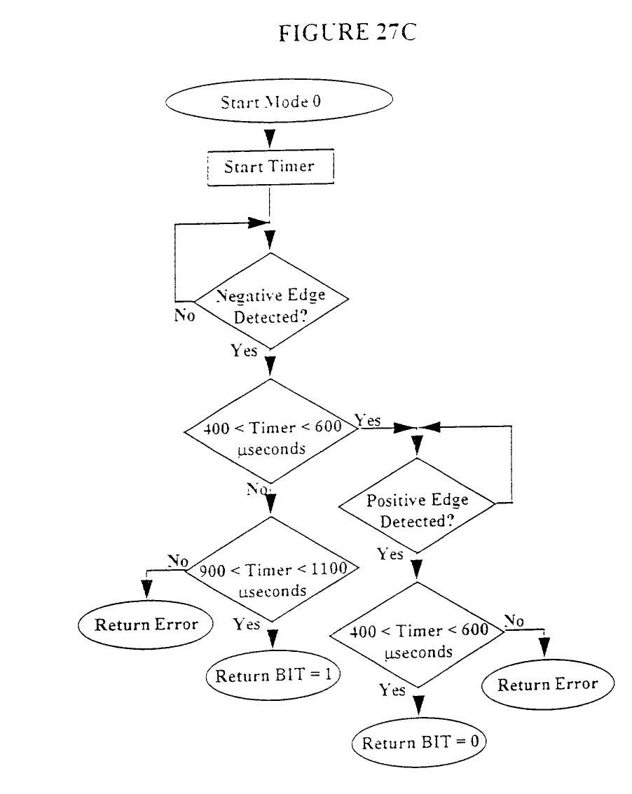

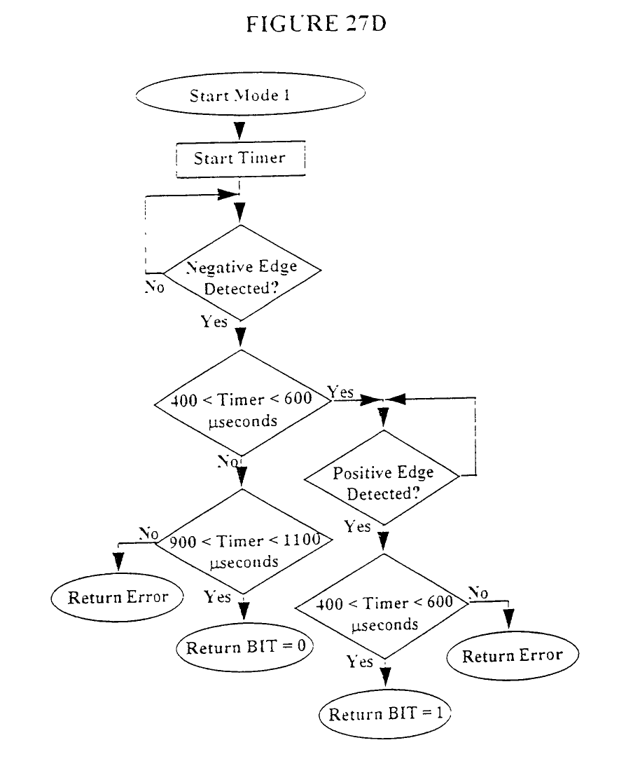

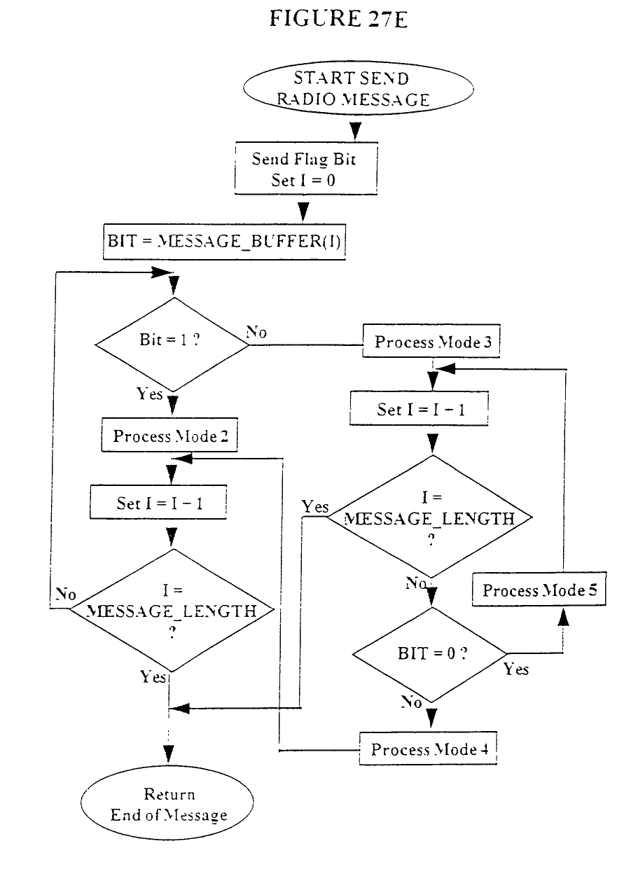

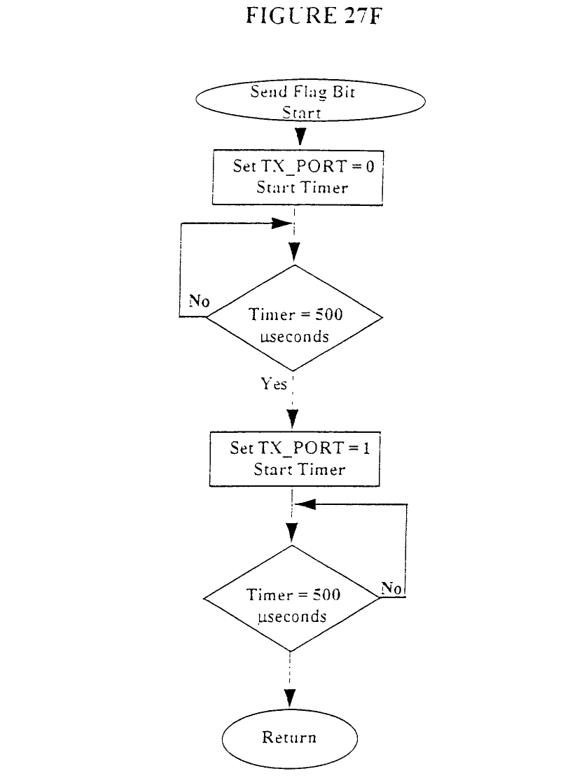

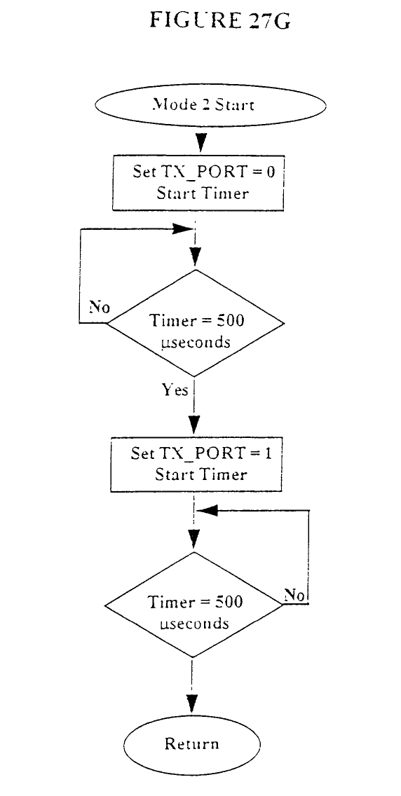

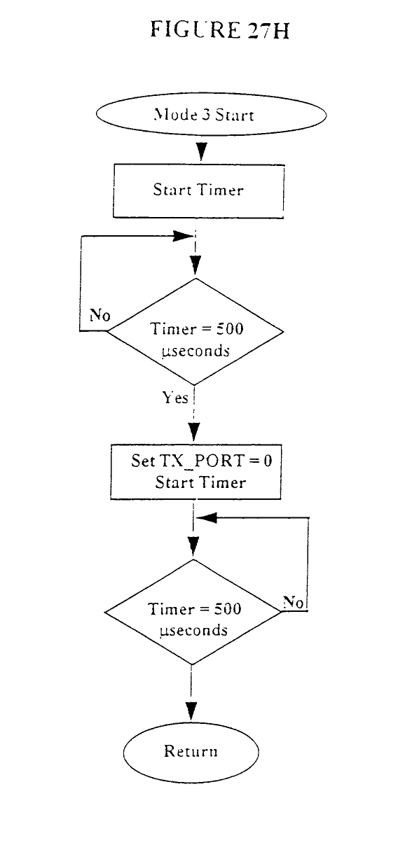

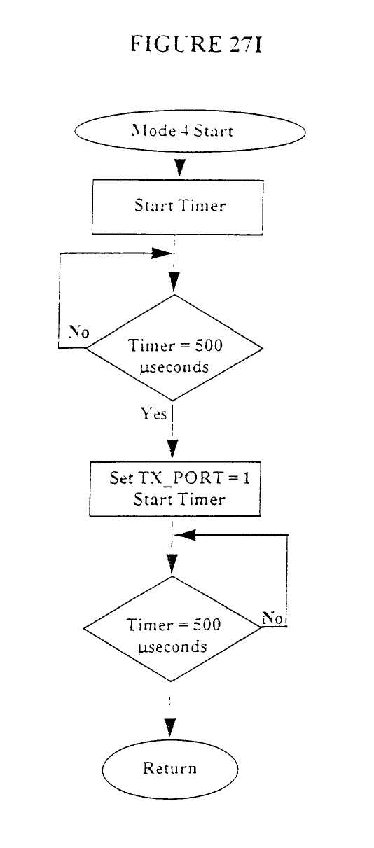

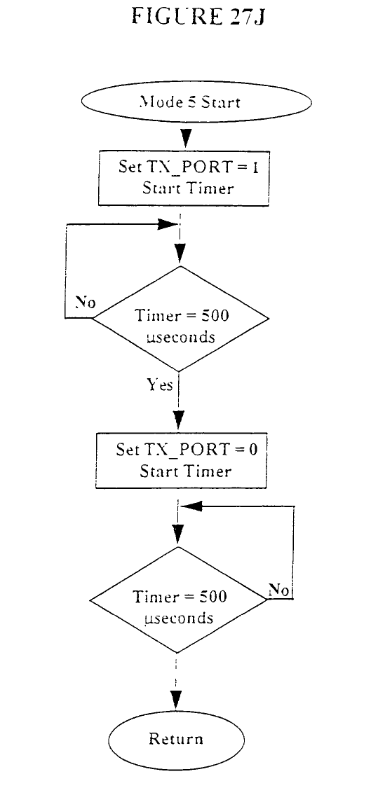

FIGS. 27A-27J are preferred self-explanatory flowchart illustrations of a preferred radio coding technique, based on the Manchester coding, which is an alternative to the radio coding technique described above with reference to FIGS. 8E, 8G-8M and 10A-C.

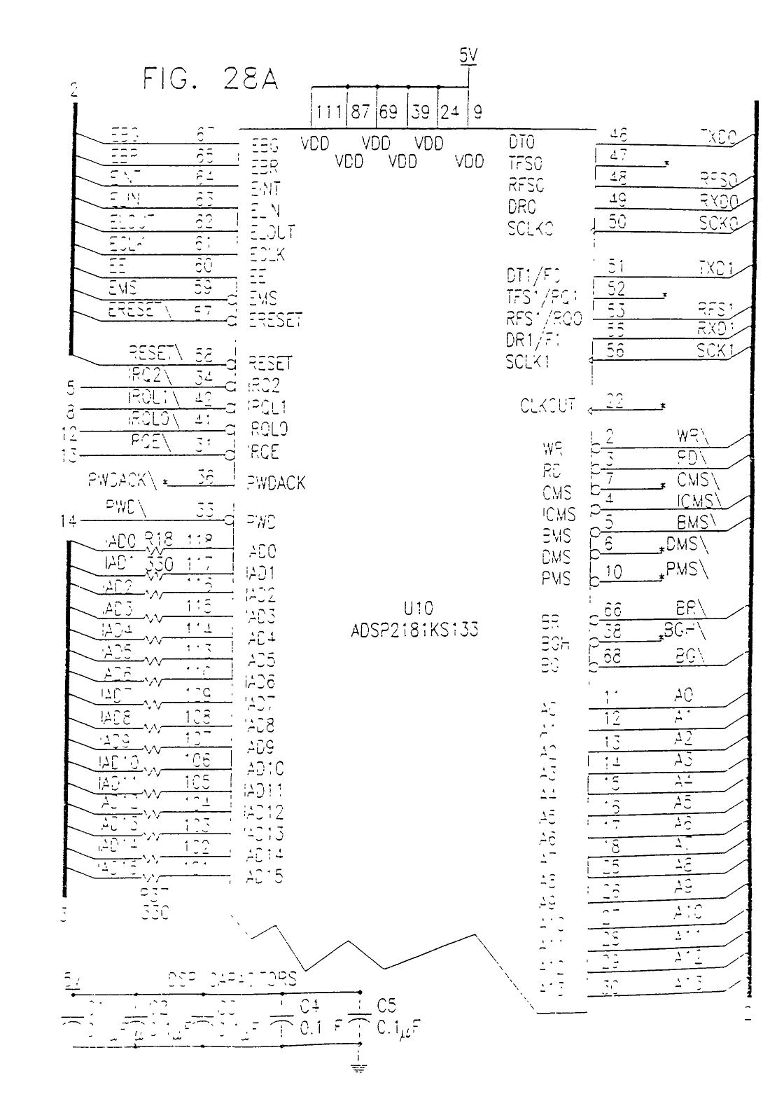

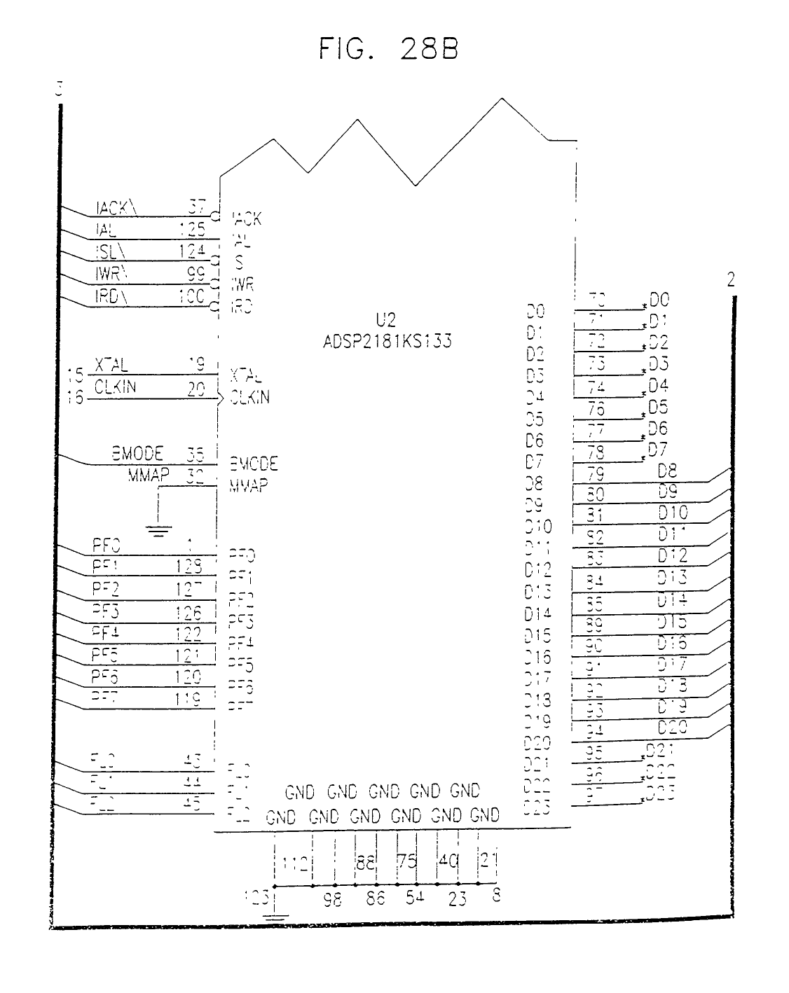

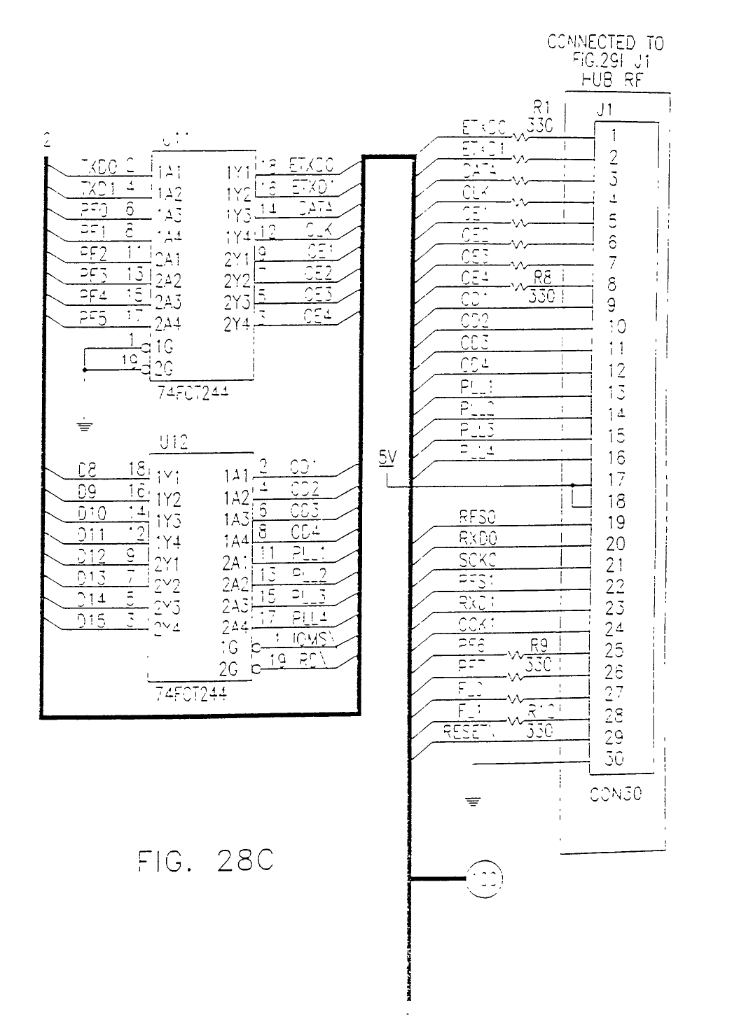

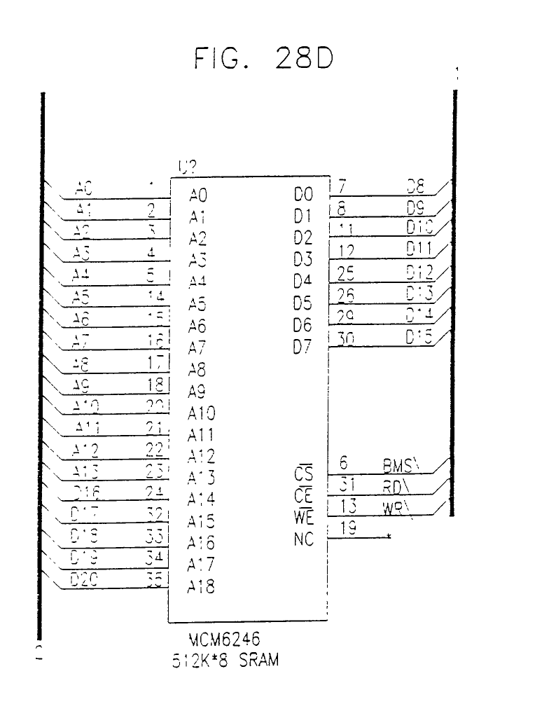

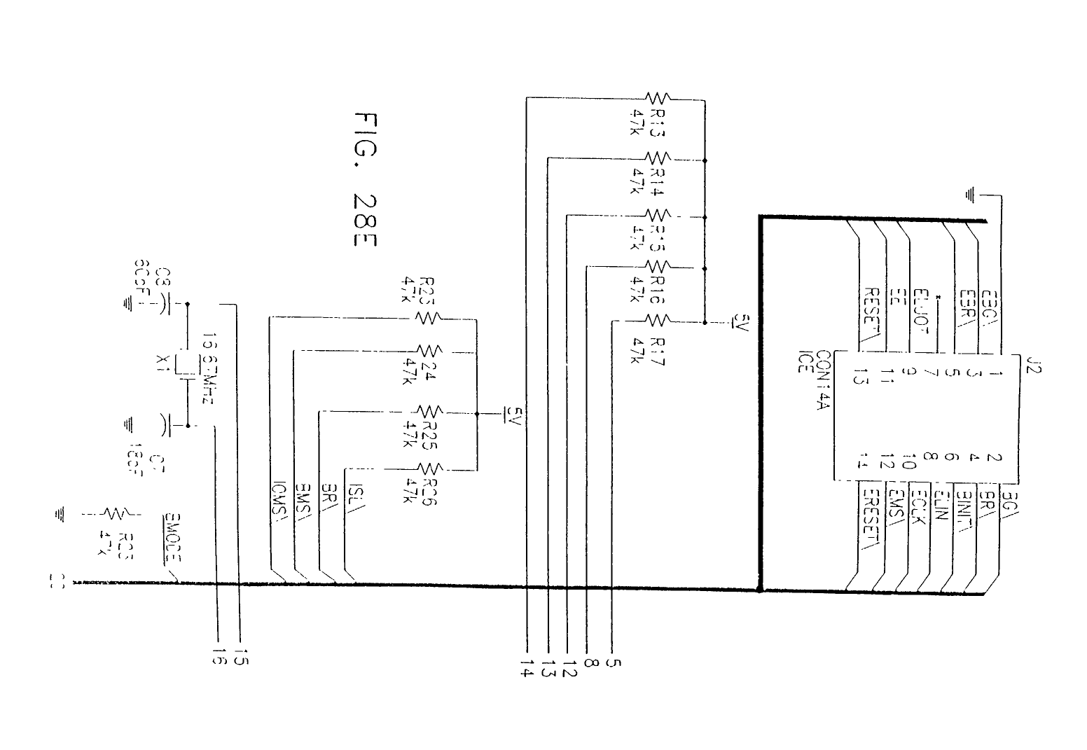

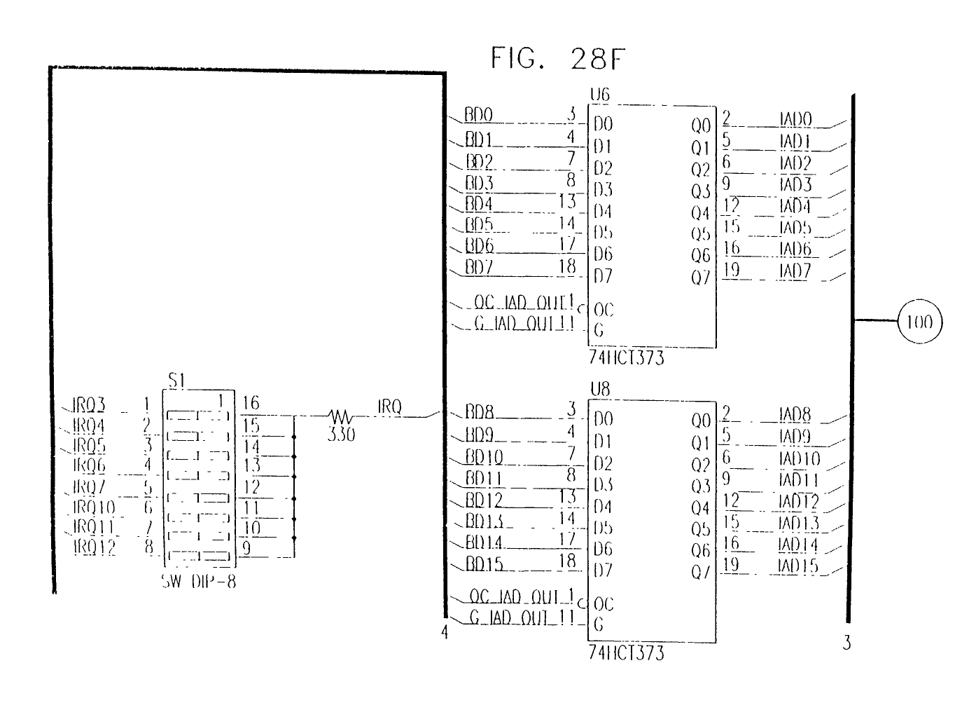

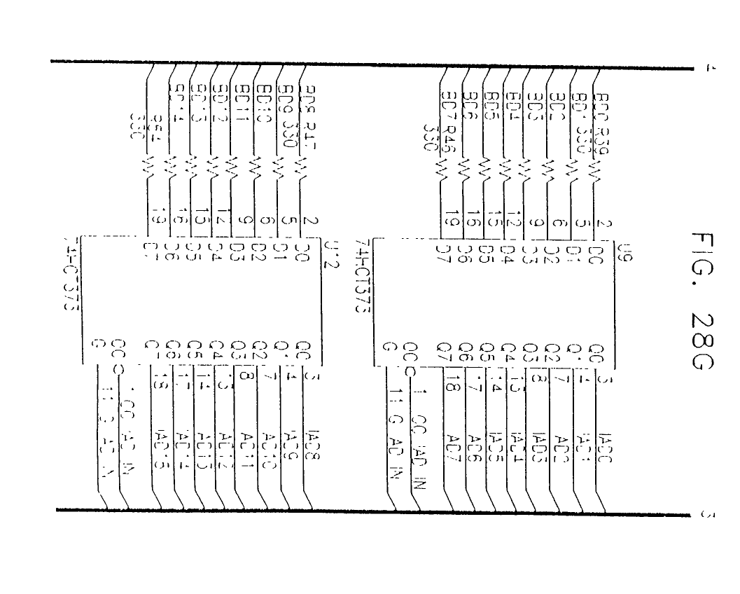

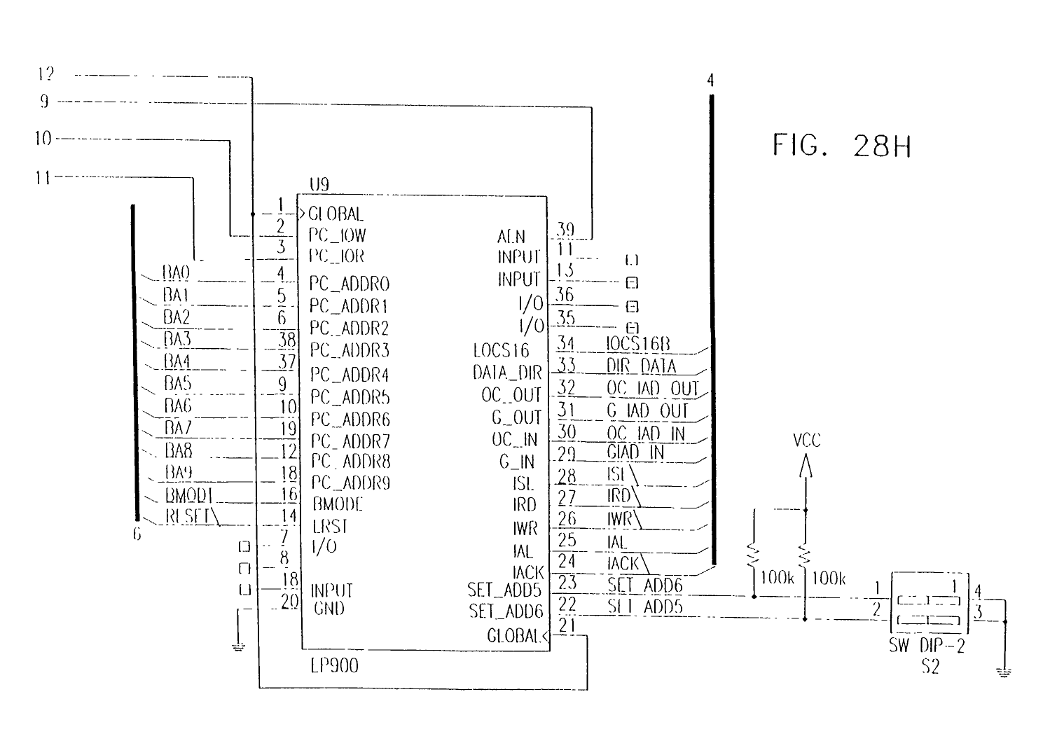

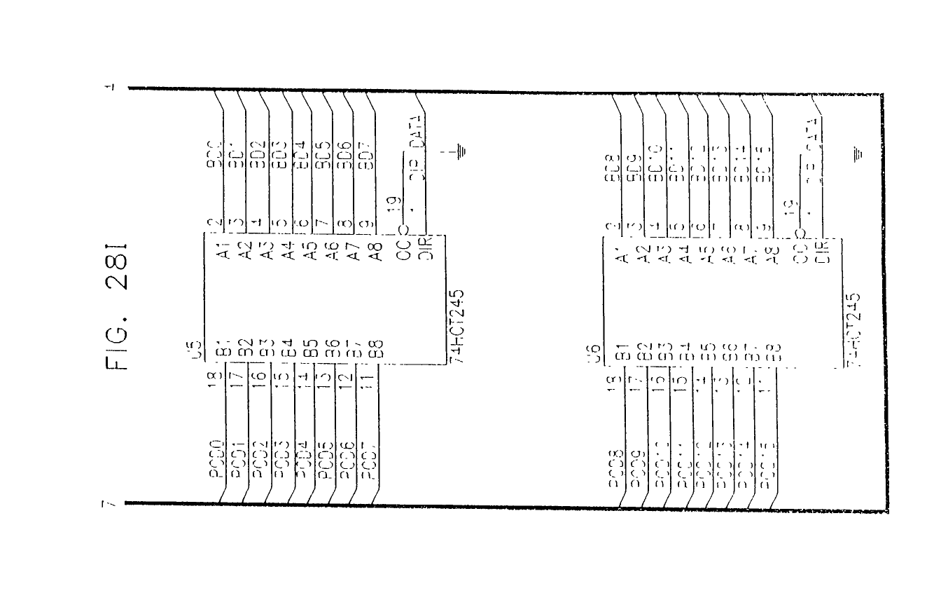

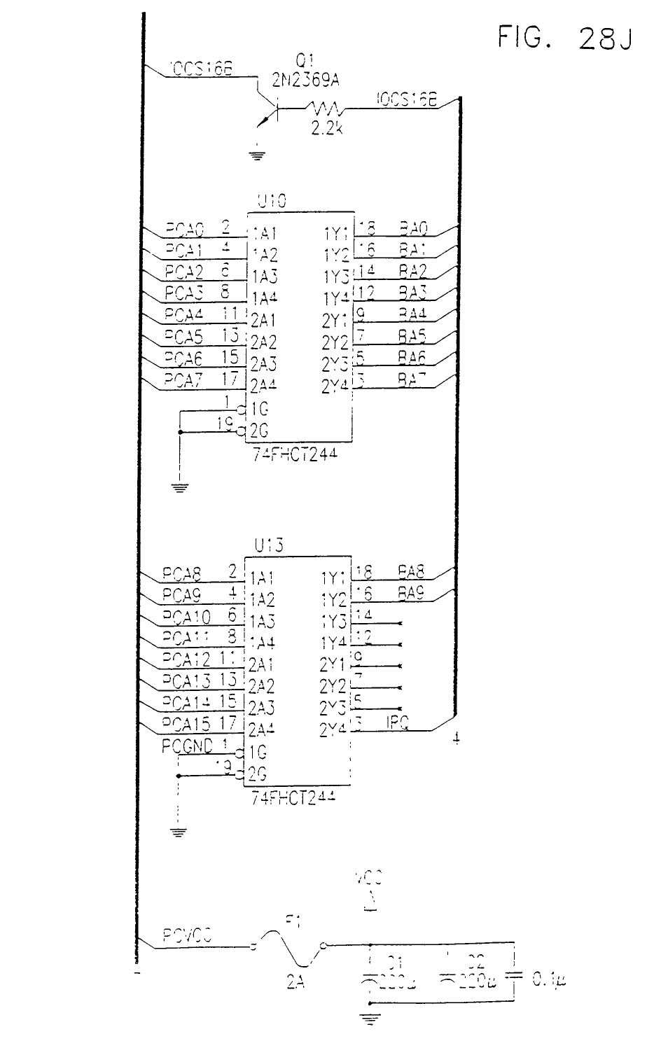

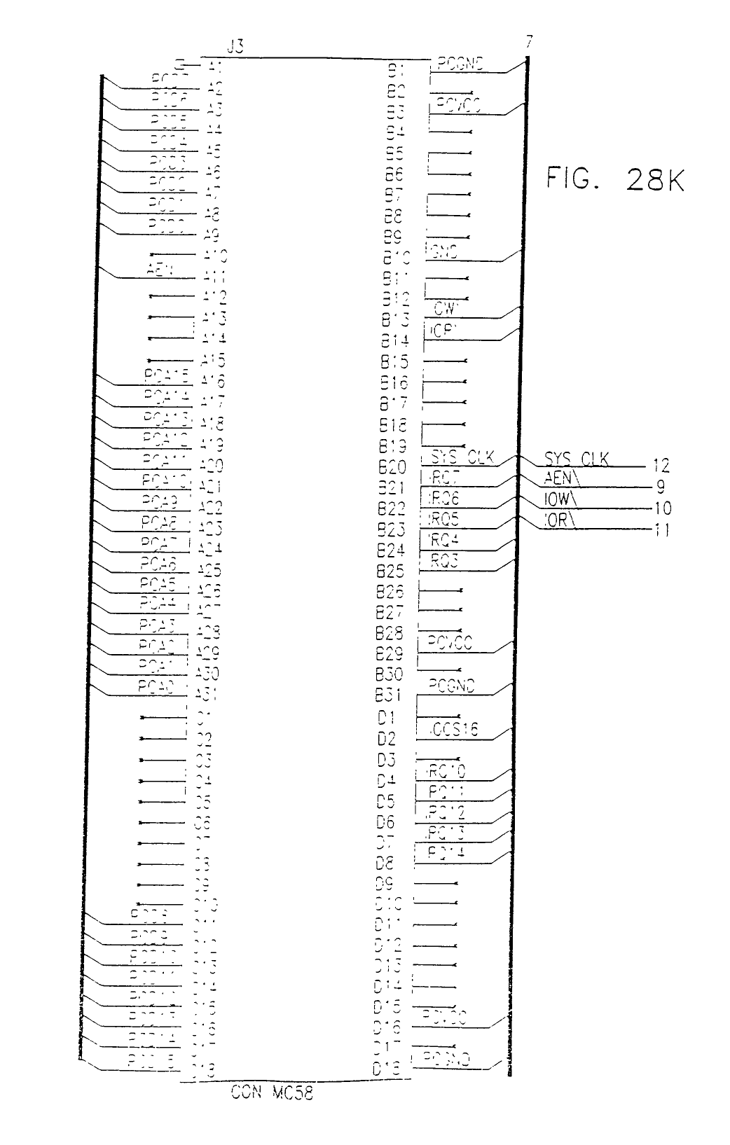

FIGS. 28A-28K, taken together, form a detailed electronic schematic diagram of the multi-port multi-channel computer radio interface sub-unit of FIG. 13.

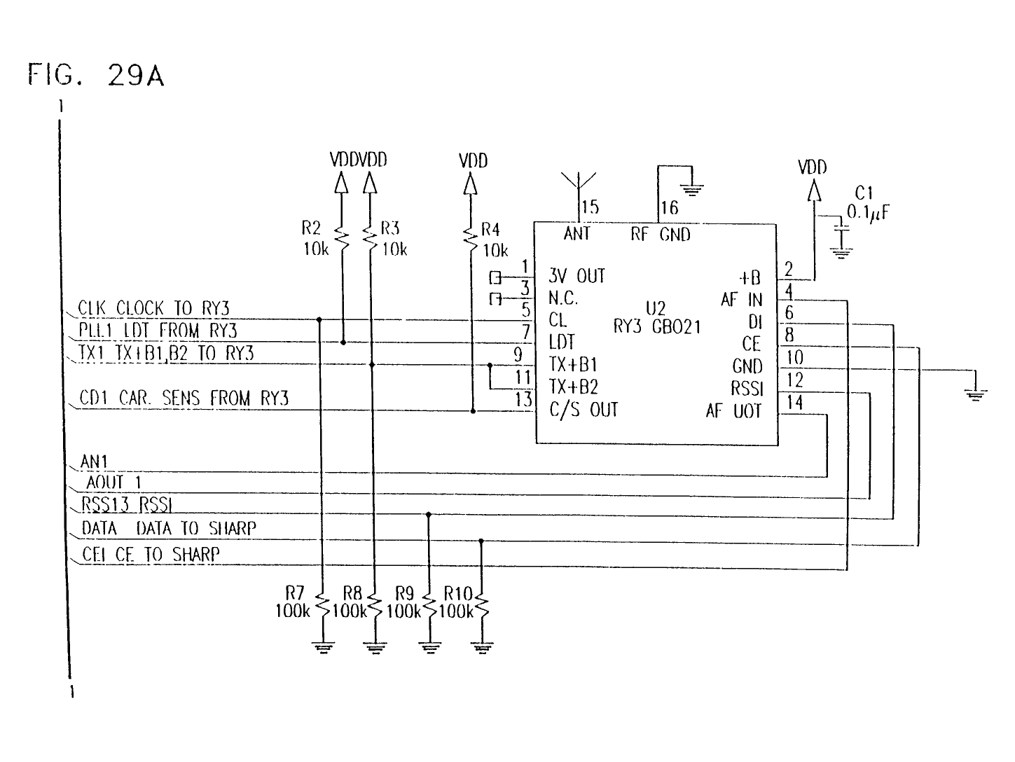

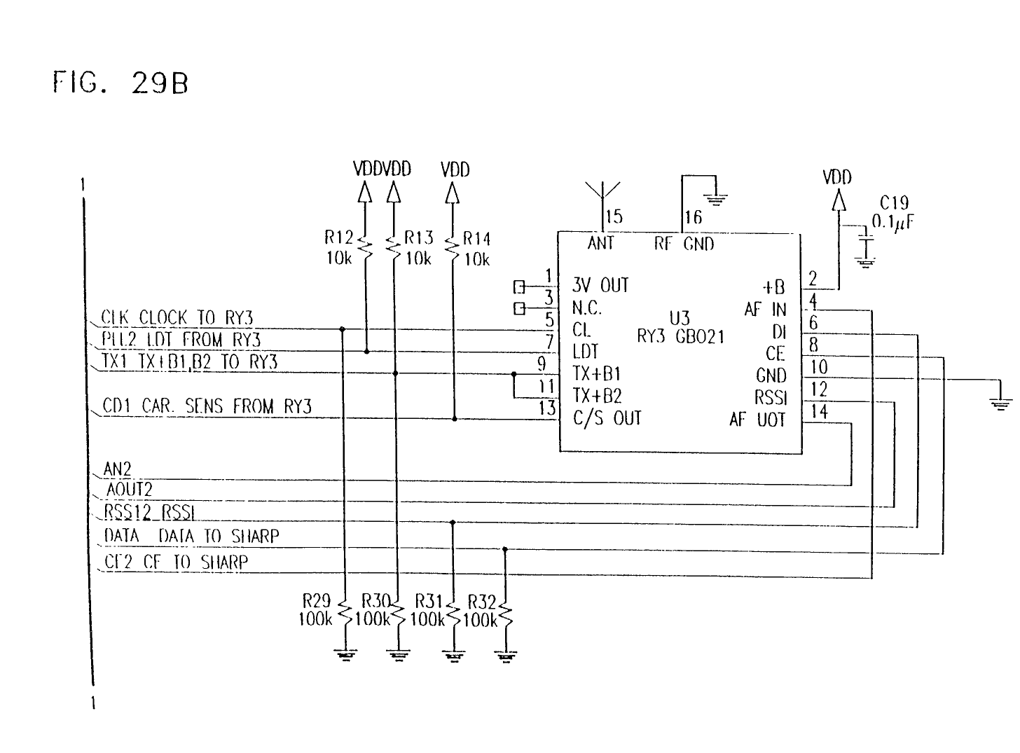

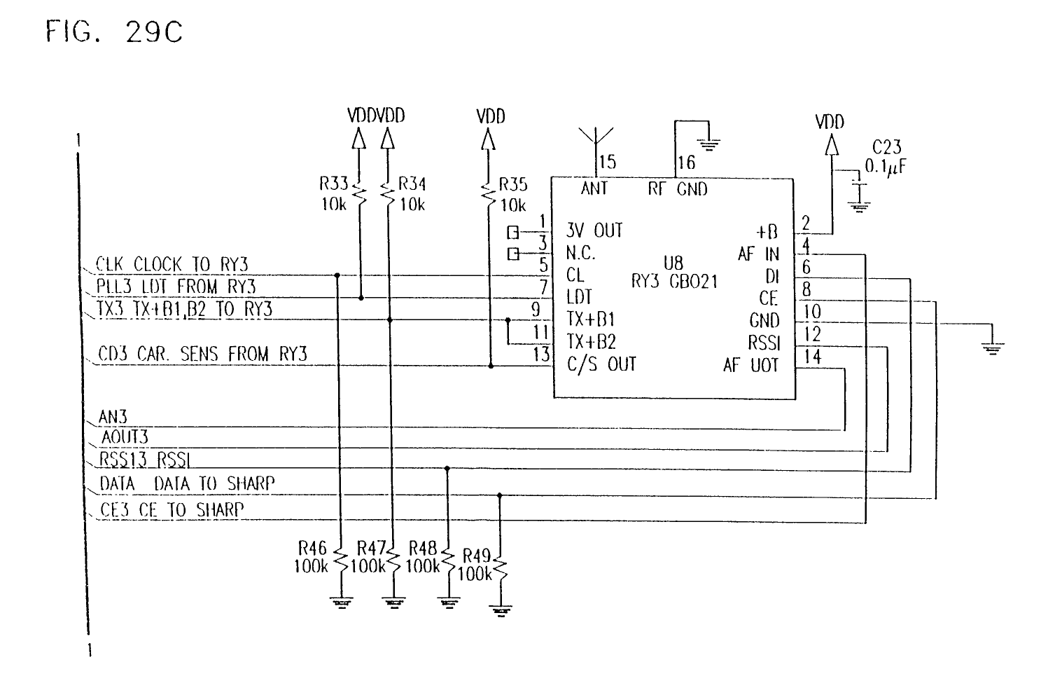

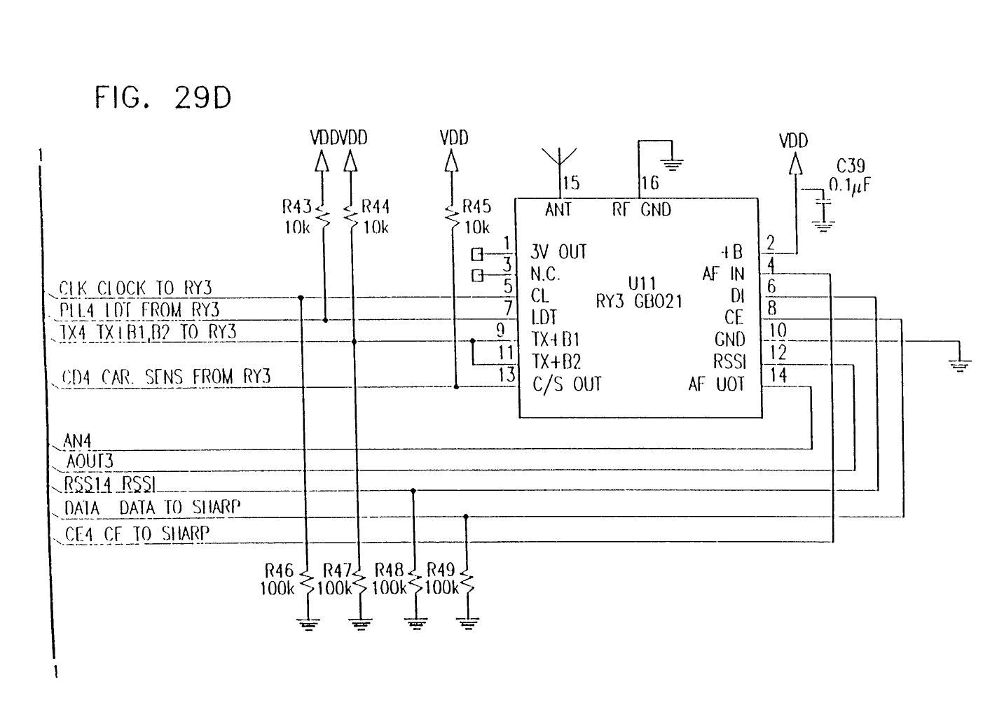

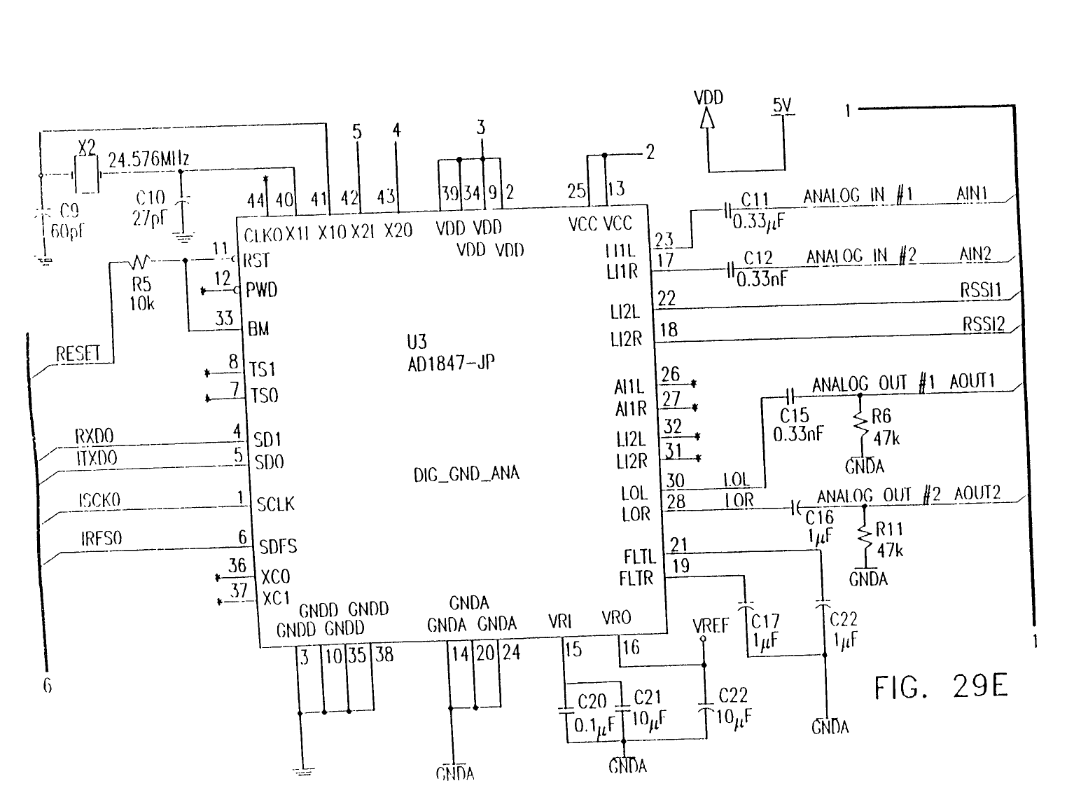

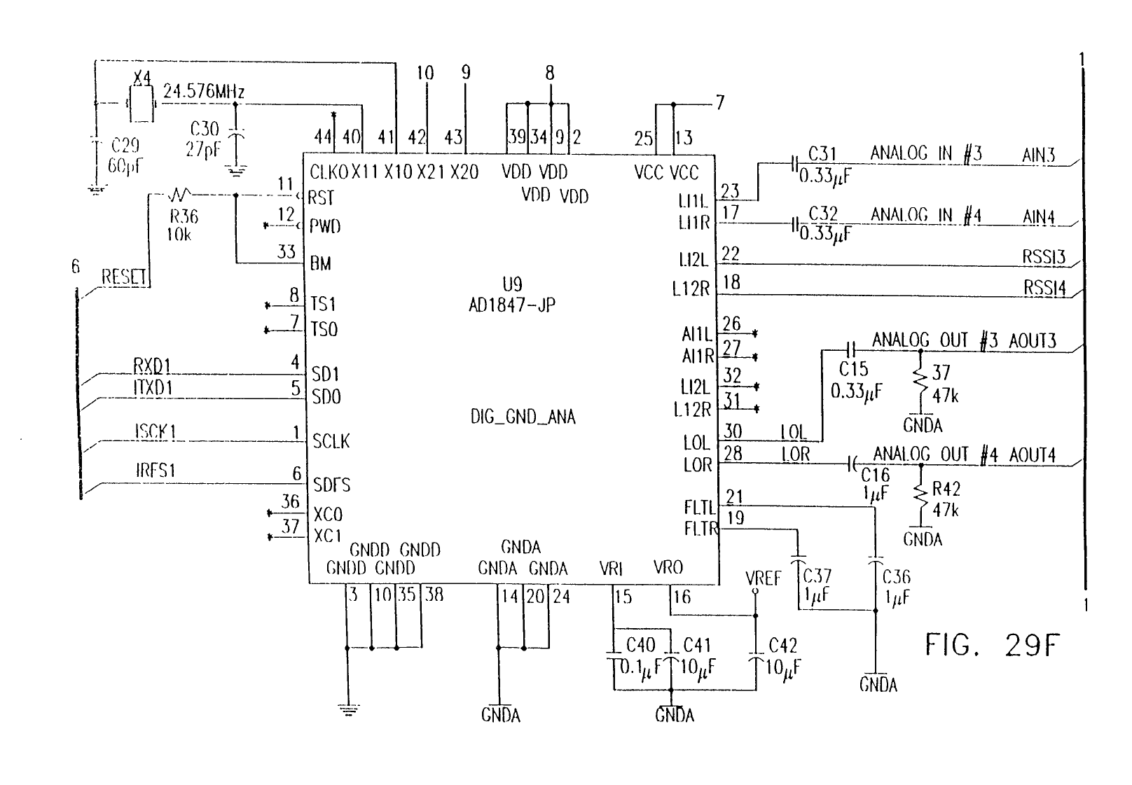

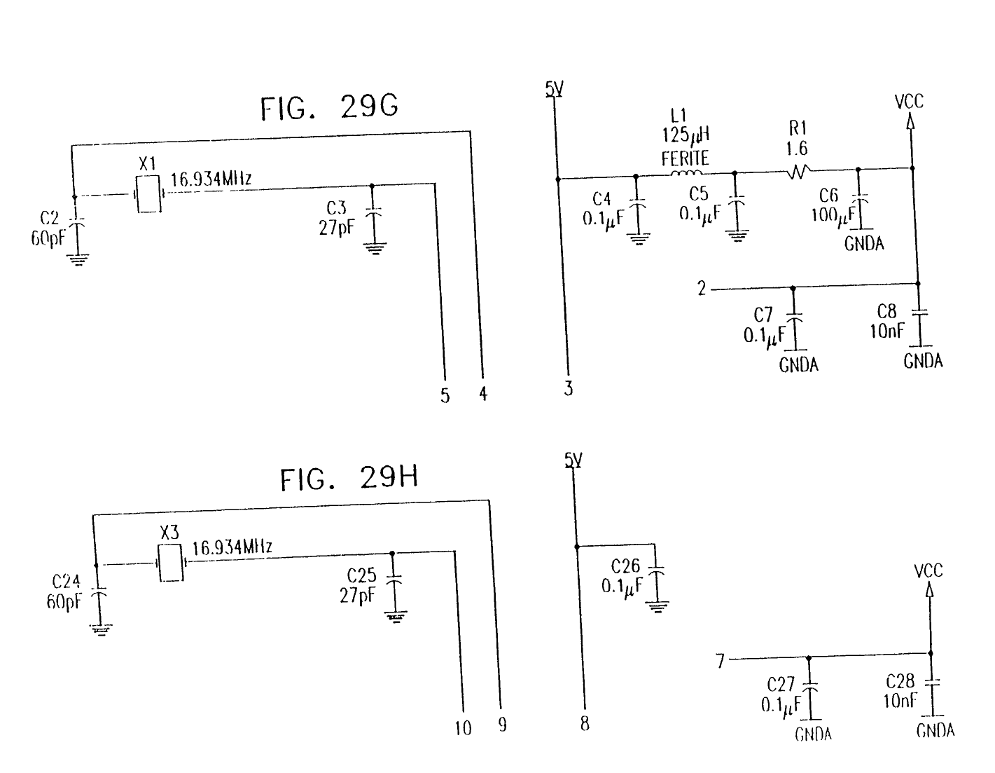

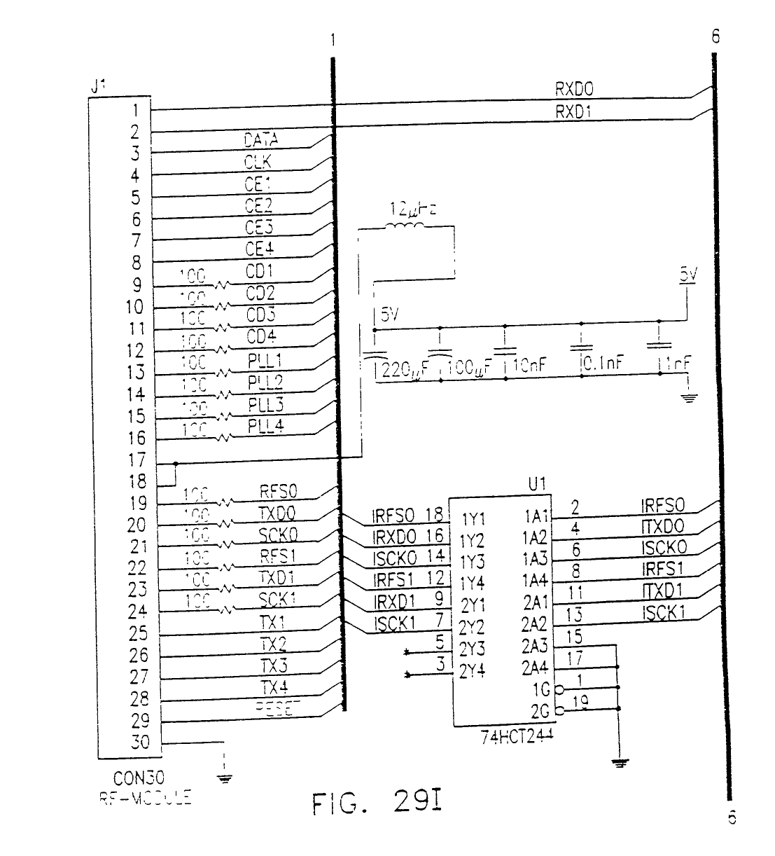

FIGS. 29A-29I, taken together, form a detailed electronic schematic diagram of the multi-port multi-channel computer radio interface sub-unit of FIG. 14.

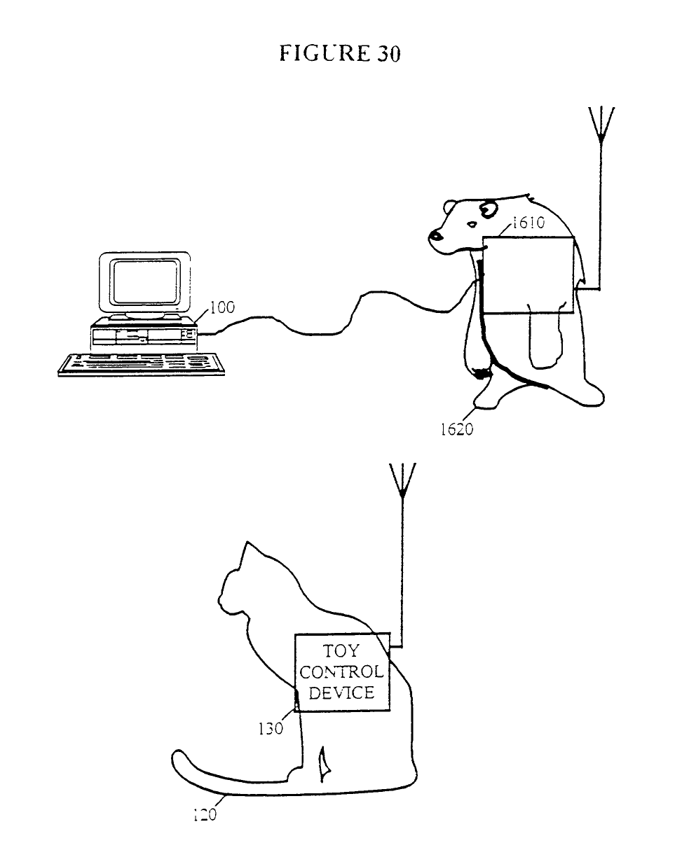

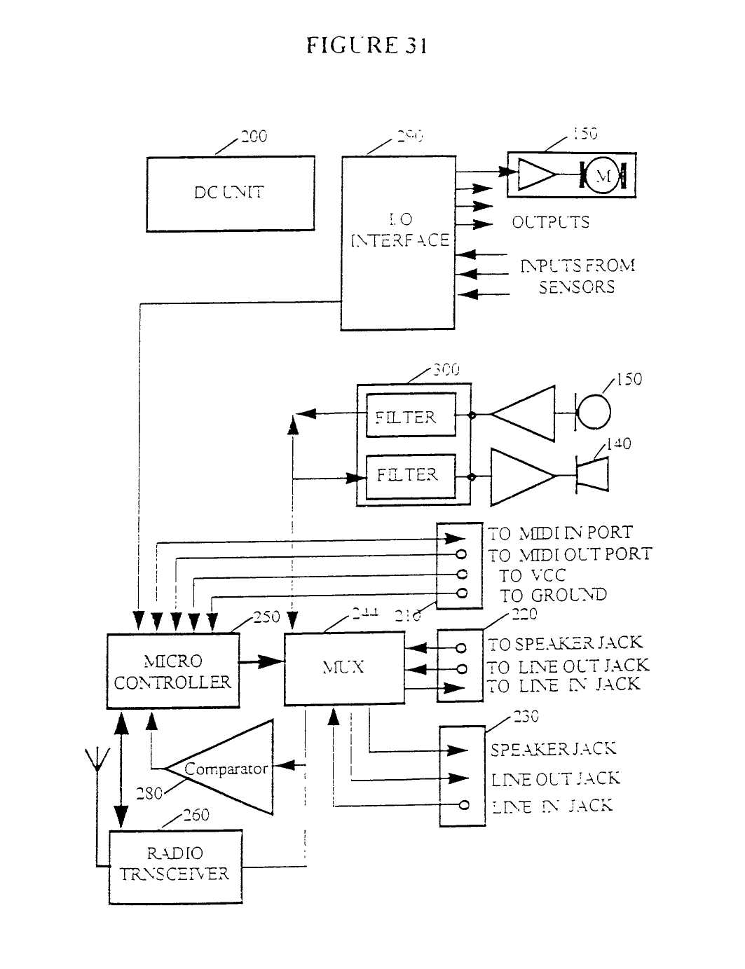

FIG. 30 illustrates a further embodiment of the present invention which includes a combination of a Computer Radio Interface (CRI) and a Toy Control Device (TCD), 1610.

The combined unit 1610 controls a toy 1620 which is connected to the computer 100 by a device, such as a cable, and communicates with other toys, 120, by means such as radio communication, using the computer radio interface 110. The toy 1620 is operated in a similar manner as the toy device 120.

FIG. 31 illustrates a simplified block diagram of the combined unit 1610.

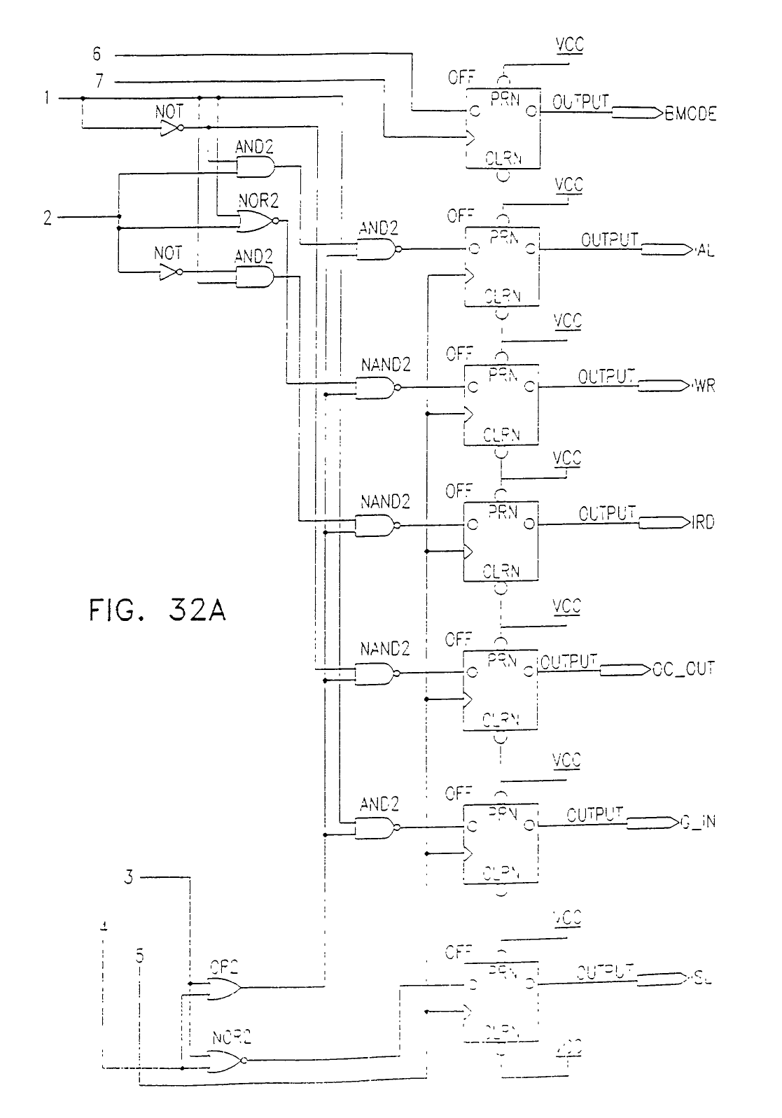

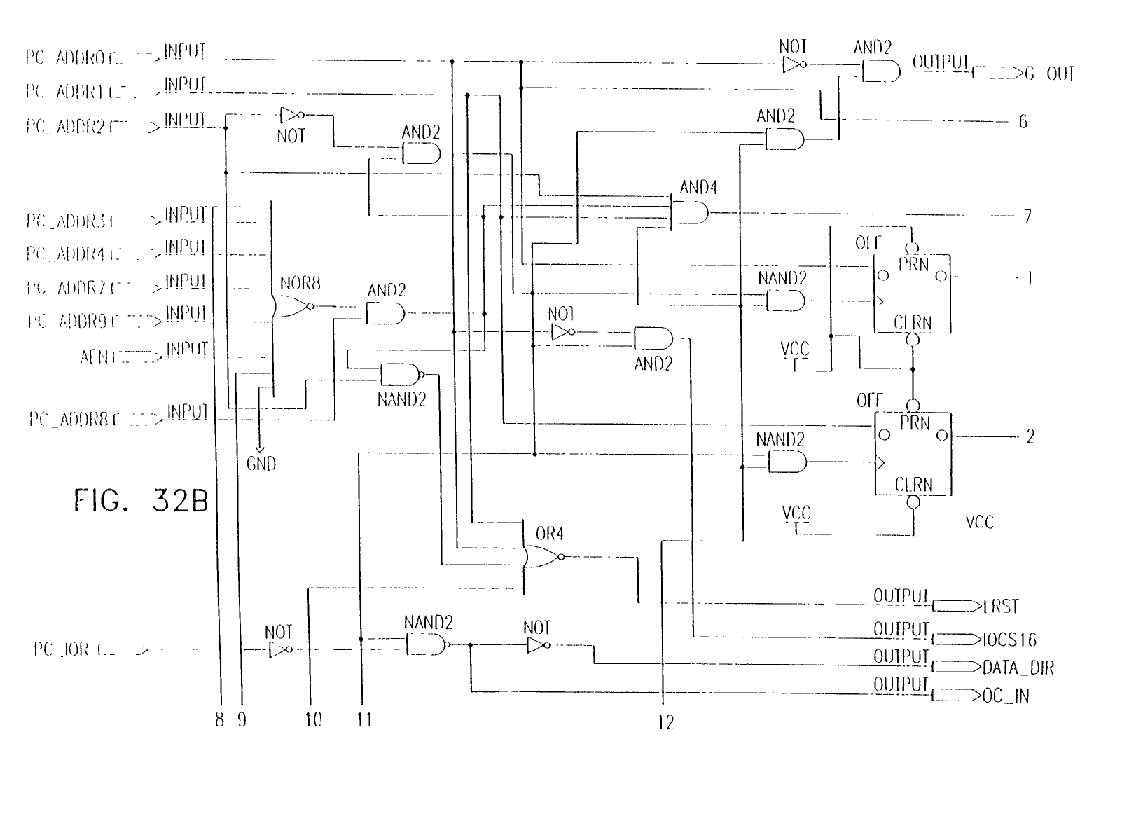

FIGS. 32A, 32B and 32C taken together form a simplified schematic diagram of the EP900 EPLD chip (U9) of FIG. 28H. The code to program the EPLD chip for this schematic diagram preferably uses the programming package “Max Plus II Ver. 6.2” available from Altera Corporation, 3525 Monroe Street, Santa Clara, Calif. 5051, USA.

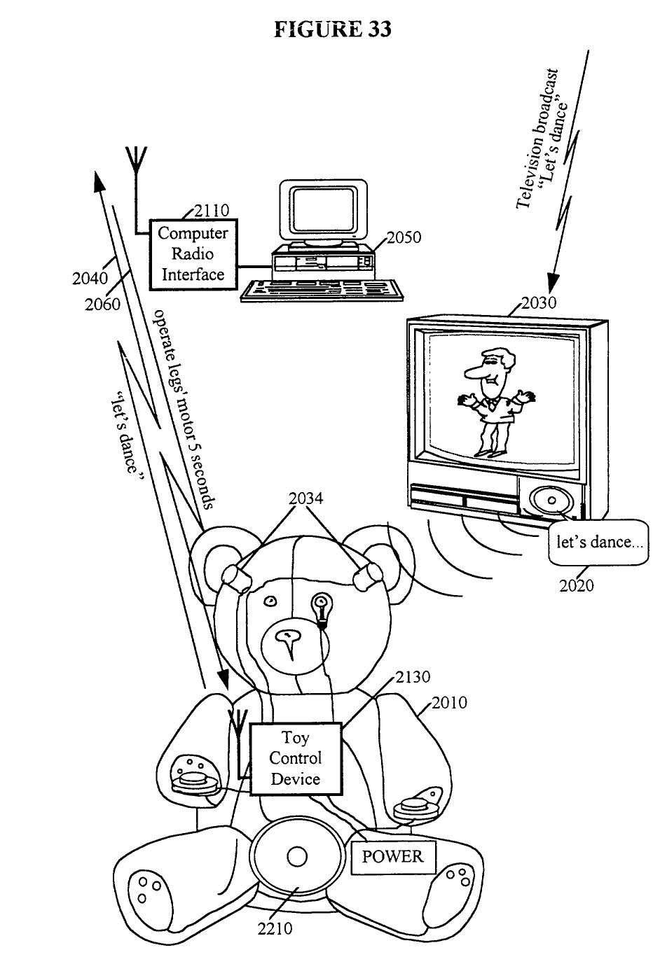

FIGS. 33-54, described hereinbelow, illustrate embodiments of the toy system of FIGS. 1-32C in which a computer-controlled toy system controls toys by means of a television or radio.

FIG. 33 is a semi-pictorial semi-block diagram illustration of a toy 2010 sensing audio information 2020 from a television 2030 viewed by a user, wherein one or more microphones 2034, typically mounted on the toy 2010, senses the audio information 2020 in acoustic form and transmits a digital representation 2040 of this information, wirelessly, to a computer 2050. The toy then receives from the computer 2050 commands 2060 which are responsive to the digital representation 2040 of the audio information 2020. Radio communication is provided between the computer 2050 and the toy 2010 via a computer radio interface 2110, which is a hardware unit associated with the computer 2050 and a toy control device 2130 typically residing within the toy 2010. A preferred embodiment of the computer radio interface 2110 and of the toy control device 2130 are described in detail hereinabove with reference to FIGS. 1-32C.

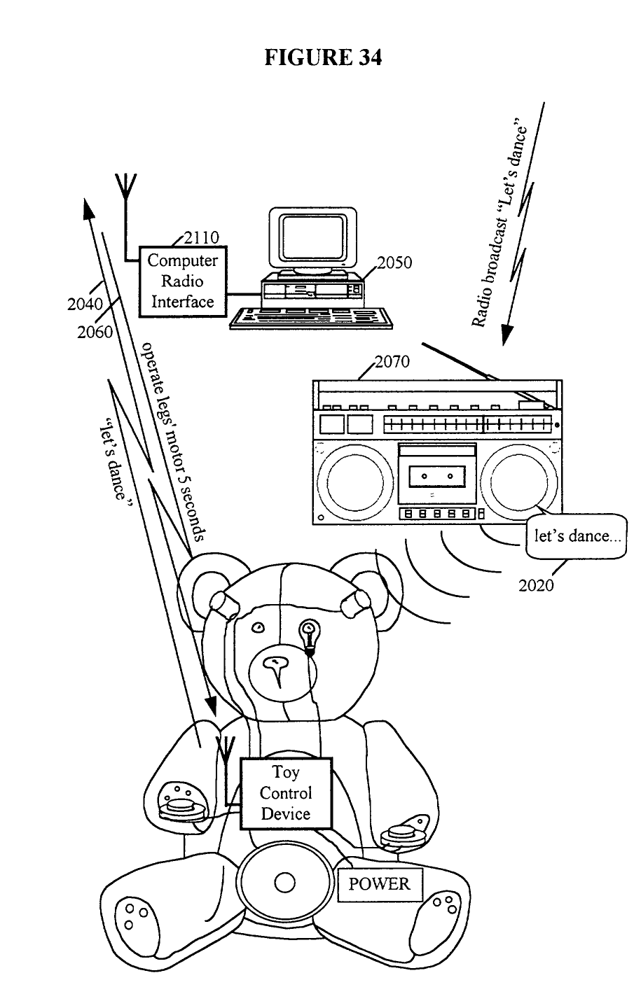

FIG. 34 is a semi-pictorial semi-block diagram illustration of a modification of the apparatus of FIG. 33 which is similar to the apparatus of FIG. 33 except that the toy 2010 senses audio information 2020 from a radio 2070 listened to by a user. The toy senses the audio information 2020 in acoustic form and transmits a digital representation 2040 of this information, wirelessly, to a computer 2050. The toy then receives from the computer 2050 commands 2060 which are responsive to the digital representation 2040 of the audio information 2020.

Alternatively, the radio may comprise an audio cassette player.

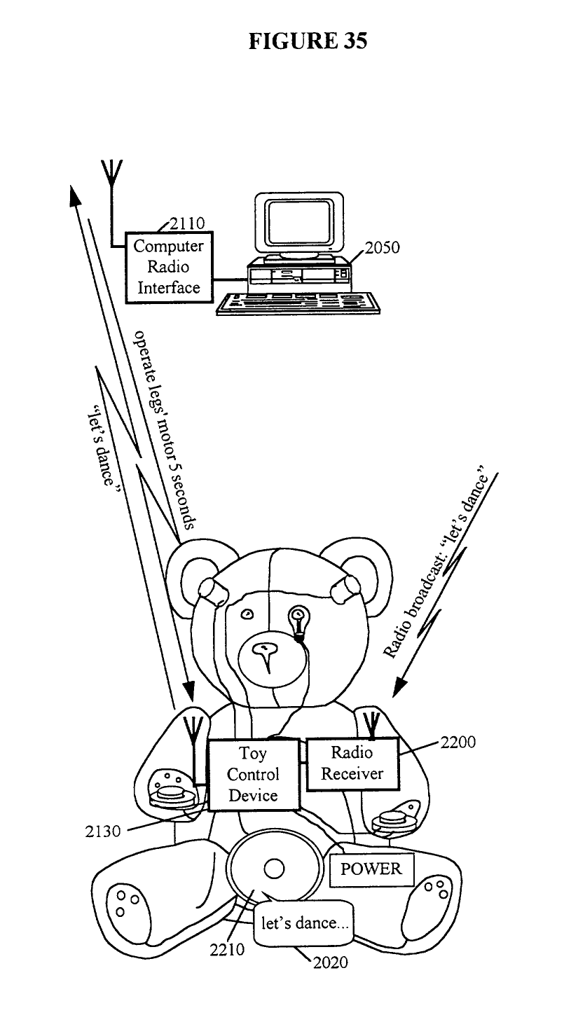

FIG. 35 is a semi-pictorial semi-block diagram illustration of a modification of the apparatus of FIG. 34 which is generally similar thereto except that the toy control device 2130 receives the audio information in electronic form rather than in acoustic form. The electronic audio information is received from a radio receiver 2200 integrally formed with the toy, preferably interiorly disposed therewithin. The toy, therefore, functions as a radio. The audio information in acoustic form, whose reference numeral is 2020, is provided to the user by means of a speaker 2210. Typically, the apparatus of FIG. 33 also includes a similar speaker to allow the computer to command the toy to emit vocalizations.

As shown in FIG. 35, the radio receiver 2200 receives radio entertainment broadcast information, transmits this information wirelessly to the computer 2050 and receives from the computer commands 2060 responsive to the radio entertainment broadcast information.

The apparatus of FIG. 35 is advantageous, relative to the apparatus of FIG. 34, in that the quality of reception is typically enhanced because the audio information transmitted by the toy does not include acoustic noise generated by noise in the toy's environment.

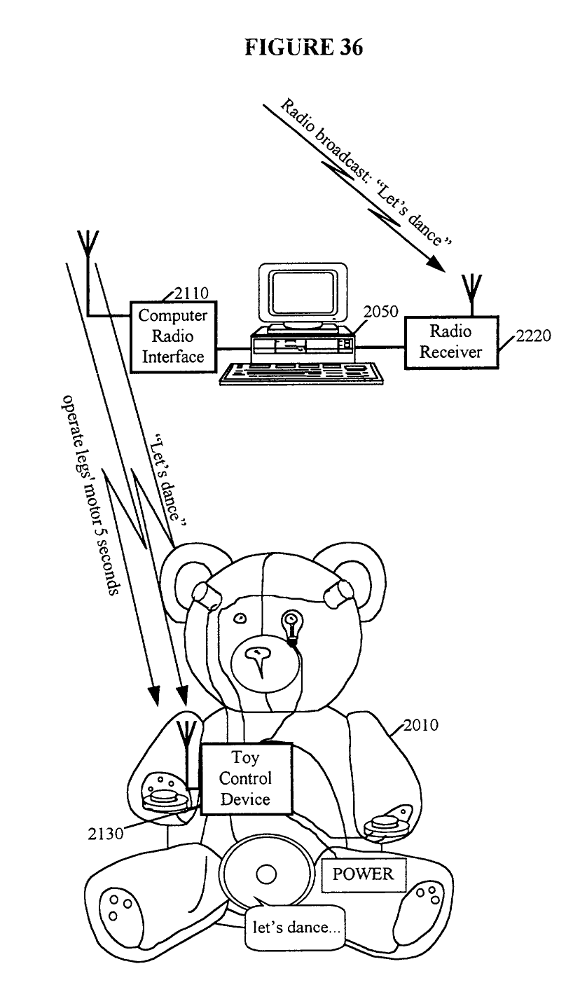

FIG. 36 is a semi-pictorial semi-block diagram illustration of a modification of the apparatus of FIG. 35 which is generally similar to the apparatus of FIG. 35 except that the audio information is received from a radio receiver 2220 connected to the computer rather than from a radio receiver residing in the toy 2010.

The apparatus of FIG. 36 is advantageous, relative to the apparatus of FIGS. 34 and 35, in that the toy's batteries or other power supply last longer because the toy does not have to transmit the audio information.

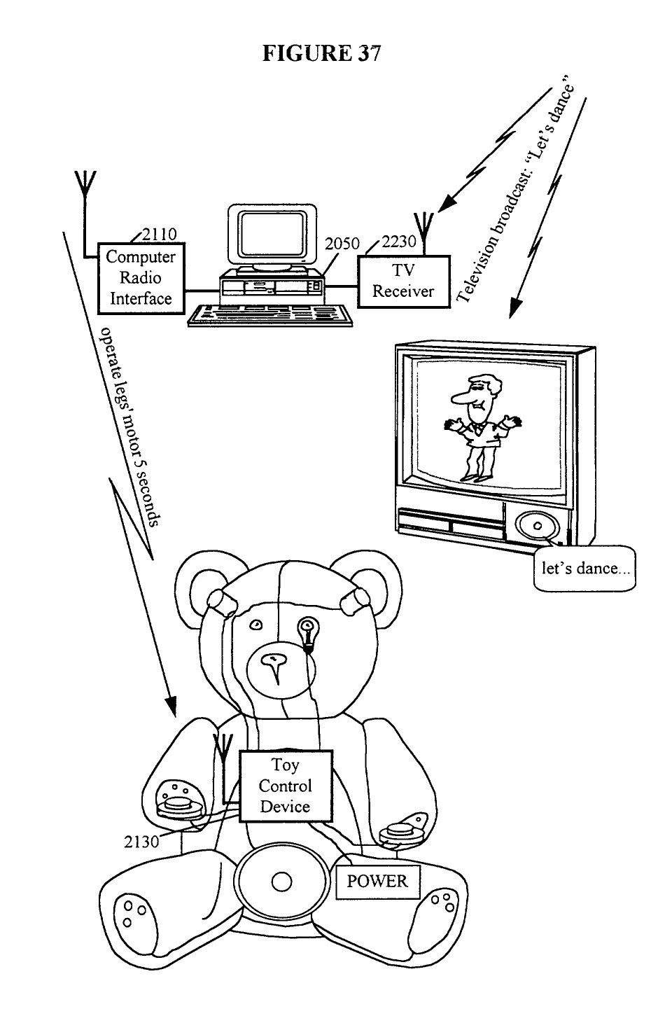

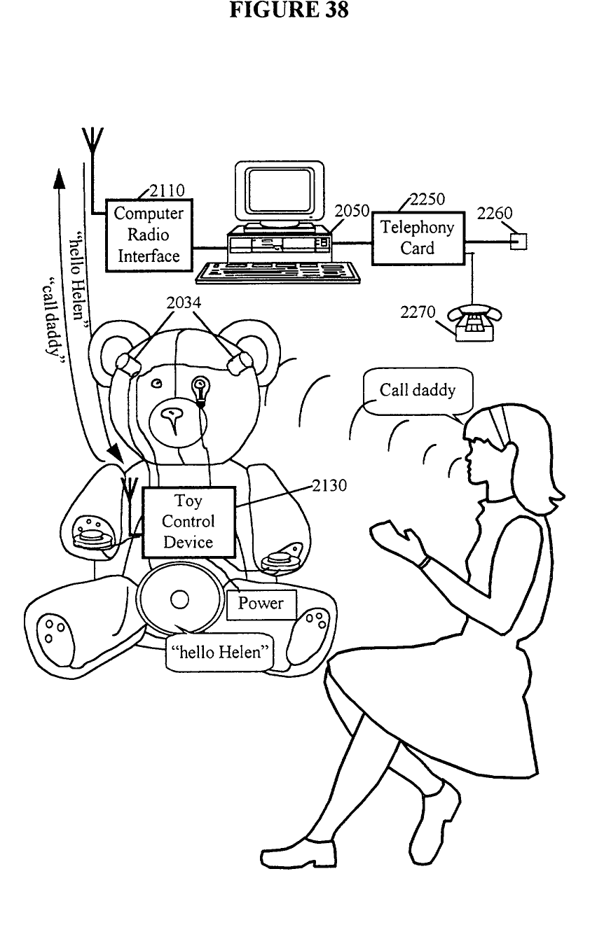

FIG. 37 is a modification of the apparatus of FIG. 33 which is generally similar to the apparatus of FIG. 33 except that the audio information is received electronically from a TV receiver 2230 connected to the computer rather than acoustically from a TV monitor.

The apparatus of FIG. 37 is advantageous, relative to the apparatus of FIG. 33, in that the toy's batteries or other power supply last longer because the toy does not have to transmit the audio information.

The apparatus of FIG. 37 is also advantageous, relative to the apparatus of FIG. 33, in that the quality of reception is typically enhanced because the audio information transmitted by the toy does not include acoustic noise generated by noise in the toy's environment.

FIG. 38 is a semi-pictorial semi-block diagram illustration of toy apparatus functioning as a PDA (personal digital assistant). The apparatus of FIG. 38 includes a computer 2050 such as a PC personal computer associated with a conventional telephony card 2250 or modem such as Dialog's D41 card, with a telephone jack 2260 and optionally with a telephone instrument 2270 enabling conventional telephone communication not involving the toy 2010.

The computer 2050 is in radio communication with a toy 2010 via a computer radio interface 2110 and a toy control device 2130.

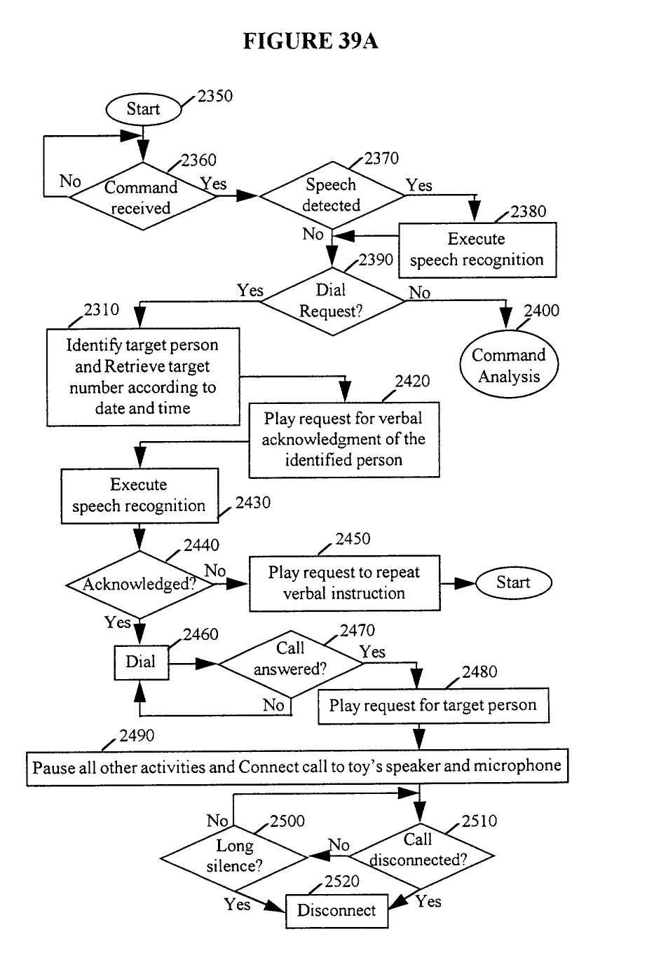

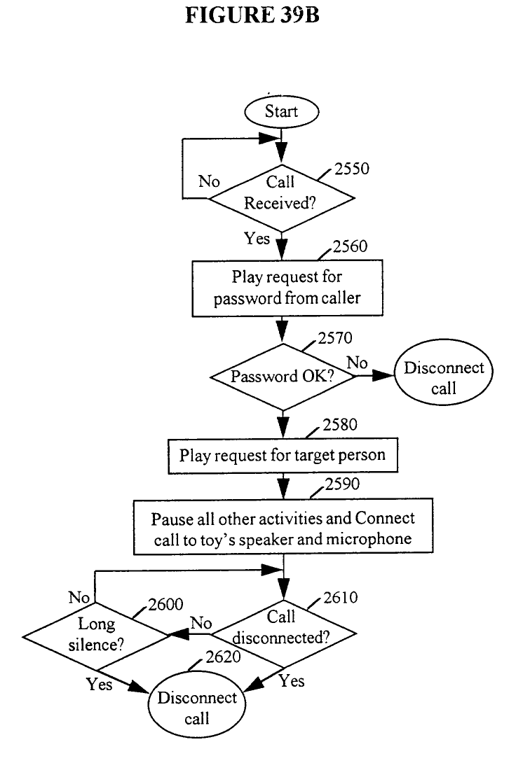

FIG. 39A is a simplified flowchart illustration of a preferred mode of operation for the apparatus of FIG. 38 allowing a call to be placed.

In normal operation, as shown in FIG. 39A, a user's request to place a telephone call is heard by one or more microphones 2034 mounted on the toy 2010 and is wirelessly transmitted to the computer 2050. The computer 2050 identifies key words using conventional speaker-dependent or speaker-independent speech recognition software such as products available from the following sources:

Stylus Innovation Inc., One Kendall Square, Building 300, Cambridge, Mass. 02139, USA;

A & G Graphics Interface, USA, at telephone number (617) 492 0120, telefax (617) 427 3625;

“Dragon Dictate for Windows”, marketed by Dragon Systems Inc., 320 Nevada Street, MA, 02160, USA, and

“SDK”, commercially available from Lernout & Hausple Speech Products, Sint-Krispijnstaat 7, 8900 Leper, Belgium.

The computer 2050 stores a list of telephone numbers each associated with a name or other label such as “daddy”. When one of the names or labels in the computer's memory is recognized, together with a dial request (such as the word “call”), the computer is operative to retrieve the telephone number corresponding to the name or label.

According to a preferred embodiment of the present invention, names in the computer's memory may be associated with more than one telephone number, each telephone number being associated with a time interval. For example, a parent's telephone number may be associated with her work number during office hours, and with her portable telephone number during her normal commuting hours.

The retrieved telephone number is dialed. If the call is answered, a request for the target person is preferably played to the responding party. The call is connected to the toy's speaker and microphone which function as the mouthpiece and earpiece respectively of a telephone instrument.

Preferably, the device is operative to disconnect the call automatically after a silence of a predetermined duration or if the responding party disconnects.

FIG. 39B is a simplified flowchart illustration of a preferred mode of operation for the apparatus of FIG. 38 for handling an entering call.

Upon receipt of an entering call by telephony card 2250, the computer 2050 answers and prompts the caller to enter a password. The correct password is stored in the memory of the computer. If the password entered is correct, the computer 2050 connects the call to the toy as above.

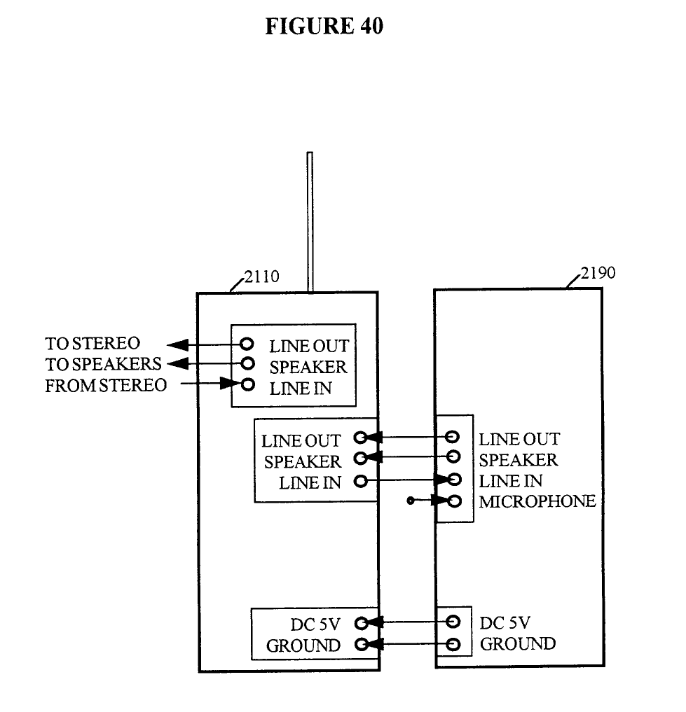

FIG. 40 is a simplified diagram of the interface between computer radio interface 2110 and soundboard 2190. The apparatus of FIG. 40 is a modification of the apparatus of FIG. 35 in which the MIDI connectors are omitted, such that the apparatus of FIG. 40 is useful in conjunction with sound-boards or computers which lack MIDI connectors.

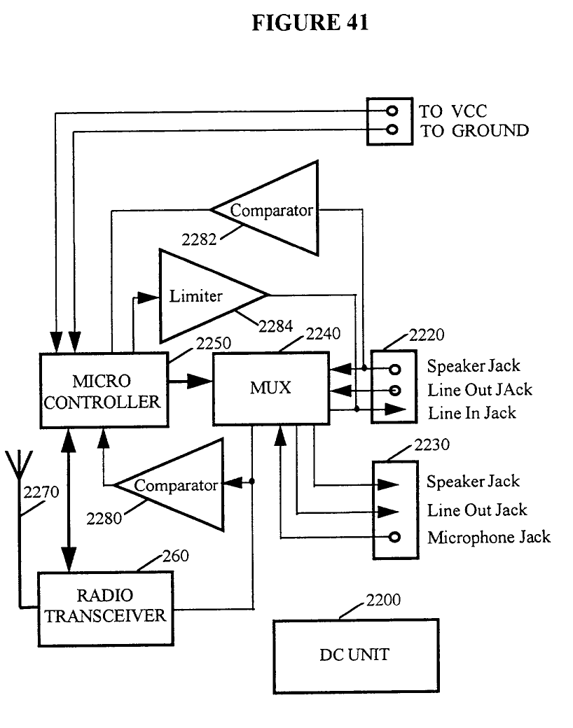

FIG. 41 is a simplified block diagram of a preferred implementation of computer radio interface 2110. FIG. 41 is a modification of the apparatus of FIG. 36 in which the MIDI connectors are omitted, such that the apparatus of FIG. 41 is useful in conjunction with sound-boards or computers which lack MIDI connectors.

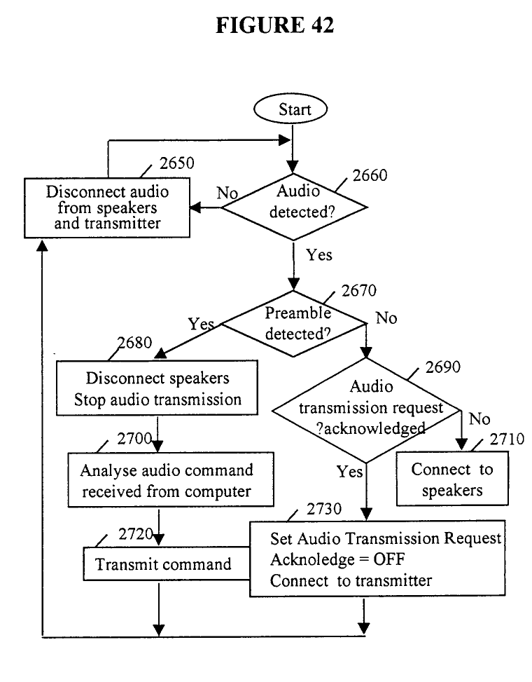

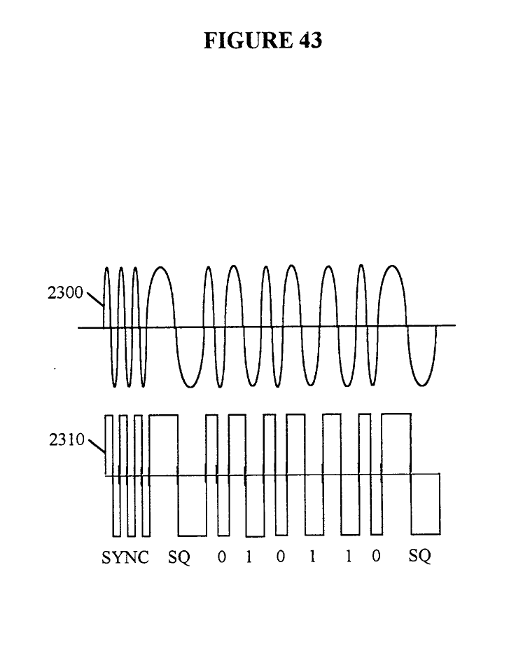

FIG. 42 is a simplified flowchart illustration of a preferred method allowing one of the computer radio interface 2110 and the computer 2050 to receive commands over the audio channel, rather than over the MIDI channel, from the other one of the computer radio interface 2110 and the computer 2050. The method of FIG. 42 first detects whether arriving information is audio information and if so, detects whether the audio information is entertainment-type audio information or a command. This is preferably effected by detecting whether or not a command-characterizing preamble has been received. The command-characterizing preamble typically comprises SYNC followed by SQ signals as described in detail below with reference to FIG. 43.

FIG. 43 is a diagram of analog and digital representations 2300 and 2310 respectively of the following signals: SYNC, SQ, zero-valued bit and one-valued bit.

The frequencies and time durations of each of the above signals are as follows:

| SIGNAL | FREQUENCY | | TIME DURATION |
|---|---|---|---|
| SYNC | 2 | KHz | 0.5 msec |
| SQ | 500 | Hz | 2 msec |
| zero | 1 | KHz | 1 msec |
| one | 666 | Hz | 1.5 msec |

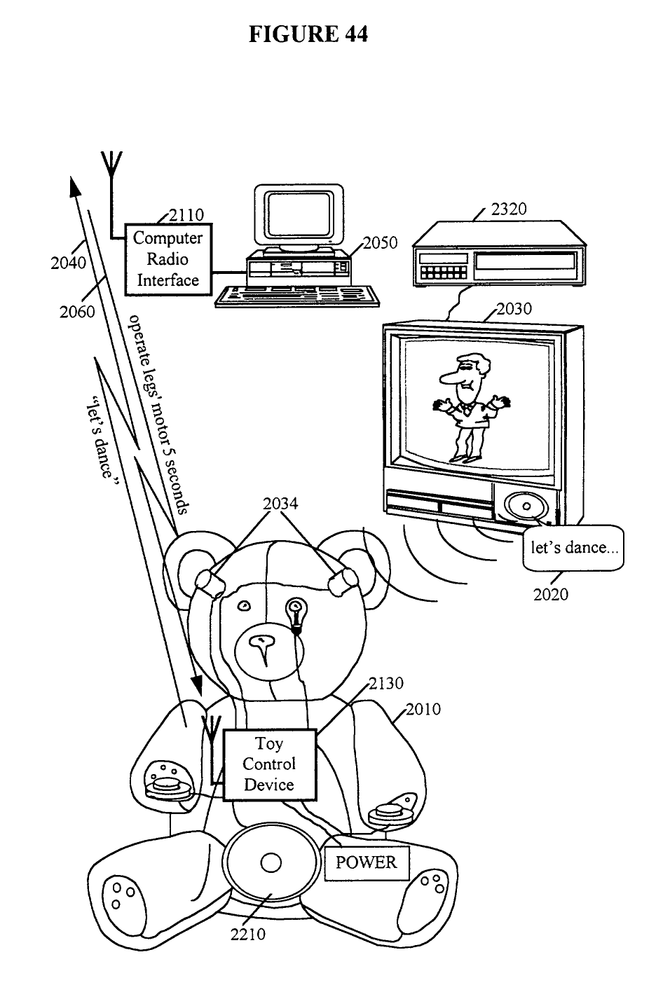

FIG. 44 is a semi-pictorial semi-block diagram illustration of a toy sensing audio information from a television viewed by a user, wherein the toy transmits this information wirelessly to a computer and receiving from the computer commands responsive to the audio information, and wherein the source of the audio-visual information provided by the television is a VCR 2320 rather than a conventional television broadcast as in FIG. 33.

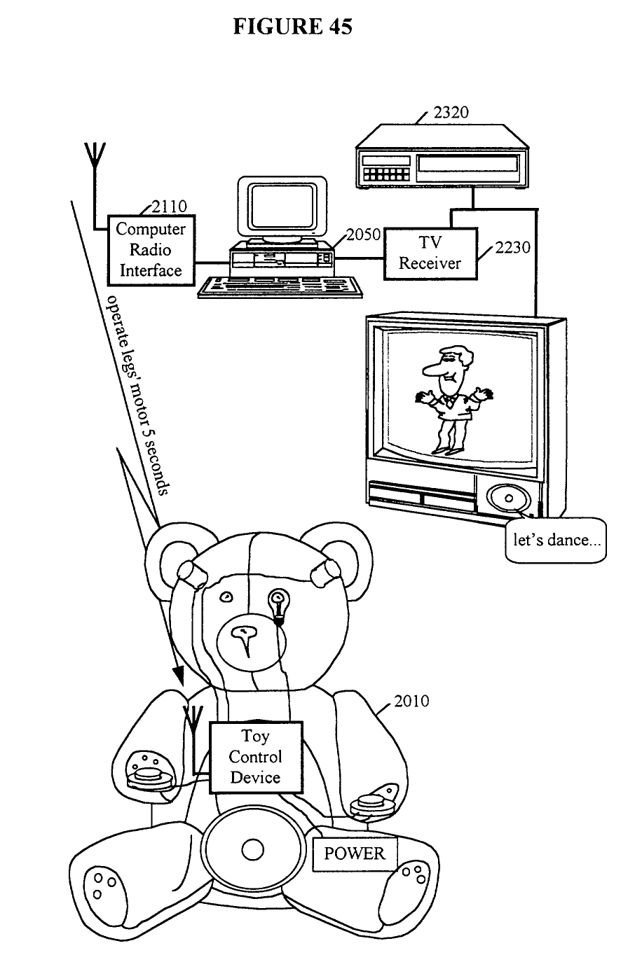

FIG. 45 is a semi-pictorial semi-block diagram illustration of a toy, a television monitor and a computer including a TV receiver or television board 2230 operative to receive audio-visual entertainment information from a VCR 2320 and to transmit to the toy 2010 computer commands responsive to the audio visual entertainment information.

In FIG. 45, the audio entertainment information is received electronically from the VCR via the television board connected to the computer rather than acoustically from a TV monitor as in FIG. 44.

The apparatus of FIG. 45 is advantageous, relative to the apparatus of FIG. 44, in that the toy's batteries or other power supply last longer because the toy does not have to transmit the audio component of the audio-visual entertainment information.

The apparatus of FIG. 45 is also advantageous, relative to the apparatus of FIG. 44, in that the quality of reception is typically enhanced because the audio information transmitted by the toy does not include acoustic noise generated by noise in the toy's environment.

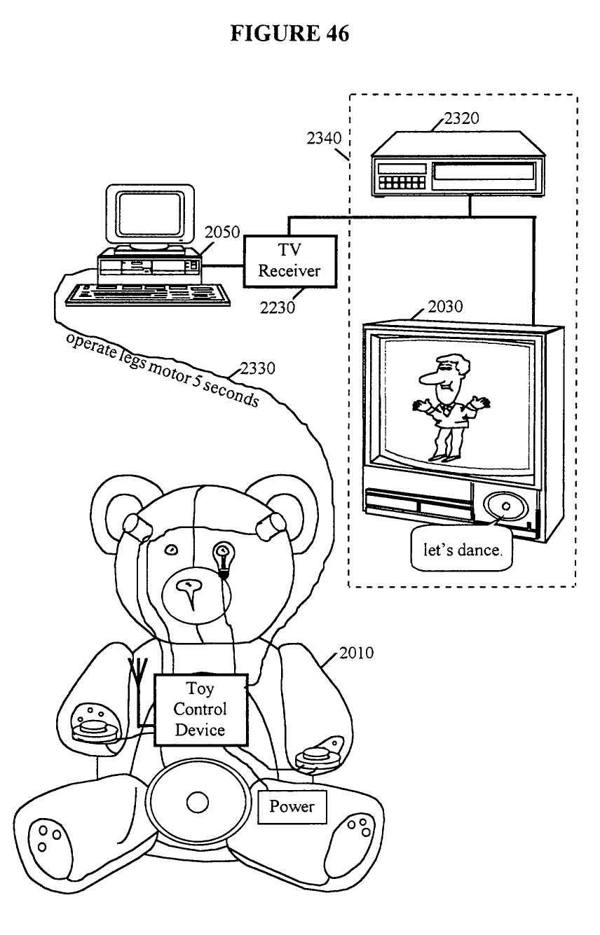

FIG. 46 is a semi-pictorial semi-block diagram illustration of a toy 2010 connected by a wire 2330 to a computer 2050, and a conventional audio entertainment provision system 2340 providing audio entertainment information. The entertainment provision system 2340, in the illustrated embodiment comprises a television set 2030 associated with a VCR 2320. However, alternatively, the entertainment provision system may comprise any of the entertainment provision systems shown and described above with reference to FIGS. 33-45 and the source of the audio entertainment information may be either a broadcast or a local repository such as a cassette. The audio entertainment information is presented to the user and is also used by the computer 2050 to operate the toy 2010 in coordination with the presentation of the audio entertainment information.

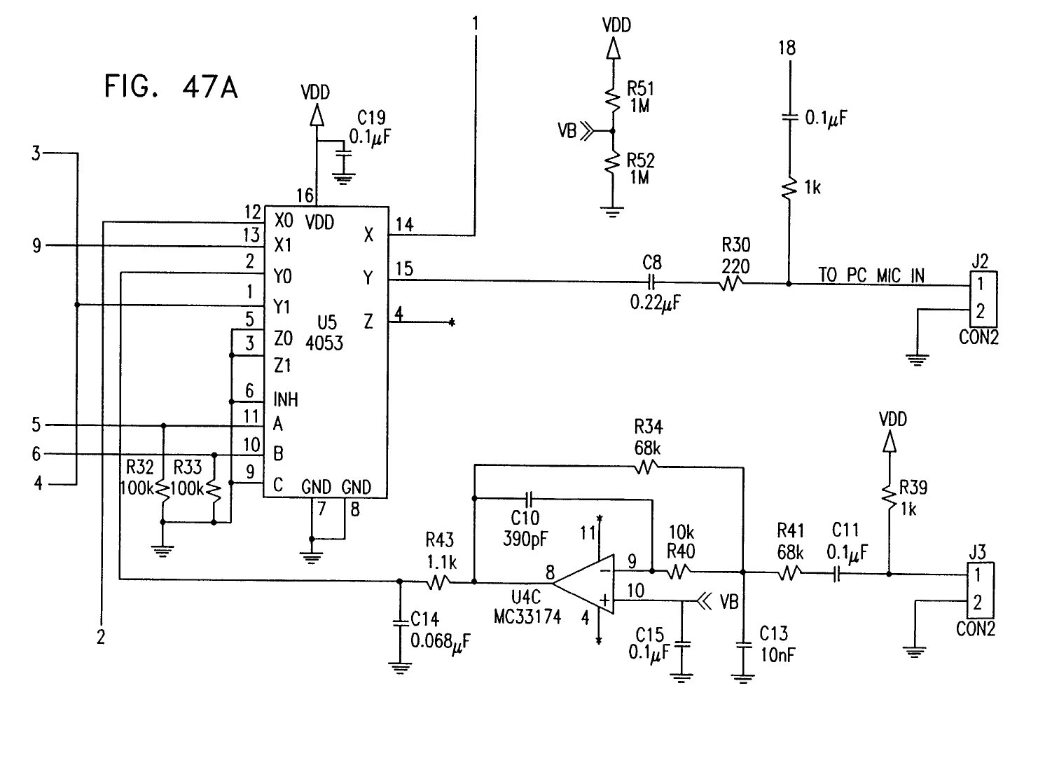

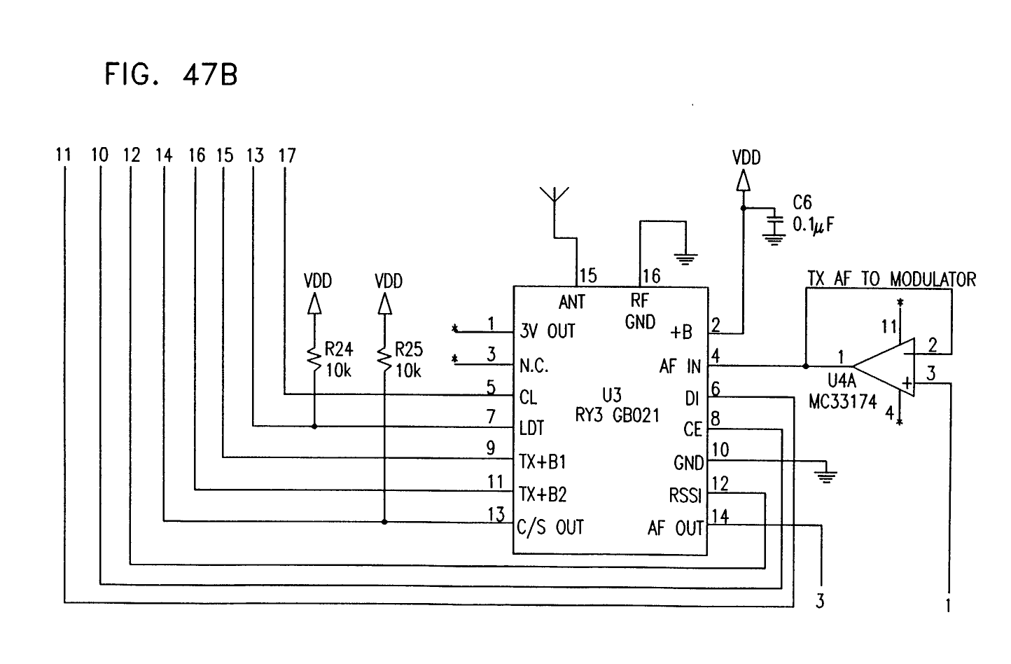

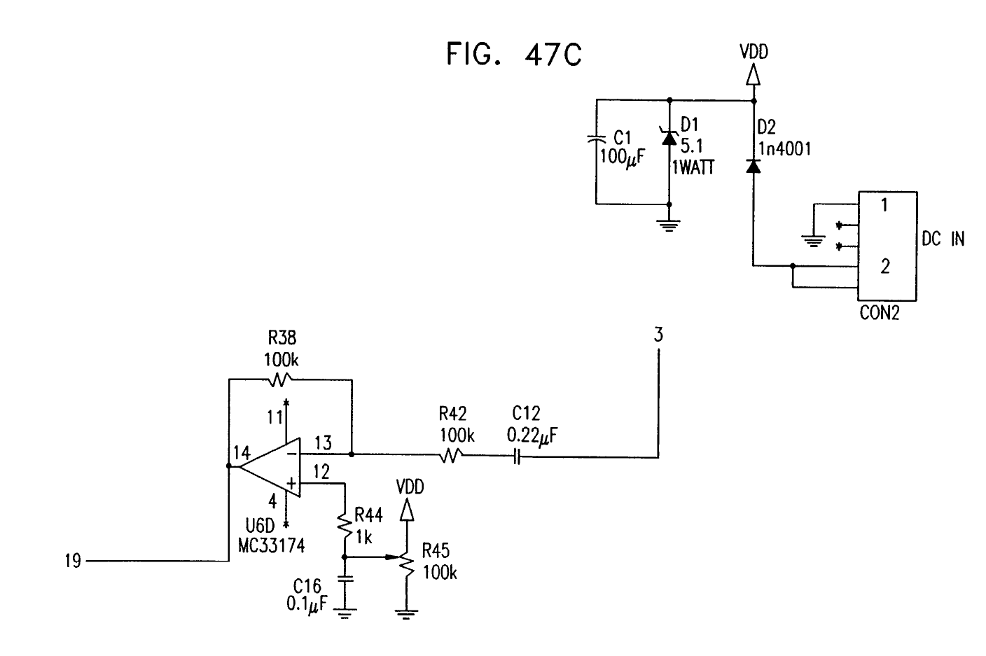

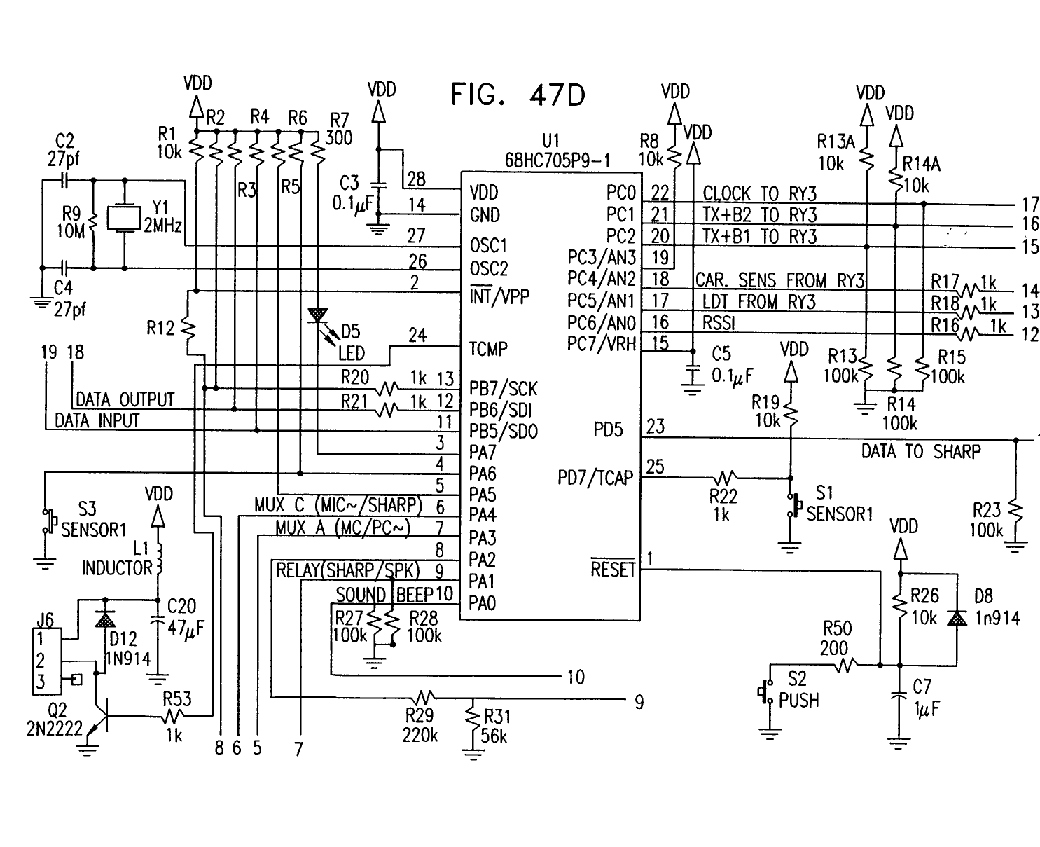

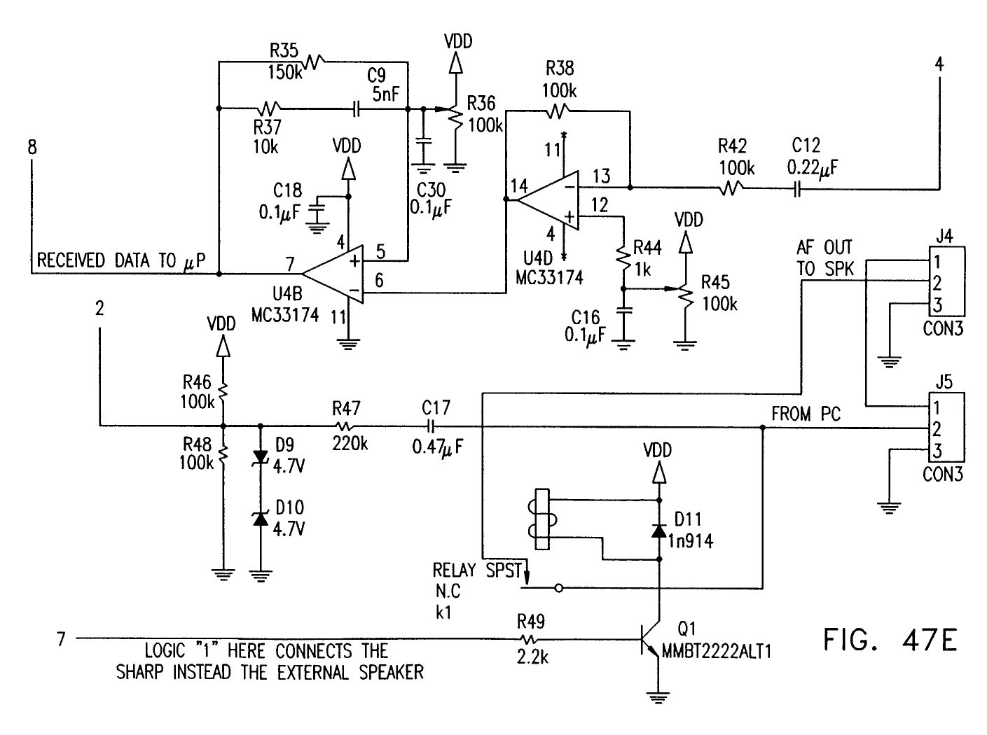

FIGS. 47A-47E, taken together, form a detailed electronic schematic diagram of a preferred implementation of the apparatus of FIG. 41.

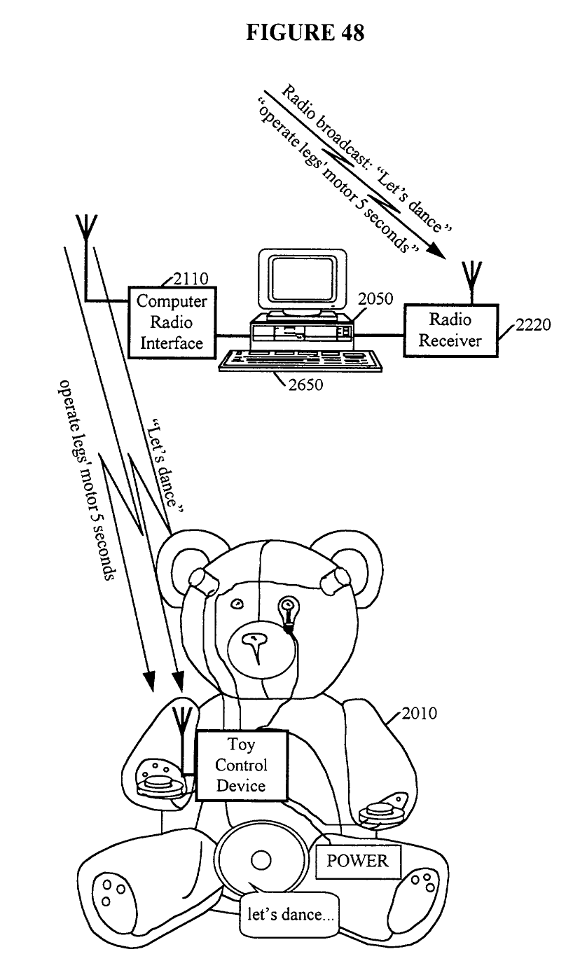

FIG. 48 is a semi-pictorial semi-block diagram illustration of a controllable toy system comprising a controllable toy 2010 and a radio signal receiver 2220 operative to receive an audio entertainment signal and a corresponding toy control signal from a remote radio transmitter. Unlike the embodiment of FIG. 36, in which the radio broadcast may be a conventional broadcast including only an audio component, in the embodiment of FIG. 48, the radio broadcast includes not only an audio component but also a toy control component. Typically, the radio broadcast comprises a stereo broadcast having two channels of which a first predetermined channel carries a mono audio component and the other channel carries the toy control component.

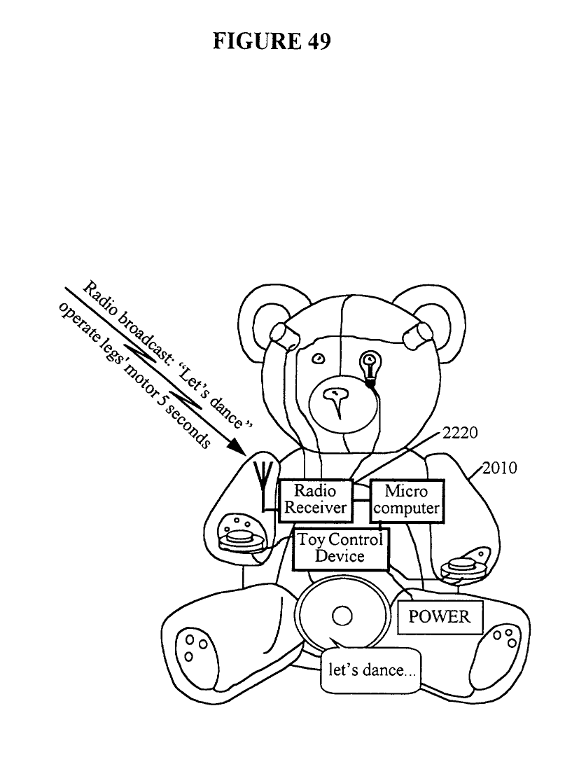

FIG. 49 is a semi-pictorial semi-block diagram illustration of a modification of FIG. 48 in which the radio signal receiver is integrally formed with the controllable toy.

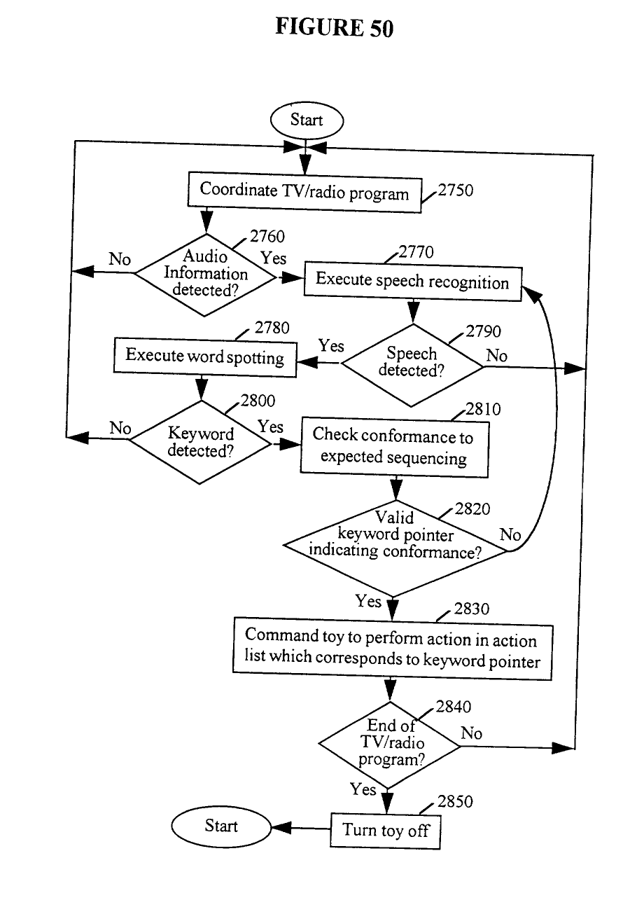

FIG. 50 is a simplified self-explanatory flowchart illustration of a preferred method by which the computer analyzes an audio entertainment signal so as to recognize therewithin predetermined audio entertainment elements and to command the toy 2010 to perform at least one action having a predetermined association with the recognized predetermined audio entertainment elements.

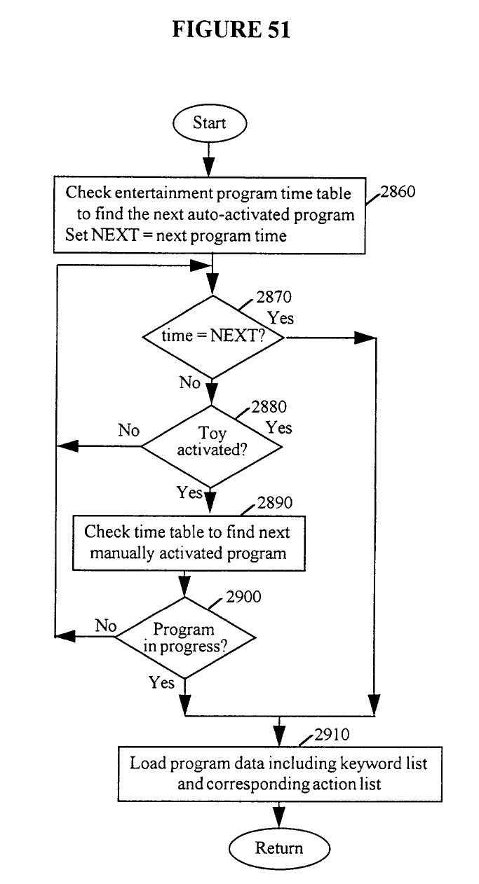

FIG. 51 is a simplified flowchart illustration of a preferred method for performing the TV/radio program coordination step of the method of FIG. 50. In the method of FIG. 51, a program may either be activated by the system itself, steps 2860, 2870, 2910, (typically if the program is discovered by the system in its entertainment program time table) or alternatively may be activated by the user, steps 2880, 2890, 2900, 2910, and acted upon by the system if the system recognizes the program as an optional program to be cooperated with only if activated by the user.

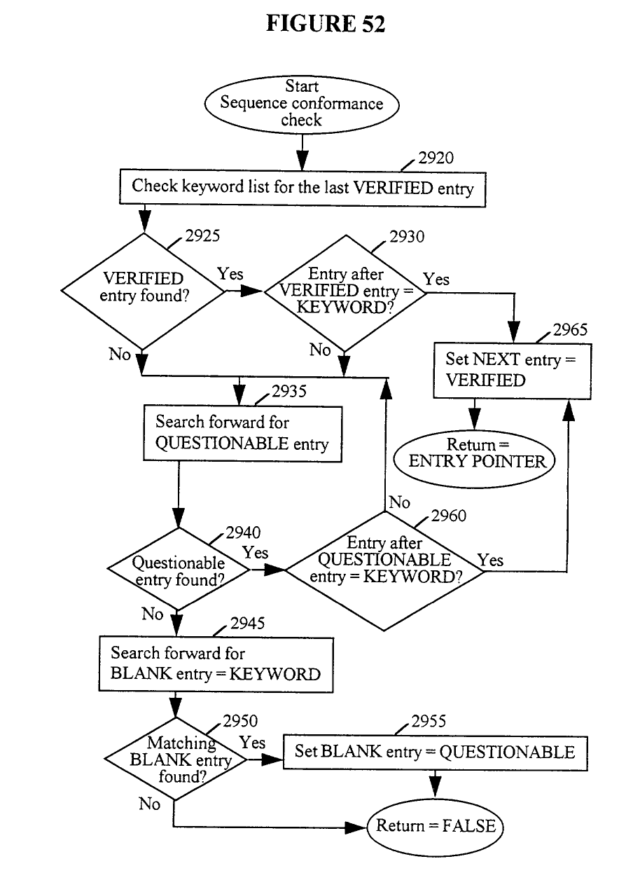

FIG. 52 is a simplified flowchart illustration of a preferred method for performing the conformance checking step 2810 of the method of FIG. 50 in order to synchronize the toy's activities with a broadcast program. Preferably, the toy operates in accordance with a predetermined sequence of activities associated with a “keyword list” typically determined by a game programmer and stored on CDROM. The advantage of providing a keyword list is that the system knows what keyword is next expected, thereby reducing synchronization errors.

Typically, the system is constructed and operative such that if a KEYWORD detected by the speech recognizer or audio analyzer is not found the next KEYWORD in sequence, steps 2925 or 2930, the system checks whether a keyword may have been missed and automatically tries to resynchronize (steps 2935, 2940, 2945, 2950, 2955, 2960, 2965). The systems searches for the KEYWORD down the list, and if found marks it as QUESTIONABLE (steps 2935, 2940, 2945, 2950, 2955). The next time a keyword is detected which is not in sequence with the last VERIFIED keyword, the system checks whether this keyword follows a QUESTIONABLE entry. If such an entry is found, the system marks this NEXT entry as VERIFIED (steps 2935, 2940, 2960, 2965) and resynchronization is achieved and all the QUESTIONABLE entries are marked BLANK (not shown).

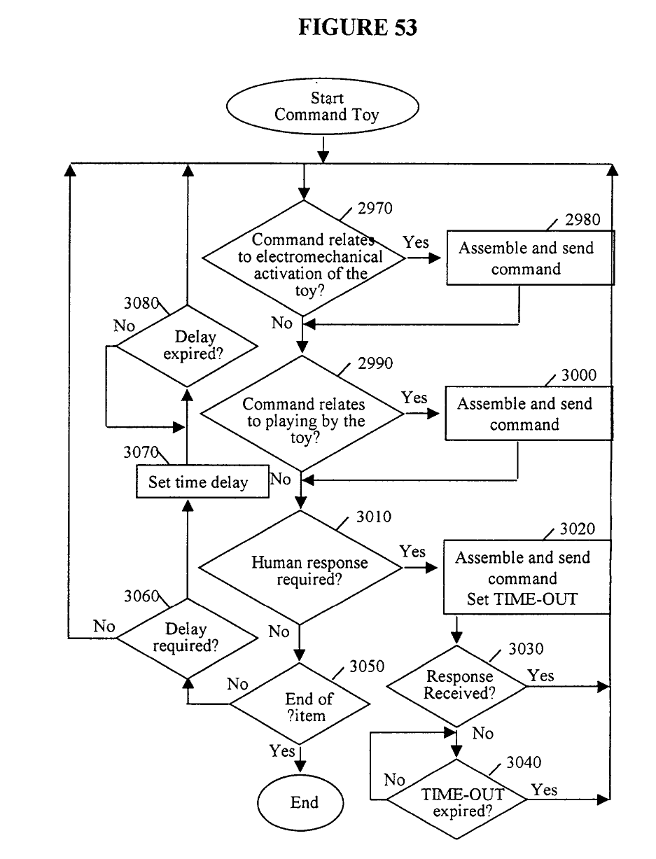

FIG. 53 is a simplified flowchart illustration of a preferred method for performing the “command toy . . . ” step 2830 of the method of FIG. 50 in which the toy is activated in synchronization with the broadcast program.

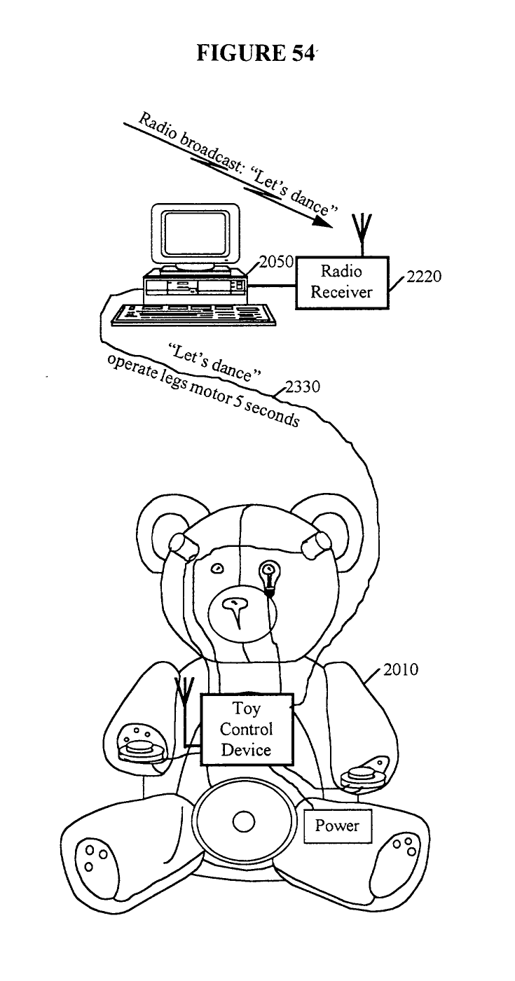

FIG. 54 is a semi-pictorial semi-block diagram of a controllable toy system operative in conjunction with a household audio entertainment player receiving an audio entertainment signal from a remote radio transmitter, the system comprising a controllable toy 2010 and a radio signal receiver 2220, integrally formed with the computer 2050 and communicating with the toy by means of a wire 2330. The radio signal receiver 2220 is operative to receive a toy control signal from a remote radio transmitter which transmits a toy control signal and a corresponding audio entertainment signal. The radio signal receiver 2220 also commands the controllable toy to perform at least one action according to said toy control signal.

It is appreciated that the software components of the present invention may, if desired, be implemented in ROM (read-only memory) form. The software components may, generally, be implemented in hardware, if desired, using conventional techniques.

It is appreciated that the particular embodiment described in the Appendices is intended only to provide an extremely detailed disclosure of the present invention and is not intended to be limiting.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow the appendices which are:

We claim:

1. A controllable toy system operative in conjunction with a household audio entertainment player, the system comprising:
a controllable toy; and
an audio entertainment signal analyzer operative to analyze an audio entertainment signal so as to recognize therewithin predetermined audio entertainment elements and to command said controllable toy to perform at least one action according to said predetermined audio entertainment elements at a time corresponding to a time at which said audio entertainment elements are played by the household audio entertainment player.

2. A computerized toy system according to claim 1 and also comprising a household audio entertainment player.

3. A computerized toy system according to claim 2 wherein said household audio entertainment player comprises a household entertainment broadcast receiver.

4. A computerized toy system according to claim 3 wherein said household entertainment broadcast receiver comprises a television set.

5. A computerized toy system according to claim 3 wherein said household entertainment broadcast receiver comprises a radio set.

6. A computerized toy system according to claim 3 wherein said household audio entertainment player comprises an audio cassette player.

7. A computerized toy system according to claim 6 wherein said household audio entertainment player comprises a VCR.

8. A system according to claim 1 wherein said audio entertainment signal analyzer is operative to receive an acoustical representation of said audio entertainment signal from said audio entertainment player.

9. A system according to claim 2 wherein said audio entertainment player and said audio entertainment signal analyzer each receive an electronic representation of said audio entertainment signal from an electronic audio entertainment source.

10. A system according to claim 1 wherein the audio entertainment signal analyzer is integrally formed with the controllable toy.

11. A system according to claim 1 wherein the audio entertainment signal analyzer comprises a computer in electronic communication with said controllable toy.

12. A system according to claim 11 wherein said electronic communication comprises wired electronic communication.

13. A system according to claim 11 wherein said electronic communication comprises wireless electronic communication.

14. A computerized toy system comprising:
a toy;
a computer having a sound card;
a computer-radio interface associated with the sound card of the computer via at least one audio channels; and
a toy control device associated with the toy and providing radio communication with the computer-radio interface;
wherein at least one of the computer-radio interface and the computer are operative to transmit audio signals and digital commands through said sound card, via said at least one audio channels to the other one of said computer-radio interface and said computer and wherein the other one of said computer-radio interface and said computer is operative to receive said audio signals and said digital commands from said at least one audio channels.

15. A controllable toy system operative in conjunction with a household audio entertainment player receiving an audio entertainment signal from a remote radio transmitter, the system comprising:
a controllable toy; and
a radio signal receiver operative to receive a toy control signal from a remote radio transmitter which transmits said toy control signal and a corresponding audio entertainment signal, and to command said controllable toy to perform at least one action according to said toy control signal.

16. A system according to claim 15 wherein said radio signal receiver is integrally formed with said controllable toy.

17. A system according to claim 15 wherein said radio signal receiver is integrally formed with a computer which is in electronic communication with said controllable toy.

18. A system according to claim 17 wherein said electronic communication comprises wired electronic communication.

19. A system according to claim 17 wherein said electronic communication comprises wireless electronic communication.

20. A telephone communication toy comprising:
a toy including a microphone and a loudspeaker;
a computer in electronic communication with the toy and including a speech recognizer;
a telephone number database accessible by said speech recognizer and including at least one destination paired with at least one telephone number; and
an automatic dialing device operative to generate a telephone connection with said destination, using a corresponding telephone number accessed from said telephone number database by said speech recognizer.

21. A system according to claim 2 wherein said controllable toy is integrally formed with the household audio entertainment player.

22. A toy control method operative in conjunction with a household audio entertainment player, the method comprising:
providing a controllable toy; and
analyzing an audio entertainment signal so as to recognize therewithin predetermined audio entertainment elements and commanding said controllable toy to perform at least one action according to said predetermined audio entertainment elements at a time corresponding to a time at which said audio entertainment elements are played by the household audio entertainment player.

23. A system according to claim 15 and also comprising a remote radio transmitter broadcasting an audio entertainment signal and a corresponding toy control signal.

24. A system according to claim 15 and wherein said household audio entertainment player is integrally formed with said controllable toy.

25. A computerized toy control method comprising:
providing a toy, a computer having a sound card, a computer-radio interface associated with the sound card of the computer via at least one audio channels and a toy control device associated with the toy and providing radio communication with the computer-radio interface; and
transmitting audio signals and digital commands through said sound card, from one of said computer-radio interface and said computer via said at least one audio channels to the other one of said computer-radio interface and said computer.

26. A toy control method operative to control a controllable toy in conjunction with a household audio entertainment player receiving an audio entertainment signal from a remote radio transmitter, the method comprising:
broadcasting a toy control signal and a corresponding audio entertainment signal;
playing said audio entertainment signal at a location remote from the radio transmitter; and
commanding said controllable toy to perform at least one action according to said toy control signal, at a location remote from the radio transmitter.

27. A telephone communication method comprising:
providing a toy including a microphone and a loudspeaker, a computer in electronic communication with the toy and including a speech recognizer and a telephone number database accessible by said speech recognizer; and
generating a telephone connection with a destination, using a telephone number accessed from said telephone number database by said speech recognizer.
